(19) United States
(12) Patent Application Publication
(10) Pub. No.: US 2014/0351033 A1
(43) Pub. Date: Nov. 27, 2014

(54) SYSTEMS AND METHODS OF INCENTIVIZING TRANSACTIONS

(71) Applicant: KAACOO, INC., San Francisco, CA (US)

(72) Inventor: Lisa A. Azevedo, Roseville, CA (US)

(73) Assignee: KAACOO, INC., San Francisco, CA (US)

(21) Appl. No.: 14/286,939

(22) Filed: May 23, 2014

Related U.S. Application Data
(60) Provisional application No. 61/827,453, filed on May 24, 2013.
(60) Provisional application No. 61/856,019, filed on Jul. 18, 2013.
(60) Provisional application No. 61/879,069, filed on Sep. 17, 2013.
(60) Provisional application No. 61/888,804, filed on Oct. 9, 2013.

(51) Int. Cl. G06Q 50/00; G06Q 30/02

(52) U.S. Cl. CPC G06Q 50/01; G06Q 30/0222
USPC 705/14.19

(57) ABSTRACT

Methods, devices, and computer program products for processing a mobile payment. In one aspect, a method includes providing an offer for a transaction, the offer contingent upon a social media promotion requirements. The method further includes receiving an authorization for the transaction and the social media promotion requirements based on the transaction. The method further includes performing the social media promotion requirements based on the transaction. The method further includes processing the mobile payment after verifying the social media promotion requirements based on the transaction.

### RELATED APPLICATIONS

This application claims the benefit of U.S. Provisional Application Nos. 61/827,453 filed May 24, 2013, 61/856,019 filed Jul. 18, 2013, 61/879,069 filed Sep. 17, 2013, and 61/888,804 filed Oct. 9, 2013, and each of these applications is hereby incorporated by reference herein in its entirety.

### FIELD

The present application relates generally to electronic commerce, and more specifically to systems, methods, and devices for incentivizing and managing social media promotion requirements and feedback in conjunction with a transaction.

### BACKGROUND

Electronic commerce, commonly known as e-commerce, includes the transaction for example, buying and selling of a product or service over electronic systems such as the Internet and other computer networks. Electronic commerce draws on technologies such as mobile commerce, electronic funds transfer, supply chain management, Internet marketing, online transaction processing, electronic data interchange (EDI), inventory management systems, and automated data collection systems. Modern electronic commerce typically uses the World Wide Web at least at one point in the transaction's life-cycle, although it may encompass a wider range of technologies such as e-mail, mobile devices, social media, and telephones.

Social media networks such as Facebook and Twitter provide a means of interaction among people in which they create, share, and exchange information and ideas. For example, mobile and web-based technologies can provide interactive platforms through which individuals and communities can share, co-create, discuss, and modify user-generated content. The advent of social media introduces substantial and pervasive changes to communication between organizations, communities and individuals.

Typically, a social media user may share information about an e-commerce transaction. For example, a user may relate a positive or negative experience with a third-party via a text message shared with friends. The third-party typically has little or no control over the content of the message, and may not even have access to the message for quality control management. Accordingly, systems and methods for managing social media in the context of e-commerce are needed.

### SUMMARY

The systems, methods, devices, and computer program products discussed herein each have several aspects, no single one of which is solely responsible for its desirable attributes. Without limiting the scope of this invention as expressed by the claims which follow, some features are discussed briefly below. After considering this discussion, and particularly after reading the section entitled “Detailed Description,” it will be understood how advantageous features of this invention include reduced power consumption when introducing devices on a medium.

One innovation is a system for incentivizing a transaction. In some implementations, the system includes a computer server system including electronic storage configured to store account information for a plurality of consumers, the account information including, for each particular consumer of the plurality of consumers, a unique consumer identifier associated with the particular consumer, at least one social media venue identifier associated with the unique consumer identifier and indicating a social media venue that the particular consumer has registered with, and access information to the at least one social media venue, the access information being associated with the unique consumer identifier, the access information being sufficient to allow a computer to, upon receiving authorization from the particular consumer, access the at least one social media venue and provide an update on the at least one social media venue of the particular consumer. The system further includes at least one processor configured with instructions to operate the processor to provide an offer for a transaction to a consumer associated with a unique consumer identifier and having stored account information, the transaction including providing an incentive to the consumer, the incentive contingent on receiving a first input in response to the offer that meets transaction requirements, the first input including a unique consumer identifier, the transaction requirements including an authorization from the consumer for a selected social media update to occur on at least one social media venue associated with the unique identifier of the consumer providing the first input, using the stored account information of the consumer providing the input. The processor is further configured to receive the first input in response to the offer, the first input associated with a unique consumer identifier. The processor is further configured to validate the received first input by determining whether the first input meets the transaction requirements. The processor is further configured to, if the first input passes validation, perform the selected social media update on the at least one social media venue of the consumer associated with the consumer identifier and using the stored account information associated with the consumer identifier. The processor is further configured to provide the incentive to the consumer after the selected social media update on the at least one social media venue of the consumer has occurred. The electronic storage can also be any type of suitable hardware and/or software that allows the computer server system to access stored data (information) to read stored data and write data into the electronic storage.

One of ordinary skill in the art will appreciate that implementations of the at least one processor include multiple processors configured on the same board, multiple processors configured on separate boards within the server system, or one or more processors arranged in separate housings and in data communication with each other. Also, the use of the words “a processor” here and throughout this disclosure is not intended to limit an implementation to having one processor unless specifically stated. Instead, one of ordinary skill in the art will appreciate that the words “a processor” indicate that at least one processor may be configured with instructions (for example, instructions stored in the processor in hardware, firmware or software, or stored in another memory component that is in data communications with the at least one processor) to perform the disclosed functionality or operation, and in some implementations two or more processors may be used.

In various embodiments, said perform the selected social media update can include providing at least a portion of the first input received in response to the offer and providing stored access information associated with the consumer identifier to at least one computer configured to perform the selected social media update on the at least one social media venue using the access information and at least a portion of the first input.

In various embodiments, the system can further include a transaction component residing on a portable computing device. The transaction component can be configured to be associated with the unique consumer identifier. The transaction component can be further configured to receive the offer. The transaction component can be further configured to display indicia of the offer on a display screen of the portable computing device. The transaction component can be further configured to receive a first input in response to the offer at an electronic interface of the portable computing device. The transaction component can be further configured to send the first input in a wireless transmission from the portable computing device. The transaction component can be further configured to display, on the display screen of the portable computing device, indicia indicating receipt of the incentive.

In various embodiments, the incentive can include a product, a service, a discount for a product, or a discount for a service. In various embodiments, the incentive can include a financial incentive, a non-financial incentive, or both a financial incentive and a non-financial incentive. In various embodiments, the offer can be a monetary offer or a non-monetary offer.

In various embodiments, said electronic storage can include a database in data communication with the at least one processor, and the portable computing device can include a wireless client device adapted to communicate with the computer server system. In various embodiments, the transaction component can be further configured to validate the first input on the portable computing device. In various embodiments, the first input can include at least one of an image, a video, or an electronic data file. The electronic data file be provided by a another device in communication with the portable computing device, for example, a GPS device, a fitness device, or a camera. The electronic data file can include any type of electronic information, for example, an image, a video, information of a route, or information indicative of a health or fitness characteristic.

In various embodiments, the portable computing device can include a laptop computer, a tablet computer, a smart phone, or glasses or other wearable computer device. In various embodiments, the incentive can include a discount, coupon, gift card, membership, product, good or service. In various embodiments, the at least one social media venue can include, for example, but not limited to, one or more of Facebook, Twitter, Instagram, Yelp or Foursquare. In various embodiments, the selected social media update can include providing an update to at least one social media venue having a social media identifier associated with the unique consumer identifier, and wherein the update can include one or images. In various embodiments, the offer can include an offer to purchase an item from a third party, wherein the offer for a transaction can be provided by the computer server system, and wherein and the transaction requirements include receiving authorization for a platform provider to process a payment for the item with the third party on behalf of the consumer. In various embodiments, the at least one processor can be further configured to receive inventory information from a third party via a communication network, the inventory information having at least one indicia of an item to include in the offer and that will be provided to the consumer if the transaction requirements are met.

In various embodiments, the account information further can include, for each particular consumer, payment information associated with the unique consumer identifier, the payment information having at least one payment source and being sufficient to make payments to a third party on behalf of the consumer. The at least one processor can be further configured to receive at the computer server system, via a network and communicated from a computing device, an authorization to pay the third party for the item, the authorization being associated with a unique consumer identifier, and wherein the first input can include the authorization. The processor can be further configured to retrieve at the computer server system, from the storage component, payment information that can be associated with the unique consumer identifier, after receiving the authorization to pay the third party. The processor can be further configured to provide payment information from the from the computer server system to the third party to transact a payment of the item for the consumer associated with the unique consumer identifier. In various embodiments, the at least one processor can be further configured to receive, from the third party via a network, an electronic communication that can include data representative of a displayable offer graphic for presenting on a display screen of a computing device for visually conveying information about the offer for the item. In various embodiments, said provide the offer can include providing, via a communication network, data representative of the displayable offer graphic to a computing device. In various embodiments, the at least on processor can be further configured to provide to the third party a customizable displayable offer graphic.

In various embodiments, the transaction component residing on the portable computing device can be further configured to receive the data representative of the displayable offer graphic from the server system platform provider, and display the displayable offer graphic on a display of a computing device.

In various embodiments, for at least one of the plurality of consumers, the account information further can include contact data associated with at least one person, the contact data sufficient to send a communication to the at least one person, and wherein performing the selected social media update can include sending a communication indicating that the consumer to the at least one person.

In various embodiments, the at least one processor of the server system can be further configured to receive a second input having the same consumer identifier as the first input, the second input including feedback related to the transaction. The processor can be further configured to validate the second input based on second transaction requirements. The processor can be further configured to, if the second input passes validation, perform a second selected social media update on the at least one social media venue of the consumer associated with the consumer identifier. The processor can be further configured to provide a second incentive to consumer after the second selected social media update has occurred.

Another innovation is a method of providing an offer for a transaction, the offer contingent upon a social media promotion requirements. The method further includes receiving an authorization for the transaction and the social media promotion requirements based on the transaction. The method further includes performing the social media promotion requirements based on the transaction. The method further includes processing the mobile payment after verifying the social media promotion requirements based on the transaction.

In various embodiments, the method can be at least partially performed on one or more of a smart device, laptop, desktop, smart tablet, smart phone, glasses or other wearable computing device, or any other device. In various embodiments, the offer for transaction can include a discount or other incentive based on the social media promotion requirements. In various embodiments, the social media promotion requirements can include one or more of a text message, a photograph, a video, a drawing or other image, a sound, a voicemail, a tweet, a re-tweet, a Facebook page or status, a blog, or any other social communication channel.

In various embodiments, the transaction can include a transaction related to a single product, good or service. In various embodiments, the transaction can include a transaction related to a plurality of products, goods and/or services. In various embodiments, the method can further include providing an option to refrain from authorizing the social media promotion requirements.

In various embodiments, the method can further include modifying or revoking the offer for transaction when the option to refrain from authorizing the social media promotion requirements can be chosen. In various embodiments, the method can further include recording a plurality of payment methods associated with an account and selecting one payment method. Processing the mobile payment can include applying the one payment method to the transaction.

In various embodiments disclosed herein, a payment method, or a system for payment, may utilize any of an electronic transaction, a near-field communication (NFC) phone, an incentive physical card, a text message, a bar code, a biometric payment, Google glasses, sound, photo, or video and or any other type of electronic form of payment. In various embodiments, the method can further include associating the payment method with at least one funding source. In various embodiments, the funding source can include any of: a credit card, a gift card, a debit card, an automatic teller machine (ATM) card, a reward card, a health card, a transit card, a checking, savings, or other bank account, an electronic payment account, a phone card, and any other electronically accessible funding source.

In various embodiments, the method can further include sharing a funding source with a secondary account or receiving a shared funding source from a primary account. In various embodiments, the method can further include automatically enabling or disabling one or more payment methods based on a time, date, third-party, and/or location.

In various embodiments, the method can further include providing a plurality of advertisements, the advertisements prioritized based on an account referral. In various embodiments, prioritization can include one or more of: size, color, font parameters, position, media type, and effect.

In various embodiments, the method can further include soliciting feedback regarding the transaction in conjunction with an incentive for completing the feedback offer and authorization for a social media promotion requirements based on the feedback offer. The method can further include receiving feedback offer and authorization. The method can further include performing the social media promotion requirements based on the feedback offer prior to delivering the incentive. The method can further include delivering the incentive after verifying the social media promotion requirements based on the feedback offer.

In various embodiments, the method can further include detecting negative feedback and intercepting the negative feedback prior to performing the social media promotion requirements. In various embodiments, the method can further include providing an offer contingent upon additional feedback, modified feedback, and/or positive feedback. In various embodiments, the method can further include refraining from performing the social media promotion requirements without positive feedback.

Another aspect provides a device configured to process a mobile payment. The device includes a processor configured to provide an offer for a transaction, the offer contingent upon a social media promotion requirements. The device further includes an interface configured to receive an authorization for the transaction and the social media promotion requirements based on the transaction. The processor can be further configured to perform the social media promotion requirements based on the transaction. The processor can be further configured to process the mobile payment after verifying the social media promotion requirements based on the transaction.

In various embodiments, the device can include one of: a smart device, laptop, desktop, smart tablet, smart phone, glasses or other wearable computing device, or any other device. In various embodiments, the offer for transaction can include a discount or other incentive based on the social media promotion requirements. In various embodiments, the social media promotion requirements can include one or more of a text message, a sound, a photograph, a video, a drawing or other image, a voicemail, a tweet, a re-tweet, a Facebook page or status, a blog, or any other social communication channel.

In various embodiments, the transaction can include a transaction related to a single product, good or service. In various embodiments, the transaction can include a transaction related to a plurality of products, goods and/or services. In various embodiments, the processor can be further configured to provide an option to refrain from authorizing the social media promotion requirements. In various embodiments, further including modifying or revoking the offer for transaction when the option to refrain from authorizing the social media promotion requirements can be chosen.

In various embodiments, the processor can be further configured to record a plurality of payment methods associated with an account. The processor can be further configured to select one payment method. Processing the mobile payment can include applying the one payment method to the transaction.

In various embodiments, the processor can be further configured to share a funding source with a secondary account or receive a shared funding source from a primary account. In various embodiments, the processor can be further configured to automatically enable or disable one or more payment methods based on a time, date, third-party, and/or location.

In various embodiments, the processor can be further configured to provide a plurality of advertisements, the advertisements prioritized based on an account referral. In various embodiments, prioritization can include one or more of: size, color, font parameters, position, media type, and effect.

In various embodiments, the processor can be further configured to provide a feedback offer to a consumer, for example, to provide an offer that solicits feedback from a consumer regarding the transaction that has occurred, or may occur, in conjunction with an incentive for completing the feedback offer and authorization for a social media promotion that meets transaction requirement(s) of the feedback offer. The processor can be further configured to receive feedback offer and authorization. The processor can be further configured to perform the social media promotion requirements based on the feedback prior to delivering the incentive. The processor can be further configured to deliver the incentive after verifying the social media promotion requirements based on the feedback.

In various embodiments, the processor can be further configured to detect negative feedback and intercept the negative feedback prior to performing the social media promotion requirements. In various embodiments, the processor can be further configured to provide an offer contingent upon additional feedback, modified feedback, and/or positive feedback. In various embodiments, the processor can be further configured to refrain from performing the social media promotion requirements without positive feedback.

Another aspect provides an apparatus for processing a mobile payment. The apparatus includes means for providing an offer for a transaction, the offer contingent upon a social media promotion requirements. The apparatus further includes means for receiving an authorization for the transaction and the social media promotion requirements based on the transaction. The apparatus further includes means for performing the social media promotion requirements based on the transaction. The apparatus further includes means for processing the mobile payment after verifying the social media promotion requirements based on the transaction.

In various embodiments, the apparatus can include any of: a smart device, laptop, desktop, smart tablet, smart phone, glasses or other wearable computing device, or any other device. In various embodiments, the offer for transaction can include a discount or other incentive based on the social media promotion requirements. In various embodiments, the social media promotion requirements can include one or more of a text message, an photograph, a video, a drawing or other image, a voicemail, a tweet, a re-tweet, a Facebook page or status, a blog, or any other social communication channel.

In various embodiments, the transaction can include a transaction related to a single product or service. In various embodiments, the transaction can include a transaction related to a plurality of products and/or services.

In various embodiments, the apparatus can further include means for providing an option to refrain from authorizing the social media promotion requirements. In various embodiments, the apparatus can further include means for modifying or revoking the offer for transaction when the option to refrain from authorizing the social media promotion requirements can be chosen.

In various embodiments, the apparatus can further include means for recording a plurality of payment methods associated with an account. The apparatus can further include means for selecting one payment method. Means for processing the mobile payment can include means for applying the one payment method to the transaction.

In various embodiments, the apparatus can further include means for sharing a funding source with a secondary account or receiving a shared funding source from a primary account. In various embodiments, the apparatus can further include means for automatically enabling or disabling one or more payment methods based on a time, date, third-party, and/or location.

In various embodiments, the apparatus can further include means for providing a plurality of advertisements, the advertisements prioritized based on an account referral. In various embodiments, prioritization can include one or more of: size, color, font parameters, position, media type, and effect.

In various embodiments, the apparatus can further include means for soliciting feedback regarding the transaction in conjunction with an incentive for completing the feedback and authorization for a social media promotion requirements based on the feedback. The apparatus can further include means for receiving feedback offer and authorization. The apparatus can further include means for performing the social media promotion requirements based on the feedback prior to delivering the incentive. The apparatus can further include means for delivering the incentive after verifying the social media promotion requirements based on the feedback.

In various embodiments, the apparatus can further include means for detecting negative feedback and intercepting the negative feedback prior to performing the social media promotion requirements. In various embodiments, the apparatus can further include means for providing an offer contingent upon additional feedback, modified feedback, and/or positive feedback. In various embodiments, the apparatus can further include means for refraining from performing the social media promotion requirements without positive feedback.

Another aspect provides a non-transitory computer-readable medium including code that, when executed, causes an apparatus to provide an offer for a transaction, the offer contingent upon a social media promotion requirements. The medium further includes code that, when executed, causes the apparatus to receive an authorization for a transaction and the social media promotion requirements based on the transaction. The medium further includes code that, when executed, causes the apparatus to perform the social media promotion requirements based on the transaction. The medium further includes code that, when executed, causes the apparatus to process the mobile payment after verifying the social media promotion requirements based on the transaction.

In various embodiments, the apparatus can include any of: a smart device, laptop, desktop, smart tablet, smart phone, glasses or other wearable computing device, or any other device. In various embodiments, the offer for transaction can include a discount or other incentive based on the social media promotion requirements. In various embodiments, the social media promotion requirements can include one or more of a text message, an photograph, a video, a drawing or other image, a voicemail, a tweet, a re-tweet, a Facebook page or status, a blog, or any other social communication channel.

In various embodiments, the transaction can include a transaction related to a single product or service. In various embodiments, the transaction can include a transaction related to a plurality of products and/or services.

In various embodiments, the medium can further include code that, when executed, causes the apparatus to provide an option to refrain from authorizing the social media promotion requirements. In various embodiments, the medium can further include code that, when executed, causes the apparatus to modify or revoke the offer for transaction when the option to refrain from authorizing the social media promotion requirements can be chosen.

In various embodiments, the medium can further include code that, when executed, causes the apparatus to record a plurality of payment methods associated with an account. The medium can further include code that, when executed, causes the apparatus to select one payment method. Processing the mobile payment can include applying the one payment method to the transaction.

In various embodiments, the medium can further include code that, when executed, causes the apparatus to share a funding source with a secondary account or receive a shared funding source from a primary account. In various embodiments, the medium can further include code that, when executed, causes the apparatus to automatically enable or disable one or more payment methods based on a time, date, third-party, and/or location.

In various embodiments, the medium can further include code that, when executed, causes the apparatus to provide a plurality of advertisements, the advertisements prioritized based on an account referral. In various embodiments, prioritization can include one or more of: size, color, font parameters, position, media type, and effect.

In various embodiments, the medium can further include code that, when executed, causes the apparatus to solicit feedback regarding the transaction in conjunction with an incentive for completing the feedback and authorization for a social media promotion requirements based on the feedback. The medium can further include code that, when executed, causes the apparatus to receive feedback offer and authorization. The medium can further include code that, when executed, causes the apparatus to perform the social media promotion requirements based on the feedback prior to delivering the incentive. The medium can further include code that, when executed, causes the apparatus to deliver the incentive after verifying the social media promotion requirements based on the feedback.

In various embodiments, the medium can further include code that, when executed, causes the apparatus to detect negative feedback and intercept the negative feedback prior to performing the social media promotion requirements. In various embodiments, the medium can further include code that, when executed, causes the apparatus to provide an offer contingent upon additional feedback, modified feedback, and/or positive feedback. In various embodiments, the medium can further include code that, when executed, causes the apparatus to refrain from performing the social media promotion requirements without positive feedback.

In various embodiments, a home page can have individual advertisement logo space. In various embodiments, the home page advertising logo space size can be assigned based on the third party vendor who registers the third party profile. In various embodiments, advertising space and size locations can be defined on a vendor sliding scale based on a third party timeline to register an incentive user. In various embodiments, an incentive user home page can have a default page if the individual user registers directly with incentive site. In various embodiments, an Incentive user can choose the adverting homepage most relevant if the Incentive user signs up directly with incentive.

In various embodiments, an incentive user can add payment information to a wallet for an individual profile for their payment transaction. In various embodiments, the wallet can be defined as a form of payment, type of payment currency and other payment features based on the incentive user's preference. In various embodiments in the wallet an incentive user can have the ability to select the form of payment options and set time restrictions for the form of payment option selected.

In various embodiments the form of payment options include but are not limited to: electronic transactions, NFC phone capabilities, incentive physical card (EMV chip), SMS, bar code, biometric, Google glasses, sound, photo, video and or any other type of electronic form of payment. In various embodiments, the type of payment currency can be to be used for payment transactions for any product and/or service(s) from a consolidate wallet profile. In various embodiments, the type of payment currencies that are available to be uploaded are credit cards, debit, ATM, credit cards, gift cards, reward cards, health, transit and any other card accepted by incentive.

In various embodiments, for each form of payment available, the incentive user can have the ability to turn the ON and OFF features in the form of payment section at any time while within their own assigned wallet icon. In various embodiments any payment features can be executed via touch, mouse click, voice comment, biometric, tapping or any electronic execution. In various embodiments, the ability to select the form of payment OFF button, when selected the OFF does not allow a payment transaction to be executed.

In various embodiments each form of payment can have the ability to set a payment alarm clock. In various embodiments the payment alarm clock allows the form of payment to be on and off during the selected and set time parameters for the incentive user. In various embodiments, set time restrictions are tied to the forms of payments selected and available for the incentive user. In various embodiments, for each form of payment currency can be an available credit balance can be listed per each currency option. In various embodiments for each form of payment currency can have the ability to grant access and share the credit card to other individual credit card holders if selected.

In various embodiments, the form of payment currency available credit for each uploaded payment currency can be available on real time basis. In various embodiments, a primary cardholder can be able to grant available credit to another incentive user who can have registered and can have an incentive user profile. In various embodiments the primary incentive user can have the ability to review the share card assigned that can be in current use. In various embodiments, the primary incentive user can have the ability to terminate the shared use at any time.

In various embodiments, an incentive user of a product and/or service(s) can be required to execute social media parameters prior to the transaction of the product and/or service(s) for a promotional incentive(s) to be applied for the specific product and/or service(s) payment transaction. In various embodiments, execution can be from any electronic device including but not limited to any smart device, laptop, desktop, smart tablet, smart phones, glasses or any electronic device. In various embodiments, social media communication parameters are but not limited to SMS, pictures—.jpg, etc., video, drawing, voicemail, Twitter™ tweet, retweet, Facebook™ page, blog, or any other social communication channel.

In various embodiments, an incentive user of a product and/or service(s) can be required to execute social media parameters prior to the transaction of one product and/or service for a promotional incentive(s) to be applied for the specific product and/or service payment transaction. In various embodiments, an incentive user of a product and/or service(s) can be required to execute social media parameters prior to the transaction of more than one product and/or service(s) for a promotional incentive(s) to be applied for the specific product and/or service(s) payment transaction.

In various embodiments, an incentive user of a product and/or service(s) can be presented the option to execute social media parameters prior to the transaction of one or more product and/or service(s) for a promotional incentive(s) to be applied for the specific product and/or service(s) payment transaction. In various embodiments, refers to claim directly above, if the option can be to not select to execute social media parameters prior to the transaction, the incentive user does not receive the product and/or service(s) incentives. In various embodiments, an incentive user of a product and/or service(s) can be presented the option to execute social media parameters prior to the transaction of one or more product and/or service(s) for a sliding scale promotional incentive(s) to be applied for the specific product and/or service(s) payment transaction.

In various embodiments, an incentive user can post social media parameters post payment transaction for an individual product and/or service(s) set feedback parameters to receive a promotional incentive. In various embodiments, an incentive user can have the option to select post social media parameters post payment transaction for an individual product and/or service(s) set feedback parameters for a promotional incentive(s).

In various embodiments, if the incentive user decides to execute the social media parameters for the product and/or service(s) feedback prior to submitting the feedback parameters the incentive user can be granted a promotional incentive for future transactions. In various embodiments, if the incentive user decides not to execute the social media parameters for the product and/or service(s) feedback prior to submitting the feedback parameters the incentive user can be not be granted or a decreased promotion incentive for future transactions.

In various embodiments, an individual can be required to meet social parameters prior to submitting set feedback parameters to receive promotion incentive(s) for future transactions. In various embodiments, an incentive user can be required to execute social media parameters for the set feedback criteria prior to submitting the general set feedback criteria to receive a promotion incentive for future transactions. In various embodiments, if an incentive user elects not to not execute social media parameters for the set feedback criteria prior to submitting the general set feedback criteria a promotion incentive for future transactions can be not granted.

In various embodiments, an alert icon appears on the incentive home page along with a streaming message and a message pops in when the Incentive user clicks or opens the incentive home page. In various embodiments, if the home page can be not accessed within a time parameters set for an Alert feedback notice to reach the individual profile, a SMS message can be sent directly the incentive individual phone number listed with the same Alert icon message streaming. In various embodiments, an Alert icon can be defined with an Alert title, link for an Alert message with key information provided, instructions and next steps.

In various embodiments, an Alert message page can be defined with key Alert message information and customer service features for this specific Alert for the incentive user profile. In various embodiments, an Alert customer service can be defined where specific customer service parameters are to be answered from the incentive user profile. In various embodiments, an incentive user can submit their answers to the third party issuing the Alert to create a customer service ticket for the third party to take action upon. In various embodiments, prior to an Alert can be submitted, incentive users send out a social media post to alert their contacts on their current status, alert link information for customer service.

Another aspect provides a method. The method includes storing account information for a plurality of consumers, for each particular consumer of the plurality of consumers, the account information including a unique consumer identifier associated with the particular consumer, at least one social media venue identifier associated with the unique consumer identifier and indicating a social media venue that the particular consumer has registered with, and access information to the at least one social media venue, the access information being associated with the unique consumer identifier, the access information being sufficient to allow a computer to, upon receiving authorization from the particular consumer, access the at least one social media venue and provide an update on the at least one social media venue of the particular consumer. The method further includes providing an offer for a transaction to a consumer associated with a unique consumer identifier and having stored account information, the transaction including providing an incentive to the consumer, the incentive contingent on receiving a first input in response to the offer that meets transaction requirements, the first input including a unique consumer identifier, the transaction requirements including an authorization from the consumer for a selected social media update to occur on at least one social media venue associated with the unique identifier of the consumer providing the first input, using the stored account information of the consumer providing the input. The method further includes receiving the first input in response to the offer, the first input associated with a unique consumer identifier. The method further includes validating the received first input by determining whether the first input meets the transaction requirements. The method further includes, if the first input passes validation, performing the selected social media update on the at least one social media venue of the consumer associated with the consumer identifier and using the stored account information associated with the consumer identifier. The method further includes providing the incentive to the consumer after the selected social media update on the at least one social media venue of the consumer has occurred.

In various embodiments, said performing the selected social media update can include providing at least a portion of the first input received in response to the offer and providing stored access information associated with the consumer identifier to at least one computer configured to perform the selected social media update on the at least one social media venue using the access information and at least a portion of the first input.

In various embodiments, said providing an offer for a transaction can include providing the offer to a portable computing device associated with the unique consumer identifier, wherein the method further can include receiving the offer on the portable computing device. Providing an offer can further include displaying indicia of the offer on a display screen of the portable computing device. Providing an offer can further include receiving a first input in response to the offer at an electronic interface of the portable computing device. Providing an offer can further include sending the first input in a wireless transmission from the portable computing device. Providing an offer can further include displaying, on the display screen of the portable computing device, indicia indicating receipt of the incentive.

In various embodiments, the incentive can include a product, a service, a discount for a product, or a discount for a service. In various embodiments, the incentive can include a financial incentive, a non-financial incentive, or both a financial incentive and a non-financial incentive. In various embodiments, the offer can be a monetary offer or a non-monetary offer.

In various embodiments, said storing account information can include storing the account information on a server computer system, and wherein the portable computing device can include a wireless client device capable of communicating with the server computer system.

In various embodiments, the method can further include validating the response to the offer on the portable computing device. In various embodiments, the first input can include at least one of an image, a video, or electronic data file. In various embodiments, the portable computing device can include a laptop computer, a tablet computer, a smart phone, or glasses or other wearable computer device.

In various embodiments, the incentive can include a discount, coupon, gift card, membership, product, good or service. In various embodiments, the at least one social media venue can include Facebook, Twitter, Instagram, Yelp or Foursquare. In various embodiments, the selected social media update can include providing an update to at least one social media venue having a social media identifier associated with the unique consumer identifier, and wherein the update can include one or images.

In various embodiments, the offer can include an offer to purchase an item from a third party, wherein the offer for a transaction can be provided by a platform provider, and wherein and the transaction requirements include receiving authorization for the platform provider to process a payment for the item with the third party on behalf of the consumer.

In various embodiments, the method can further include receiving inventory information from a third party via a communication network, the inventory information having at least one indicia of an item to include in the offer and that will be provided to the consumer if the transaction requirements are met.

In various embodiments, the account information further can include, for each particular consumer, payment information associated with the unique consumer identifier, the payment information having at least one payment source and being sufficient to make payments to a third party on behalf of the consumer. The method can further include receiving at the platform provider, via a network and communicated from a computing device, an authorization to pay the third party for the item, the authorization being associated with a unique consumer identifier, and wherein the first input can include the authorization. The method can further include retrieving, at the platform provider, payment information that can be associated with the unique consumer identifier, after receiving the authorization to pay the third party. The method can further include providing payment information from the platform provider to the third party to transact a payment of the item for the consumer associated with the unique consumer identifier.

In various embodiments, the method can further include receiving, from the third party via a network, an electronic communication that can include data representative of a displayable offer graphic for presenting on a display screen of a computing device for visually conveying information about the offer for the item.

In various embodiments, providing the offer can include providing, via a communication network, data representative of the displayable offer graphic to a computing device. In various embodiments, the method can further include providing to the third party a customizable displayable offer graphic. In various embodiments, the method can further include receiving the data representative of the displayable offer graphic from the platform provider, and displaying the displayable offer graphic on a display of a computing device.

In various embodiments, for at least one of the plurality of consumers, the account information further can include contact data associated with at least one person, the contact data sufficient to send a communication to the at least one person, and wherein performing the selected social media update can include sending a communication indicating that the consumer to the at least one person.

In various embodiments, the method can further include receiving a second input having the same consumer identifier as the first input, the second input including feedback related to the transaction. The method can further include validating the second input based on second transaction requirements. The method can further include, if the second input passes validation, performing a second selected social media update on the at least one social media venue of the consumer associated with the consumer identifier. The method can further include providing a second incentive to consumer after the second selected social media update has occurred.

Another aspect provides a device configured to process a mobile payment. The device includes a processor configured to provide an offer for a purchase, the offer contingent upon a social media promotion. The device further includes an interface configured to receive an authorization for the purchase and the social media promotion based on the purchase. The processor is further configured to perform the social media promotion based on the purchase. The processor is further configured to process the mobile payment after verifying the social media promotion based on the purchase.

In various embodiments, the device can include one of: a smart device, laptop, desktop, smart tablet, smart phone, glasses or other wearable computing device, or any other device. In various embodiments, the offer for purchase can include a discount or other incentive based on the social media promotion. In various embodiments, the social media promotion can include one or more of a text message, an photograph, a video, a drawing or other image, a voicemail, a tweet, a re-tweet, a Facebook page or status, a blog, or any other social communication channel.

In various embodiments, the purchase can include a transaction related to a single product or service. In various embodiments, the purchase can include a transaction related to a plurality of products and/or services. In various embodiments, the processor can be further configured to provide an option to refrain from authorizing the social media promotion.

In various embodiments, the processor can be further configured to modify or revoke the offer for purchase when the option to refrain from authorizing the social media promotion can be chosen.

In various embodiments, the processor can be further configured to record a plurality of payment methods associated with an account. The processor can be further configured to select one payment method. Processing the mobile payment can include applying the one payment method to the purchase.

In various embodiments, the processor can be further configured to associate the payment method with at least one funding source. In various embodiments, the funding source can include any of: a credit card, a gift card, a debit card, an automatic teller machine (ATM) card, a reward card, a health card, a transit card, a checking, savings, or other bank account, an electronic payment account, a phone card, and any other electronically accessible funding source.

In various embodiments, the processor can be further configured to share a funding source with a secondary account or receive a shared funding source from a primary account. In various embodiments, the processor can be further configured to automatically enable or disable one or more payment methods based on a time, date, merchant, and/or location.

In various embodiments, the processor can be further configured to provide a plurality of advertisements, the advertisements prioritized based on an account referral. In various embodiments, prioritization can include one or more of: size, color, font parameters, position, media type, and effect.

In various embodiments, the processor can be further configured to solicit feedback regarding the purchase in conjunction with an incentive for completing the feedback and authorization for a social media promotion based on the feedback. The processor can be further configured to receive said feedback and authorization. The processor can be further configured to perform the social media promotion based on the feedback prior to delivering the incentive. The processor can be further configured to deliver the incentive after verifying the social media promotion based on the feedback.

In various embodiments, the processor can be further configured to detect negative feedback and intercept the negative feedback prior to performing the social media promotion. In various embodiments, the processor can be further configured to provide an incentive offer contingent upon additional feedback, modified feedback, and/or positive feedback. In various embodiments, the processor can be further configured to refrain from performing the social media promotion without positive feedback.

Another aspect provides an apparatus for processing a mobile payment. The apparatus includes means for providing an offer for a purchase, the offer contingent upon a social media promotion. The apparatus further includes means for receiving an authorization for the purchase and the social media promotion based on the purchase. The apparatus further includes means for performing the social media promotion based on the purchase. The apparatus further includes means for processing the mobile payment after verifying the social media promotion based on the purchase.

In various embodiments, the apparatus can include any of: a smart device, laptop, desktop, smart tablet, smart phone, glasses or other wearable computing device, or any other device. In various embodiments, the offer for purchase can include a discount or other incentive based on the social media promotion. In various embodiments, the social media promotion can include one or more of a text message, an photograph, a video, a drawing or other image, a voicemail, a tweet, a re-tweet, a Facebook page or status, a blog, or any other social communication channel.

In various embodiments, the purchase can include a transaction related to a single product or service. In various embodiments, the purchase can include a transaction related to a plurality of products and/or services. In various embodiments, the apparatus can further include means for providing an option to refrain from authorizing the social media promotion.

In various embodiments, the apparatus can further include means for modifying or revoking the offer for purchase when the option to refrain from authorizing the social media promotion can be chosen.

In various embodiments, the apparatus can further include means for recording a plurality of payment methods associated with an account. The apparatus can further include means for selecting one payment method. Means for processing the mobile payment can include means for applying the one payment method to the purchase.

In various embodiments, the apparatus can further include means for associating the payment method with at least one funding source. In various embodiments, the funding source can include any of: a credit card, a gift card, a debit card, an automatic teller machine (ATM) card, a reward card, a health card, a transit card, a checking, savings, or other bank account, an electronic payment account, a phone card, and any other electronically accessible funding source.

In various embodiments, the apparatus can further include means for sharing a funding source with a secondary account or receiving a shared funding source from a primary account. In various embodiments, the apparatus can further include means for automatically enabling or disabling one or more payment methods based on a time, date, merchant, and/or location. In various embodiments, the apparatus can further include means for providing a plurality of advertisements, the advertisements prioritized based on an account referral. In various embodiments, prioritization can include one or more of: size, color, font parameters, position, media type, and effect.

In various embodiments, the apparatus can further include means for soliciting feedback regarding the purchase in conjunction with an incentive for completing the feedback and authorization for a social media promotion based on the feedback. The apparatus can further include means for receiving said feedback and authorization. The apparatus can further include means for performing the social media promotion based on the feedback prior to delivering the incentive. The apparatus can further include means for delivering the incentive after verifying the social media promotion based on the feedback.

In various embodiments, the apparatus can further include means for detecting negative feedback and intercepting the negative feedback prior to performing the social media promotion. In various embodiments, the apparatus can further include means for providing an incentive offer contingent upon additional feedback, modified feedback, and/or positive feedback. In various embodiments, the apparatus can further include means for refraining from performing the social media promotion without positive feedback.

Another aspect provides a non-transitory computer-readable medium. The medium includes code that, when executed, causes an apparatus to provide an offer for a purchase, the offer contingent upon a social media promotion. The medium further includes code that, when executed, causes the apparatus to receive an authorization for a purchase and the social media promotion based on the purchase. The medium further includes code that, when executed, causes the apparatus to perform the social media promotion based on the purchase. The medium further includes code that, when executed, causes the apparatus to process the mobile payment after verifying the social media promotion based on the purchase.

In various embodiments, the apparatus can include any of: a smart device, laptop, desktop, smart tablet, smart phone, glasses or other wearable computing device, or any other device. In various embodiments, the offer for purchase can include a discount or other incentive based on the social media promotion. In various embodiments, the social media promotion can include one or more of a text message, an photograph, a video, a drawing or other image, a voicemail, a tweet, a re-tweet, a Facebook page or status, a blog, or any other social communication channel.

In various embodiments, the purchase can include a transaction related to a single product or service. In various embodiments, the purchase can include a transaction related to a plurality of products and/or services.

In various embodiments, the medium can further include code that, when executed, causes the apparatus to provide an option to refrain from authorizing the social media promotion. In various embodiments, the medium can further include code that, when executed, causes the apparatus to modify or revoke the offer for purchase when the option to refrain from authorizing the social media promotion can be chosen.

In various embodiments, the medium can further include code that, when executed, causes the apparatus to record a plurality of payment methods associated with an account. The medium can further include code that, when executed, causes the apparatus to select one payment method. Processing the mobile payment can include applying the one payment method to the purchase.

In various embodiments, the medium can further include code that, when executed, causes the apparatus to associate the payment method with at least one funding source. In various embodiments, the funding source can include any of: a credit card, a gift card, a debit card, an automatic teller machine (ATM) card, a reward card, a health card, a transit card, a checking, savings, or other bank account, an electronic payment account, a phone card, and any other electronically accessible funding source.

In various embodiments, the medium can further include code that, when executed, causes the apparatus to share a funding source with a secondary account or receive a shared funding source from a primary account. In various embodiments, the medium can further include code that, when executed, causes the apparatus to automatically enable or disable one or more payment methods based on a time, date, merchant, and/or location. In various embodiments, the medium can further include code that, when executed, causes the apparatus to provide a plurality of advertisements, the advertisements prioritized based on an account referral. In various embodiments, prioritization can include one or more of: size, color, font parameters, position, media type, and effect.

In various embodiments, the medium can further include code that, when executed, causes the apparatus to solicit feedback regarding the purchase in conjunction with an incentive for completing the feedback and authorization for a social media promotion based on the feedback. The medium can further include code that, when executed, causes the apparatus to receive said feedback and authorization. The medium can further include code that, when executed, causes the apparatus to perform the social media promotion based on the feedback prior to delivering the incentive. The medium can further include code that, when executed, causes the apparatus to deliver the incentive after verifying the social media promotion based on the feedback.

In various embodiments, the medium can further include code that, when executed, causes the apparatus to detect negative feedback and intercept the negative feedback prior to performing the social media promotion. In various embodiments, the medium can further include code that, when executed, causes the apparatus to provide an incentive offer contingent upon additional feedback, modified feedback, and/or positive feedback. In various embodiments, the medium can further include code that, when executed, causes the apparatus to refrain from performing the social media promotion without positive feedback.

In various innovations, a method may include providing on a display of a portable or non-portable computing device an offer for a transaction, the offer having at least one requirement that must be met for the transaction to occur, the transaction including providing a benefit to a user in exchange for a social media promotion relating to the offer if the offer can be accepted and the at least one requirement of the offer can be met. The method further includes receiving an input through an electronic interface at the computing device, the input indicating acceptance of the offer and the input including input information for meeting the at least one requirement. The method further includes providing the input from the computing device to a server in communication through a network with the computing device. The method further includes validating the input at the server to determine if the input information meets the at least one requirement of the offer. The method further includes performing the transaction if the input meets the at least one requirement of the offer, the transaction including providing user information and offer information from the server through a network to one or more computers configured to provide a promotion on at least one social media outlet pre-approved by the user, the promotion indicative that the user can be using a product or service related to the offer, the user information including data to allow the one or more computers to provide the promotion on social media for the particular user that accepted the offer. The method further includes providing a transaction status to the computing device, the transaction status indicating that the promotion occurred and that the user will receive the benefit.

### BRIEF DESCRIPTION OF THE DRAWINGS

FIG. 1 is a schematic that illustrates an example of an e-commerce system, according to various embodiments.

FIG. 2 is a flow chart illustrating an example of a process for managing incentive transaction.

FIGS. 3, 3A, 4, 5-14, 15, 15A, 16-20, 21, 21A, 21B, 21C, 22, 23, 23A, 23B and 24-30 illustrate examples of user interfaces, sometime referred to herein as “incentive interfaces” that may be displayed on a computing device, for example, a wireless portable communication device (e.g., a smartphone, laptop computer, tablet computer) according to various embodiments. The computing device is configured to communicate with a platform provider computer server system through a communication network. A transaction component may reside on the computing device and communicate with the server system to send and receive information (data), including information to support displaying a user interface or support displaying information within the user interface.

FIG. 31 is an example of a screenshot that may be displayed on a computer display illustrating a “dashboard” for displaying various information to a consumer (user).

FIG. 32 is a functional block diagram illustrating an example of certain components of a wireless device that can be employed within the e-commerce system of FIG. 1 to communicate with a server system. In some examples, the wireless device may also be referred to herein as a client device or a portable computing device.

FIG. 33 is a functional block diagram that illustrates various components that can be utilized in a device that can be employed within the e-commerce system of FIG. 1.

FIG. 34 is a schematic that illustrates a depiction of an incentive system.

FIGS. 35A and 35B are flowcharts that together illustrate an example of an incentive process.

FIGS. 36A and 36B are flowcharts that together illustrate an example of a search process.

FIGS. 37A and 37B are flowcharts that together illustrate an example of a process for using an electronic wallet.

FIGS. 38A and 38B are flowcharts that together illustrate an example of a process of incentive deals.

FIGS. 39A and 39B are flowcharts that together illustrate an example of a process of incentive food purchase processes.

FIGS. 40A and 40B are flowcharts that together illustrate an example of another incentive process.

FIGS. 41A and 41B are flowcharts that together illustrate an example of another incentive process for providing post purchase feedback.

FIGS. 42A and 42B are flowcharts that together illustrate an example of another incentive process for providing focus group feedback.

FIGS. 43A and 43B are flowcharts that together illustrate an example of another incentive process for providing any time feedback.

FIGS. 44A and 44B are flowcharts that together illustrate an example of a merchant inventory upload process.

FIGS. 45A and 45B are flowcharts that together illustrate an example of a merchant customer (consumer) checkout process.

FIG. 46 illustrates an example of an incentive process that can be performed on a computer server system and a client computing device, for example a wireless client computing device.

FIG. 47 illustrates an example of an incentive system that can include a computer server system and a plurality of client computing devices, for example, wireless client computing devices.

### DETAILED DESCRIPTION

The word “exemplary” is used herein to mean “serving as an example, instance, or illustration.” Any embodiment described herein as “exemplary” is not necessarily to be construed as preferred or advantageous over other embodiments. Various aspects of the novel systems, apparatuses, and methods are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus can be implemented or a method can be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein can be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

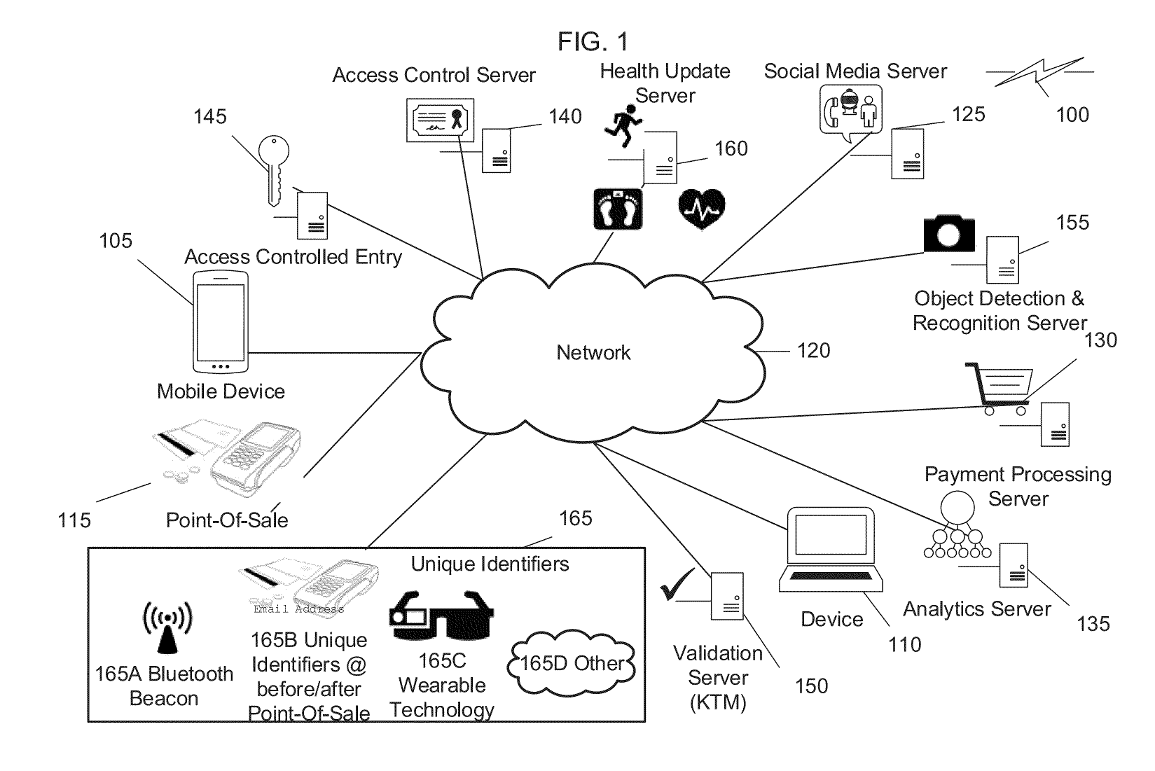

FIG. 1 illustrates an exemplary e-commerce system 100, according to an embodiment. The e-commerce system 100 includes a mobile device 105, a device 110, a point-of-sale (POS) 115, a network 120, a social media server 125, a payment processing server 130, an analytics server 135, an access control server 140, and an access controlled entry 145, validation server (KTM, health update server 160, and unique identifiers server 165. Although various components of the e-commerce system 100 are shown in FIG. 1, a person having ordinary skill in the art will appreciate that different components can be used, additional components can be added, one or more components can be omitted, and/or individual component functionality can be separated or combined.

The mobile device 105 can include any one of, for example, a cell phone, a smart phone, a personal digital assistant (PDA), a laptop, a tablet computer, a wearable computing device, etc. The mobile device 105 can be configured to access the network 120, for example via a wireless connection such as WIFI or a cellular connection. In various embodiments, the mobile device 105 can run a mobile operating system such as, for example, iOS or Android. The mobile device 105 can include an incentivized media application associated with an incentive account, as described in greater detail herein.

Although various embodiments are described herein with respect to the mobile device 105, a person having ordinary skill in the art will appreciate that any suitable device can be used such as, for example, the device 110. The device 110 can include any one of, for example, a cell phone, a smart phone, a personal digital assistant (PDA), a laptop, a tablet computer, a wearable computing device, a desktop personal computer, etc. The device 110 can include a wired or wireless connection to the network 120.

In various embodiments, the mobile device 105 can be configured to facilitate a transaction with the POS 115. The POS 115 can include, for example, a third-party terminal (such as a cash register, handheld payment method, etc.), a World Wide Web shopping cart and/or checkout system, etc. The POS 115 can be configured to access the network 120, for example via a wireless connection such as WIFI or a cellular connection.

The network 120 can include one or more wired or wireless networks configured to facilitate electronic communication between one or more of the mobile device 105, the device 110, the POS 115, the social media server 125, the payment processing server 130, the analytics server 135, the access control server 140, and the access controlled entry, health update server 160 and unique identifiers server 165. The network 120 can include, for example, the Internet.

The social media server 125 can provide one or more services configured to allow the sharing of messages such as, for example, review services, short message broadcasting services, image sharing services, discussion for a, email services, text-message services, etc. The social media server 125 can facilitate broadcast, unicast, or groupcast-type message sharing. In various embodiments, the social media server 125 can provide social media services such as, for example, Yelp, Twitter, Facebook, Four Square, Instagram, etc. The social media server 125 can be configured to access the network 120, for example via a wireless connection such as WIFI or a cellular connection. In some embodiments, the social media server 125 can provide an application programming interface (API).

In various embodiments, the mobile device 105 can be configured to send social media updates to the social media server 125. In some embodiments, the incentive application on the mobile device 105 can incentivize one or more social media updates. Such incentivized social media updates can be referred to herein as social media promotion requirements.

The payment processing server 130 can provide one or more services configured to store payment information and/or process payments. For example, the payment processing server 130 can store one or more payment methods associated with the incentive account. Payment methods can include, for example, specific credit cards, gift cards, debit cards, automatic teller machine (ATM) cards, healthcare cards, digital currency accounts, checking and savings accounts, home equity or other lines of credit, etc. The payment processing server 130 can be configured to access the network 120, for example via a wireless connection such as WIFI or a cellular connection.

The analytics server 135 can provide one or more services configured to analyze transactions, social media promotion requirements, and post-transaction feedback associated with the incentive account or any unique identifiers 165, offer transaction or any other consumer behavior processed through health update server 160, unique identifiers 165, validation server 150, objet detection and recognition server 155, social media 125, payment processing server 130 or any other server to provide consumer specific data. For example, the analytics server 135 can analyze social media posts and promotions, direct and indirect feedback, consumer demographics, and the like. The analytics server 135 can provide analyses and forecasts, for example via a World Wide Web dashboard, to the mobile device 105 and/or the device 110. The analytics server 135 can be configured to access the network 120, for example via a wireless connection such as WIFI or a cellular connection.

The access control server 140 can be configured to control the access controlled entry 145. For example, the access control server 140 can receive an access code entered at the access controlled entry 145, compare the access code to a list of authorized access codes, and transmit an access authorization to the access controlled entry 145 when the received access code is in the list of authorized access codes. In various embodiments, the access code can be provided via a magnetic strip, a barcode, a near-field-communications (NFC) transmission, etc. For example, the mobile device 105 can include an NFC module configured to transmit the access code. In an embodiment, the access control server 140 can provide an authorized access code to the mobile device 105, which can be configured to receive a programmable access code.

The access controlled entry 145 can include, for example, a door, a subway turnstile, a public transit payment terminal, etc. The access controlled entry 145 can receive an access code, for example via a magnetic strip, a barcode, or an NFC transmission. In an embodiment, the access controlled entry 145 can transmit the access code to the access control server 140, and can receive a response indicative of an access authorization. The access controlled entry 145 can allow or deny entry based on the received access code.

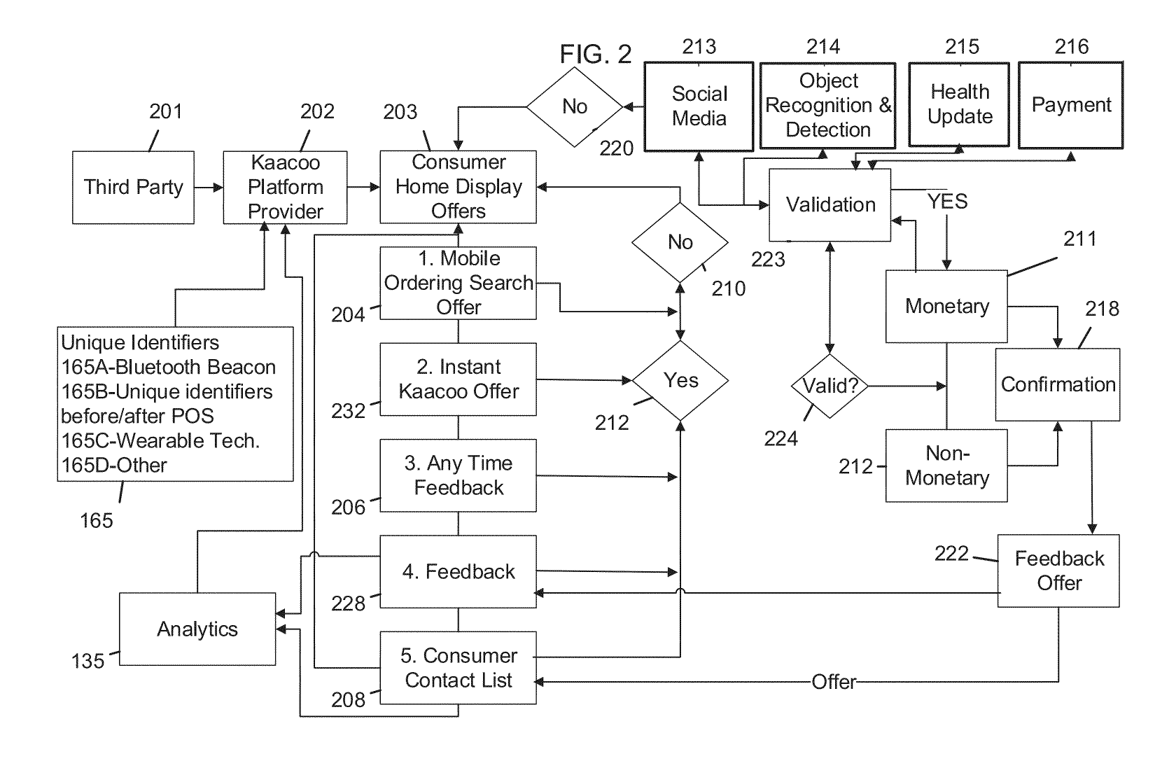

FIG. 2 is a flow chart 200 illustrating an exemplary process for managing social media promotion requirement process. The process can be implemented in whole or in part by any of the devices described herein, such as the mobile device 105, the device 110, the POS 115, and the servers 125, 130, and 135, described above with respect to FIG. 1. Although the illustrated process is described herein with reference to the components of the e-commerce system 100 of FIG. 1, a person having ordinary skill in the art will appreciate that the illustrated process can be implemented by another device described herein, or any other suitable device. Although the illustrated process is described herein with reference to a particular order, in various embodiments, blocks herein can be performed in a different order, or omitted, and additional blocks can be added.

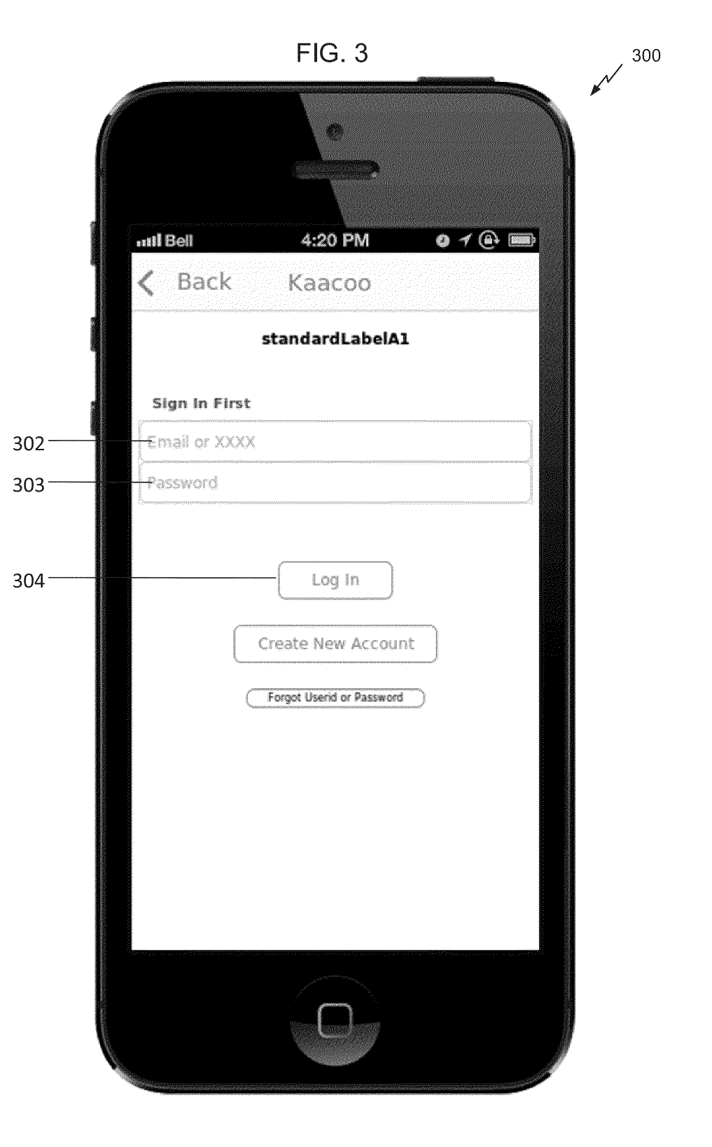

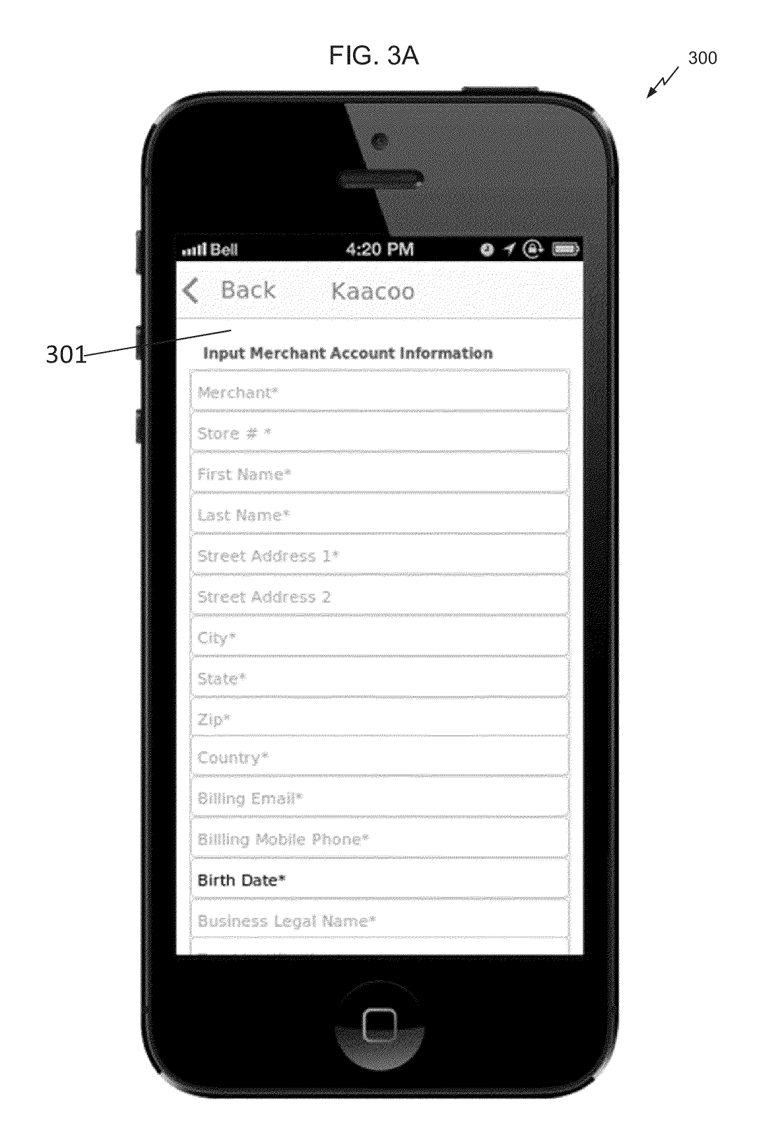

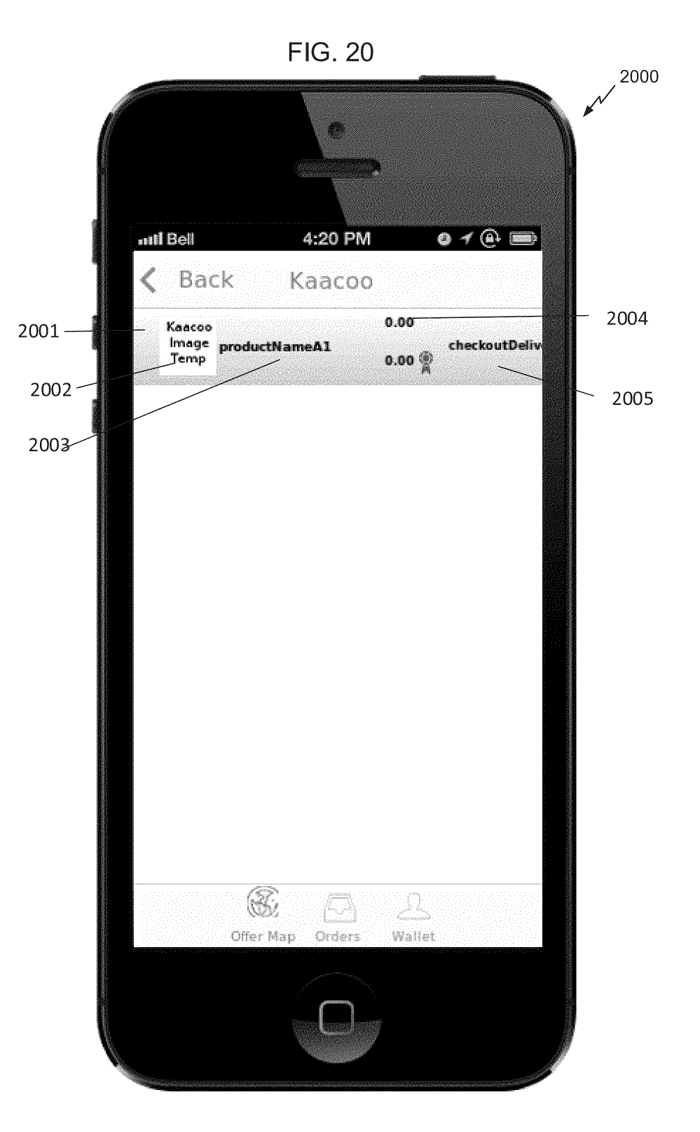

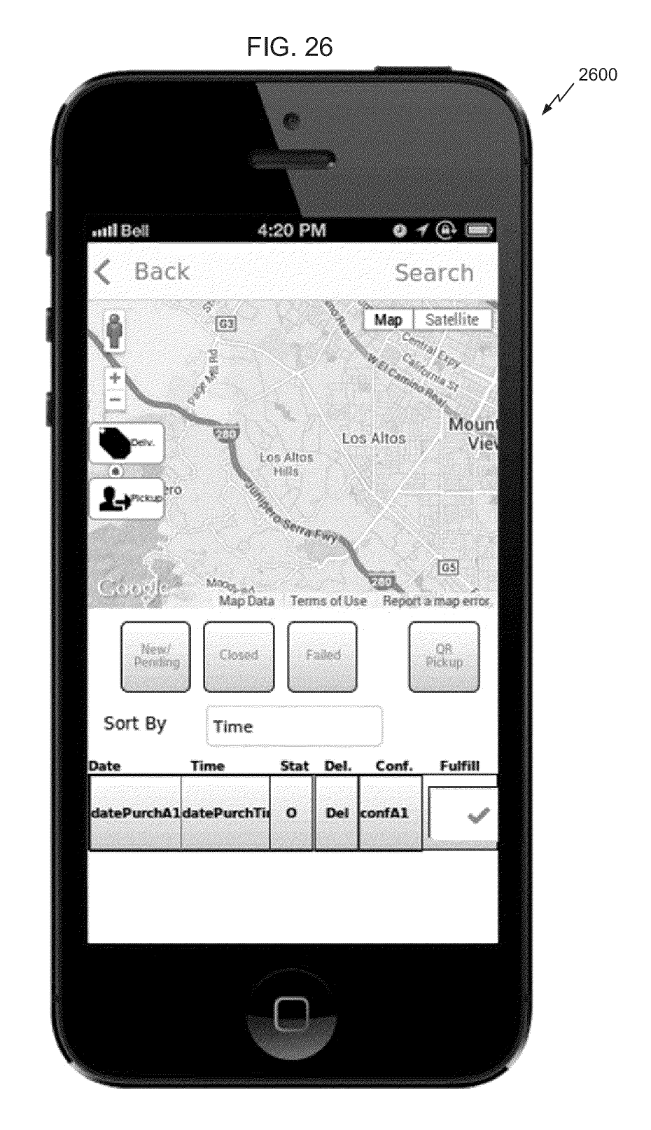

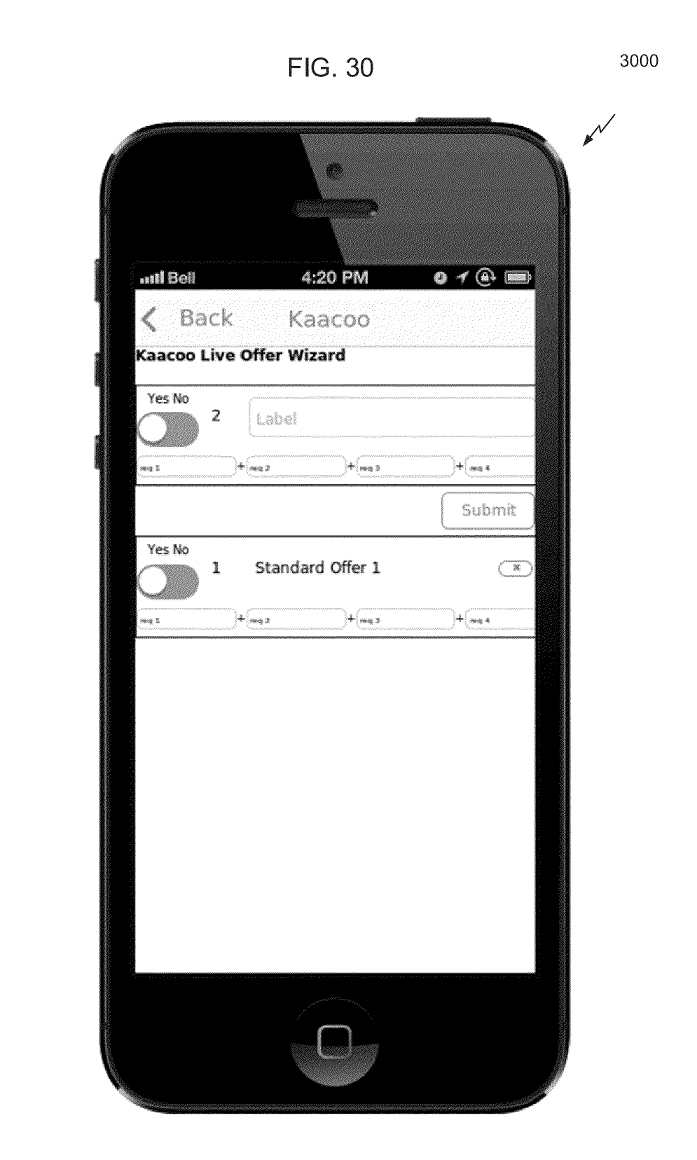

First, at block 203, the mobile device 105 runs an incentive application. In various embodiments, the incentive application can include any of the interfaces described herein with respect to FIGS. 3-30. For example, in various embodiments, the incentive application can provide a consumer with one or more offers for transaction with offers such as instant Kaacoo monetary offers, instant Kaacoo nonmonetary offers, instant Kaacoo photo offers, health update offers, alert offers, any time feedback offers or an opportunity to provide feedback offers on a transaction, any time feedback, product, goods or service, events or any item or for a feedback requests. An “item” when used herein, is a broad term that refers to something that can be conveyed to a person (consumer), for example but not limited to, a good, a service, a whole or partial discount for a good, service or event, sign-up for participation in an event or group, an entry, and can be a monetary or non-monetary item.

In one embodiment, at block 204, the mobile device 105 displays a list of mobile ordering search items available for transaction. The mobile ordering search items can include products, goods and/or services. In some embodiments, one or more mobile ordering search items can be associated with an offer contingent upon social media promotion requirements. For example, one or more mobile ordering search items can be associated with an inventive i.e. a discount contingent on one or more of a tweet, a Facebook post, etc. In various embodiments, the offer can be displayed with associated mobile ordering search items and incentives.

Then, at block 204, a user can select a menu item for transaction. For example, the user can navigate a list of mobile ordering search items. The user can search for mobile ordering search items or filter the list of mobile ordering search items based on one or more criteria such as third-party name, product or service name, price, incentive amount, incentive type, location, product or service feature, etc.

Next, at block 204, 232, 206, 228, and 208, the mobile device 105 displays an offer. In an embodiment, the offer can be contingent on completing a social media promotion requirements prior to transaction. For example, the mobile device 105 can display an option to transaction the selected menu item at a discount if the user authorizes the mobile device 105 (or the social media server 125) to initiate a social media promotion requirements on behalf of the user. In an embodiment, the offer can be contingent on completing a social media promotion requirements after transaction. In various embodiments, the offer can be contingent on a plurality of social media promotion requirements, and a value of the offer can increase based on one or more of a number of social media promotion requirements, a number of social media networks included, a number or quality of the audience for the social media promotion requirements, etc.

At block 210, if the user declines the offer, the mobile device 105 refrains from initiating the social media promotion requirements. In an embodiment, the mobile device 105 can continue to block 216 to complete the transaction without applying the incentive. For example, the mobile device 105 can process transaction at a non-discounted price (non-monetary).

At block 212, if the user accepts the offer, the mobile device 105 (or the social media server 125) initiates the social media promotion requirements on behalf of the user. For example, the mobile device 105 can transmit the social media promotion requirements to the social media server 125. In various embodiments, the mobile device 105 can transmit a plurality of social media promotion requirements to a plurality of social media servers 125. In an embodiment, the user can transmit the social media promotion requirements. The mobile device 105 can confirm the social media promotion requirements, for example by contacting the social media server 125. In an embodiment, the mobile device 104 can transmit an authorization for the social media promotion requirements, for example to the social media server 125, and the social media server 125 can complete the social media promotion requirements.

In an embodiment, at block 234, the mobile device 105 can issue a coupon based on the social media promotion requirements. For example, in circumstances where the transaction will not or cannot be completed immediately, the coupon may provide a discount in the amount of the offer. Such circumstances can include, for example, users without active payment types or payment sources in their wallet, transactions completed away from the POS 115, etc.

In an embodiment, at block 224, the mobile device 105 can complete payment for the selected item. For example, the mobile device 105 can transmit the payment to the payment processing server 216. In an embodiment, the mobile device 105 can transmit a payment authorization to the payment processing server 216, and the payment processing server 216 can complete payment. The payment processing server 216 can determine a payment source associated with the incentive account and initiate payment. In various embodiments, payment can be transmitted to a third-party such as, for example, to the POS 115.

Next, at block 218, the mobile device 105 receives and/or displays a confirmation for the transaction. The confirmation can include a number associated with the transaction, a barcode, a receipt, or the like.

Thereafter, at block 218, the user can receive the transaction, product or service. For example, the third-party can ship the item. As another example, the user can show the confirmation to the third-party in exchange for the transaction, item. As another example, the POS 115 can directly receive the confirmation, for example, from the payment processing server 216.

Subsequently, at block 222, the mobile device 105 can display a request for feedback. In some embodiments, the mobile device 105 can offer an incentive for feedback such as, for example, a discount or coupon. In some embodiments, the mobile device 105 only offers an incentive for feedback after a user declines a first request for feedback.

At block 224, if the user agrees to provide feedback, the mobile device 105 proceeds to receive the feedback at block 228.

At block 226, if the user declines to provide feedback, the mobile device 105 can display the incentive application home screen at block 203. In an embodiment, the mobile device 105 can offer an enhanced incentive for feedback after a user declines a first request for feedback. For example, the incentive can include a larger discount.

At block 228, the mobile device receives the feedback. The mobile device 105 can transmit the feedback to the analytics server 135. In various embodiments, the mobile device 105 can offer an incentive for transmitting the feedback as social media promotion requirements. The mobile device 105 can transmit the feedback to the social media server 125 as a social media promotion requirements at block 213. In an embodiment, the mobile device 105 or analytics server 135 can identify negative feedback and refrain from posting negative feedback as a social media promotion requirements. In an embodiment, the mobile device 105 can offer an incentive for transmitting positive feedback as a social media promotion requirements.

In an embodiment, at block 232, the mobile device 105 can present an instant Kaacoo offer that is single offer contingent upon social media promotion requirements (in contrast to the list of mobile ordering search items displayed at block 204). For example, an instant Kaacoo offer can be displayed as an advertisement on a home screen, as a pop-up offer, as an alert, etc. The instant Kaacoo offer can monetary or a non-monetary type of offer. In various embodiments, the user can choose to transaction the item or not.

Next, at block 232, 206, 228, if the user chooses to transact the offer, the mobile device proceeds to display additional details for the offer at block 212. In an embodiment, the offer can be contingent on completing a social media promotion requirements prior to transaction. For example, the mobile device 105 can display an option to transaction the item at a discount if the user authorizes the mobile device 105 (or the social media server 125) to initiate a social media promotion requirements on behalf of the user. In an embodiment, the offer can be contingent on completing a social media promotion requirements after transaction (222). In various embodiments, the offer can be contingent on a plurality of social media promotion requirements, and a value of the offer can increase based on one or more of a number of social media promotion requirements, a number of social media networks included, a number or quality of the audience for the social media promotion requirements, etc. If the user chooses to accept the offer, the mobile device proceeds to process the social media promotion requirements at block 212. In various embodiments, transaction of the item is contingent on the social media promotion requirements.

The Unique identifier are servers or a type of technology that identify unique identifiers such as a Beacon 165A, At or after pos transaction 165B, wearable technology 165C i.e. google glass or any other technology device identifies a unique identifier. A unique identifier can be a unique data set that can be in a form of a data string, image, code, text, sound, or any other representation for a unique identifier.

The 165A beacon technology is where the consumer unique ID is identified through a beacon technology. The offer is tied to the beacon and the consumer unique ID. A beacon is a Bluetooth Low Energy Beacon. This technology can send an unique identifier to nearby Bluetooth 4.0 enabled devices. The technology encompasses being able to recognize the unique beacon identifier and to be able to match it against a third party t and the physical location of the beacon. In that way the consumer would be alerted to an incentive offer that is tied to the physical location of the beacon and the proximity of the consumer to it. This action could be the trigger for other actions as well such as in a health scenario where distanced traveled, as measured by beacons and confirmed by motion, could be used for incentives around exercise.

For 165B, a unique identifier at or after POS transaction can be used to identify a consumer via an identifier tied specifically to the consumer's unique identification.

For example, a unique identifier after a POS transaction can be entering in an email address assigned directly to the consumer. The consumer is identified by the consumer's unique identifier the email address by the platform provider running the application. The consumer unique ID email address is used by the platform provider application to send third-party promotions, coupons, incentives, offer contingent upon social media promotions, advertisement, survey, feedback, or any communication between the third party and the consumer's unique identifier the email address and the communications can be sent directly to the consumer's unique identifier the email address and also the consumer's profile in the platform profile application once signed in to the platform profile application to receive the third-party communications. The unique identifiers can be at least one unique identifier to a specific consumer.

The 165C Wearable technology is where a consumer unique identifier is tied specifically to a hardware or wearable technology device such as google glass, technology watch or any other type of wearable technology. The wearable technology is able to identify offers for the consumer unique identifier based on the technology device. 165D is the other technology or any other type of way to identify a consumer unique identifier such as an image, a biometric, a facial expression, or any other representation of a unique identifier tied back to a consumer.

FIGS. 3-30 illustrate examples of incentive interfaces (user interfaces), according to various embodiments. Interfaces can generally include static or user-interactive inputs and/or outputs. For example, outputs can include displays, graphics, text, audio, etc. Exemplary inputs can include physical or virtual buttons, dials, check-boxes, drop-down boxes, etc., microphones and/or speech recognition, cameras and/or optical character recognition, facial recognition, fingerprint recognition, code recognition (e.g., barcode, 31R codes, etc.), etc.

### Third-Party Sign-In

FIG. 3 illustrates an exemplary third-party sign-in interface 300, according to an embodiment. The third-party sign-in interface 300 can be implemented in, for example, an incentive management application running on the mobile device 105 (FIG. 1). In various embodiments, the mobile device 105 can display the third-party or a consumer sign-in interface 300, for example, when the incentive management application starts. As shown, the third-party sign-in interface 300 includes a third-party name entry field 302, a password entry field 303, and a login interface 304. As shown, the consumers can also sign-in interface 300 includes a consumer name entry field 302, a password entry field 303, and a login interface 304. Although various portions of the interface 300 are shown, a person having ordinary skill in the art will appreciate that the portions can be rearranged, portions can be omitted, and/or additional portions can be added.

### Third-Party Onboarding Account Information

FIG. 3A illustrates an exemplary third-party account information sign up profile page. The third-party account information interface 300A can be implemented in, for example, the third party application running on the mobile device (105) FIG. 1 or a smart device. In various embodiments, the mobile device 105 can display the third party home interface (XX) for example, after a third party onboard the third party account information interface. As shown, the third party interface 300A includes a third-party account information third-party name, store #, last name, street address, city state, zip, country, email, billing mobile phone, birth date, business legal name, tax, funding information, bank information. Although various portions of the interface 300A are shown, a person having ordinary skill in the art will appreciate that the portions can be rearranged, portions can be omitted, and/or additional portions can be added.

### Third-Party Home Page

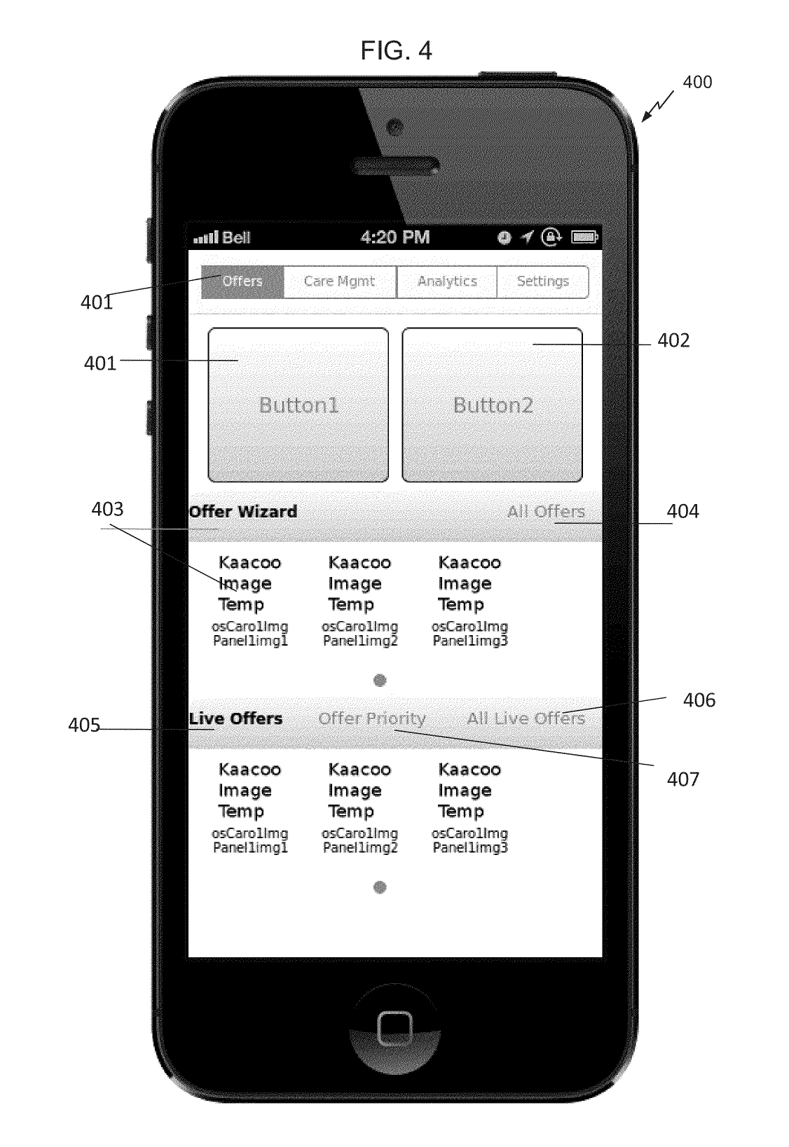

FIG. 4 illustrates an exemplary Third party home interface 400, according to an embodiment. The Third party home interface 400 can be implemented in, for example, the application running on the mobile device 105 (FIG. 1). In various embodiments, the mobile device 105 can display the Third-party home interface 400, for example, after a Third-party signs in to a Third-party account via the sign-in interface 300 (FIG. 3). As shown, the Third-party home interface 400 includes a Third-party functionality bar to display respective functionalities 401, an upload interface button to launch inventory uploading capabilities 401, Add new Third-party sub users 402, pre-determined templates 403, pre-determined templates search list 404, Live Third-party offer list current being offered through Kaacoo platform, Live offer priority ranking 407 and all live offers available list 406. Although various portions of the interface 400 are shown, a person having ordinary skill in the art will appreciate that the portions can be rearranged, portions can be omitted, and/or additional portions can be added.

### Third-Party Identity & Access Management

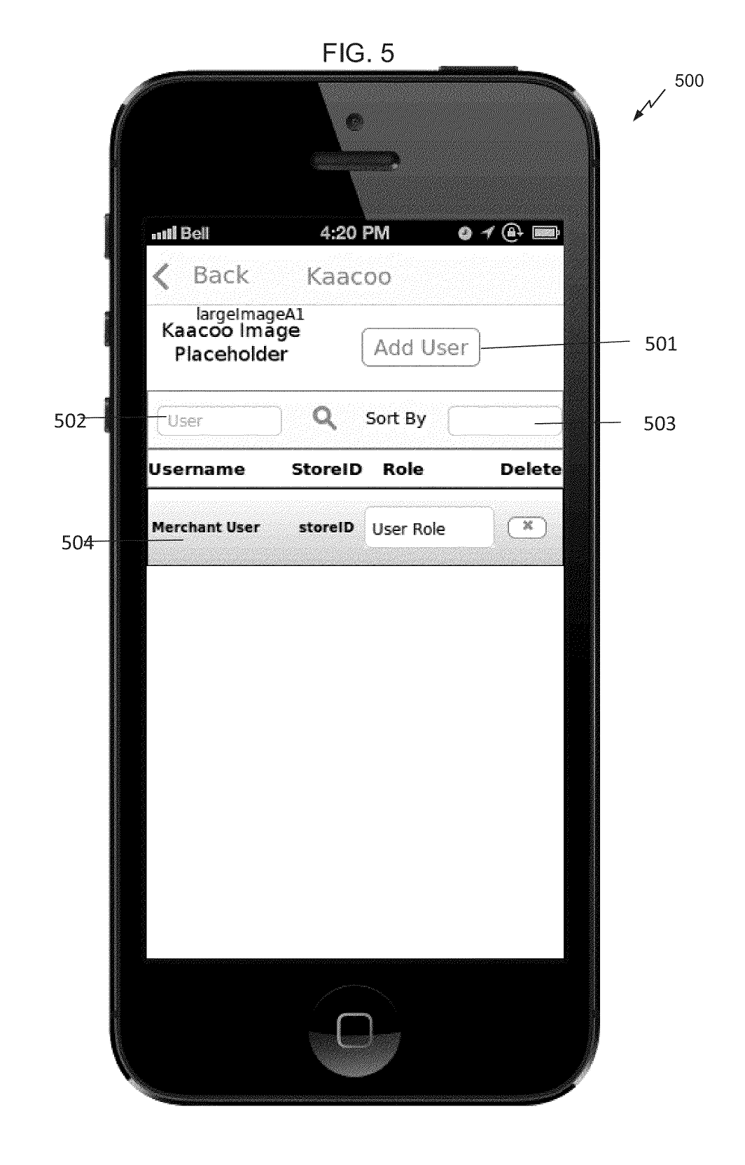

FIG. 5 illustrates an exemplary Third-party Identity & Access management home interface 500, according to an embodiment. The Identity & Access management interface 500 can be implemented in for example, the application running on the mobile device 105 or smart device. In various embodiment, the mobile device or smart device can display the Identity & Access management interface 500, for example, after a Third-party signs into their specific Third-party account via the sign in interface 300 (FIG. 3) and launches the Third-party Identity & Access management interface 500 launches Add consumer 501 button. As shown, the Third-party Identity & Access management 500 interface 400 includes a button to launch to add new Third-party sub users management interface (FIG. 5), a consumer ID search field 502, a sort by filtering drop down box 503, the Third-party sub user list by third-party sub consumer, store unique identifier, assigned role (active or not active role), delete capability and other Third-party sub consumer supporting information when the Third-party sub user list 504 is launched.

### Third-party Identity & Access Sub-User Interface

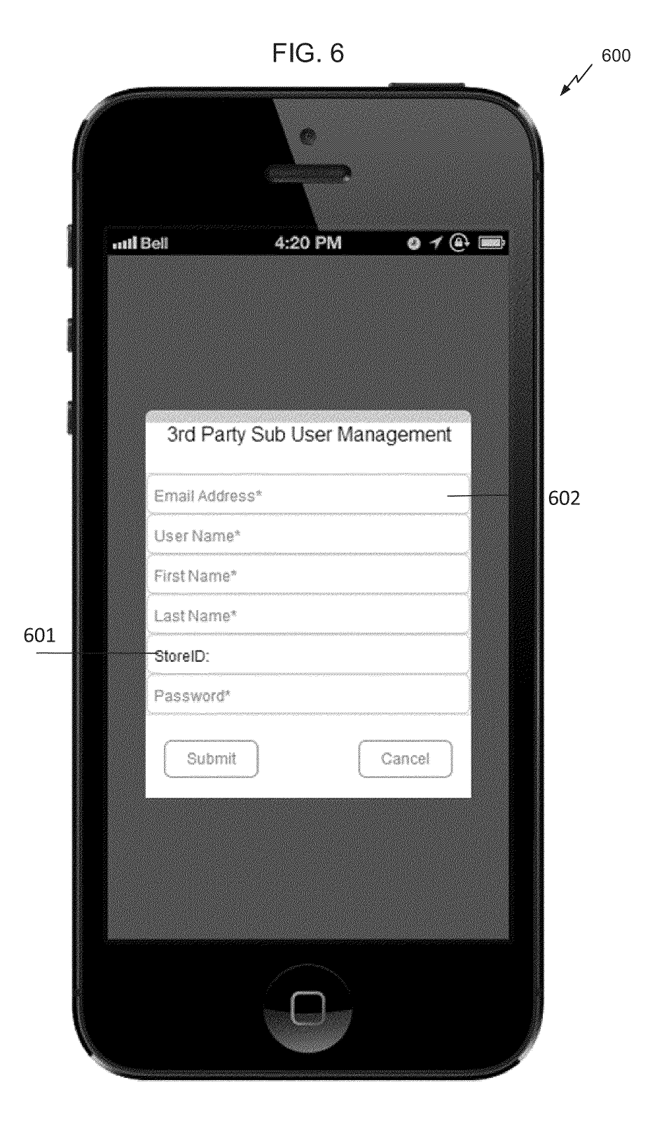

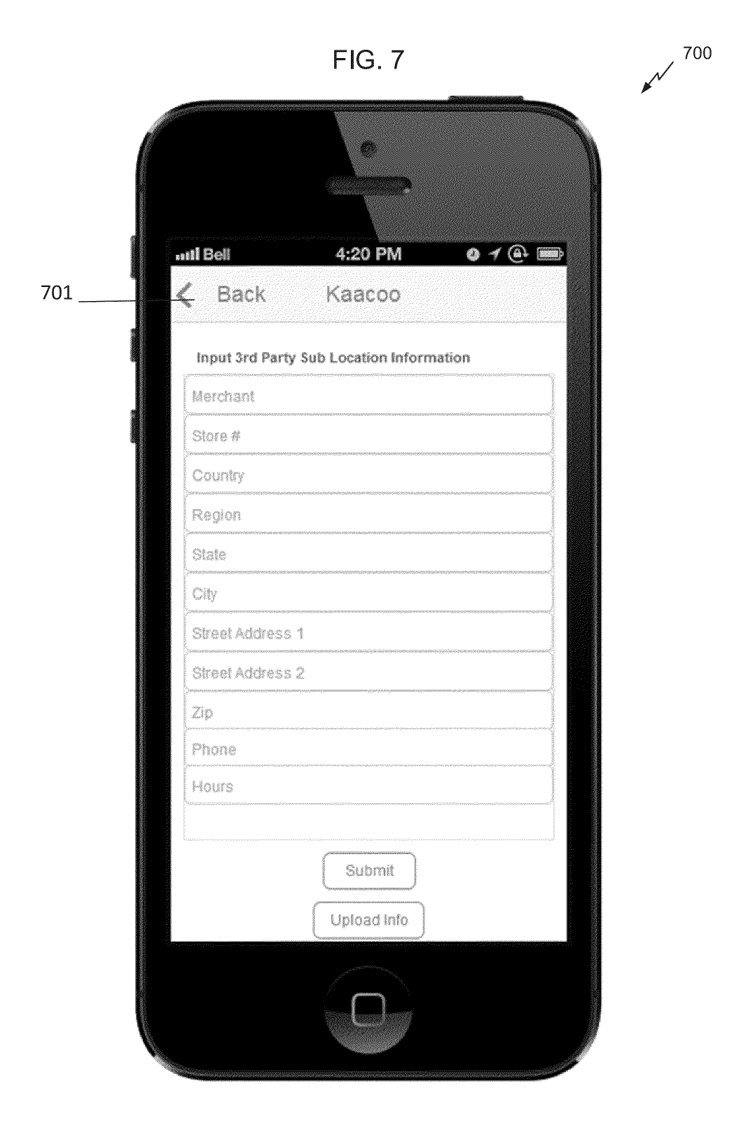

FIG. 6 illustrates an exemplary Third-party sub user management interface 600, according to the embodiment. The Third-party sub user management interface 600 can be implemented in, for example, the application running on the mobile computing device 105 (FIG. 1) or another computing device. In various embodiments, a computing device can display the Third-party sub user management interface 600 after a Third-party signs into their specific Third-party account via the sign in interface 300 (FIG. 3) and launches the add consumer button 501 (FIG. 5). The add new Third-party sub users management interface 500 allows Third-party consumers once signed in via the Third-party sign interface 300 (FIG. 3) to create new sub-user store sub-user store ID 601, sub-user unique identifier 602, additional sub-user information interface 700 (FIG. 7) for sub-user information inputs 701 (FIG. 7) that include supporting information examples of sub-user country, consumer, sub-user address, etc. and assign sub-user roles, rights and permissions 500 (FIG. 5) that are part of the overall Third-party Identity & Access management system.

### Third-Party Inventory Interface

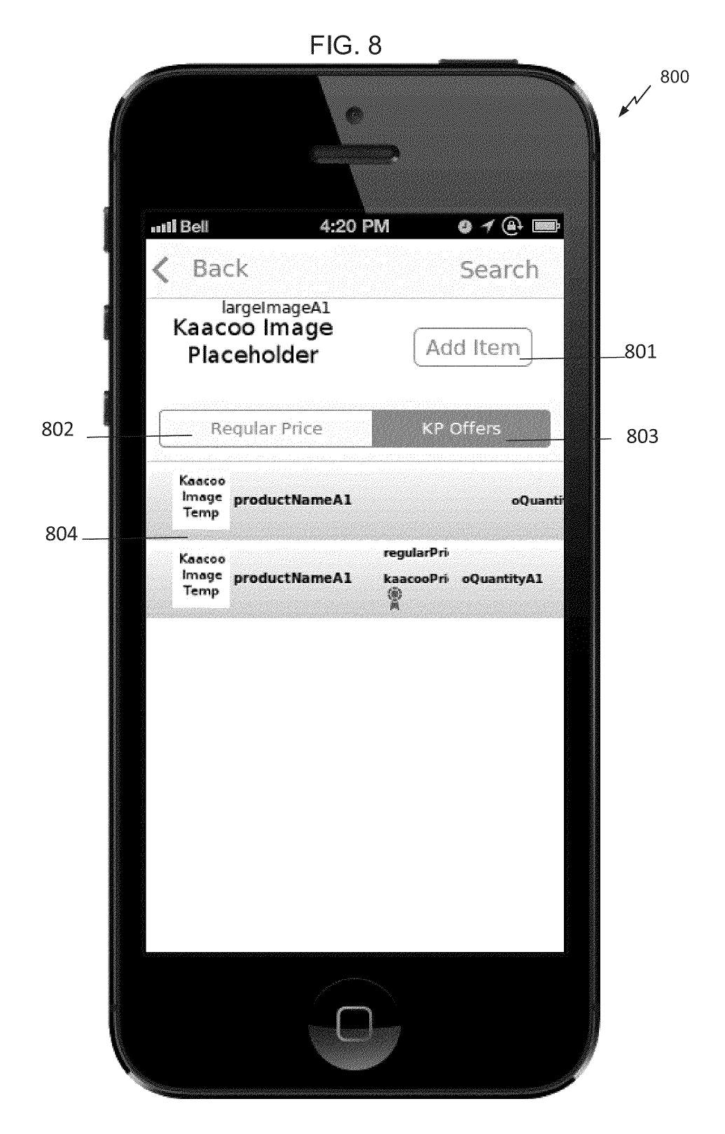

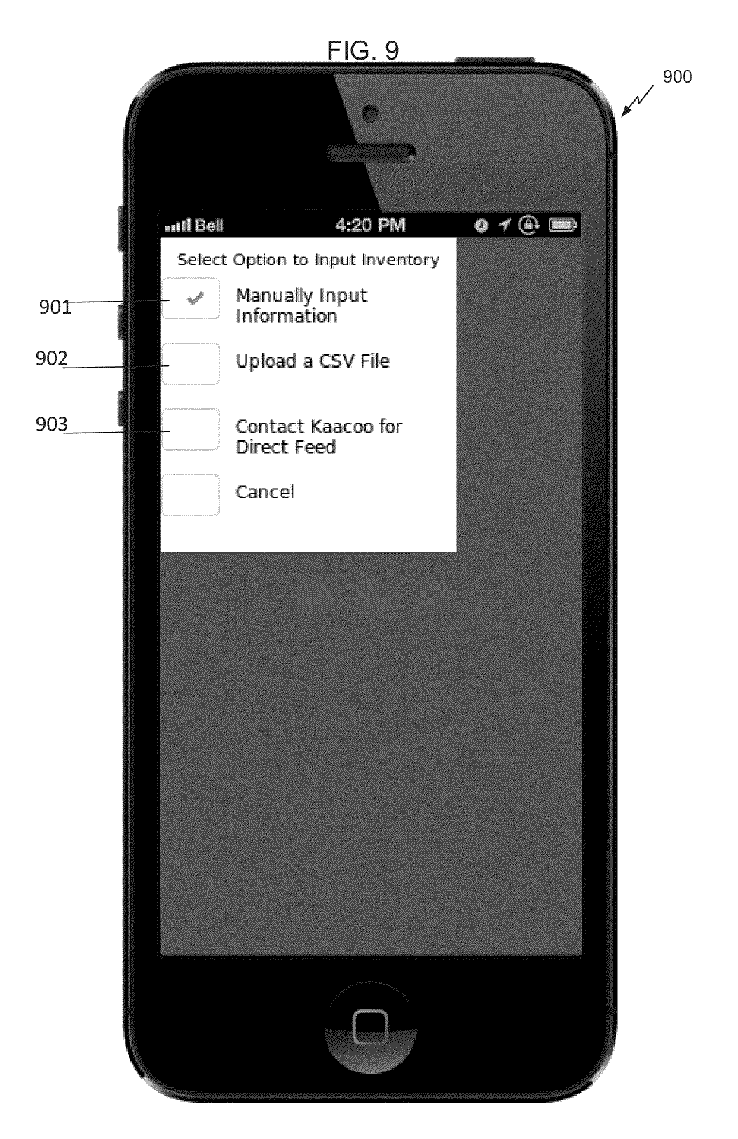

FIG. 8 illustrates an exemplary Third-party inventory interface 800, according to an embodiment. The Third-party inventory interface N00 can be implemented in, for example, the application running on the mobile device 105 (FIG. 1) or smart device (FIG. 1). In various embodiments, the mobile device 105 can display the Third-party inventory interface 800, for example, after a Third-party selects the upload inventory interface launch add item button 801 to launch displays the Upload inventory interface 900 (FIG. 9). As shown, the Third-party upload inventory interface 800 includes an Add item button 801, a regular price list of all inventory with regular price uploaded either individually or group 802, an offer list of inventory with offers attached to either individually or group inventory 803 and depending on the list tab chosen, the item image, item name, price and if offer is attached with all the other supporting detailed is uploaded as part of the inventory. Although various portions of the interface 800 are shown, a person having ordinary skill in the art will appreciate that the portions can be rearranged, portions can be omitted, and/or additional portions can be added.

FIG. 9 illustrates an exemplary Third-party inventory upload interface option 900, according to an embodiment. In various embodiments, the mobile device 105 can display the Third-party upload inventory option interface 900, for example, after a Third-party selects the upload inventory interface launch add item button 801 to launch displays the Upload inventory interface 900. As shown, the Third-party upload inventory can be uploaded in three different ways manual upload 901, CSV upload 902 and Kaacoo's API upload feed 903 and a submission button.

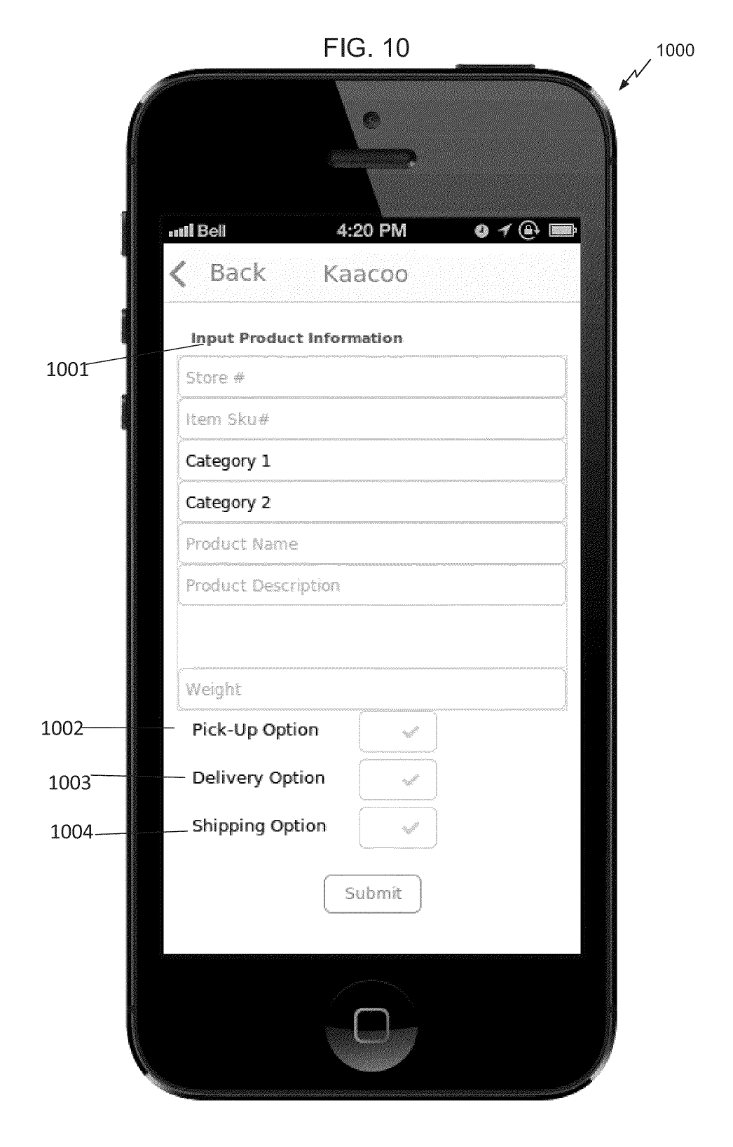

FIG. 10 illustrates an exemplary item information view interface 1000, according to an embodiment. The add in item information interface 1000 can be implemented in, for example, the application running on the mobile device 105 (FIG. 1). In various embodiments, the mobile device 105 can display the add in item view interface 1000, for example, after a third party submits FIG. 9. As shown, the add in item view interface 1000 includes an item information fields 1001, delivery options pick up 1002, delivery 1003 and shipping 1004. Although various portions of the interface 1000 are shown, a person having ordinary skill in the art will appreciate that the portions can be rearranged, portions can be omitted, and/or additional portions can be added.

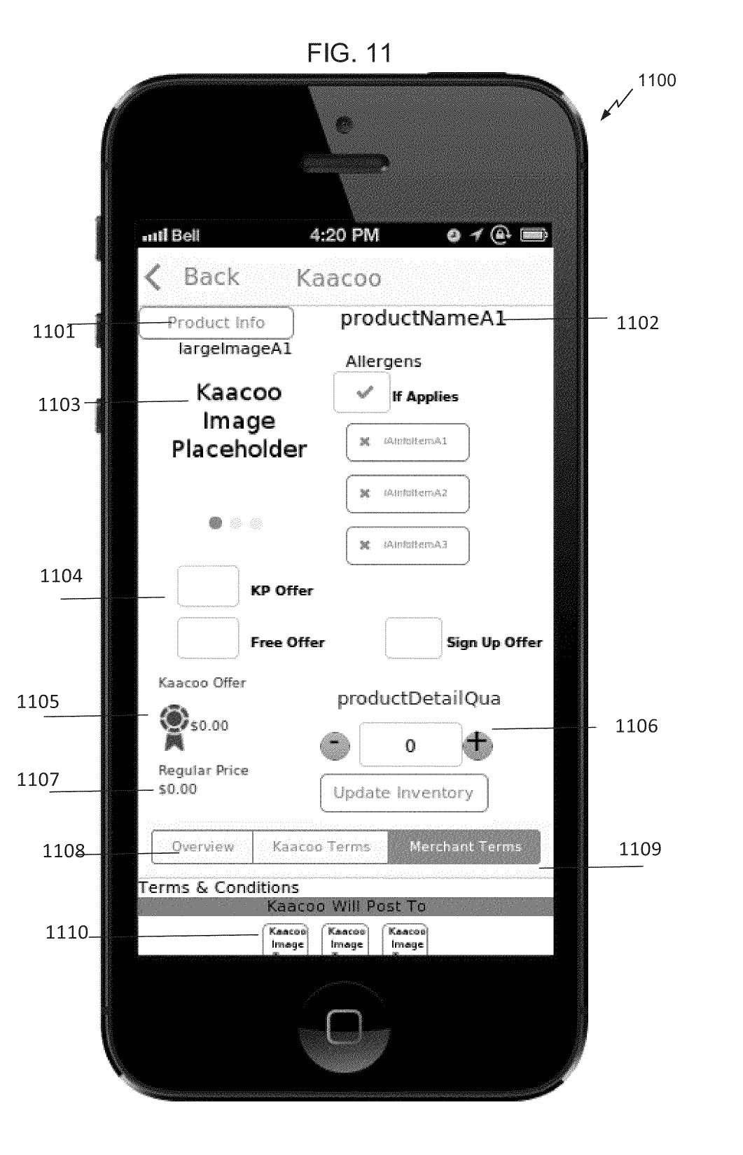

FIG. 11 illustrates an exemplary detailed item/item information view interface 1100, according to an embodiment. The detailed/item information interface 1100 can be implemented in, for example, the application running on the mobile device 105 (FIG. 1). In various embodiments, the mobile device 105 can display the detailed item/item view interface 1100, for example, after a third party consumer submits on detailed item/item view 804 (FIG. 8). As shown, the item/item view interface 1100 includes an item information button to launch to detailed item overview 1001, item/item name 1102 and image(s) 1103, if offer is applied for an incentive the options are displayed for monetary or non-monetary offers 1104, 1105 Offer price if incentive is a monetary incentive 1105, regular price 1107, add in available inventory 1106, item/item description overview 1108, Terms and conditions 1109 and social media venues 1110. Although various portions of the interface 1000 are shown, a person having ordinary skill in the art will appreciate that the portions can be rearranged, portions can be omitted, and/or additional portions can be added.

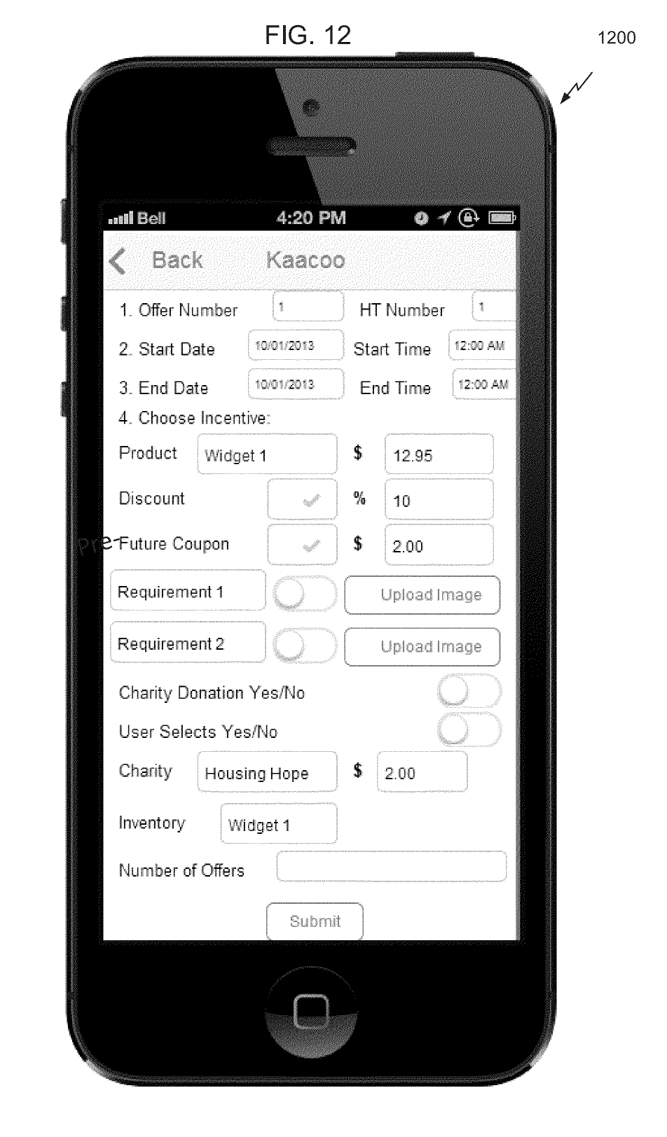

In FIG. 12 illustrates an exemplary third party offer interface 1200, according to an embodiment. The third party offer interface 1200 can be implemented in, for example, the application running on the mobile device 105 (FIG. 1). In various embodiments, the mobile device 105 can display the third party offer interface 1200, for example, after a third party chooses a pre-determined offer template and selects the inventory, applies to the offer and the offer is presented to the consumer.

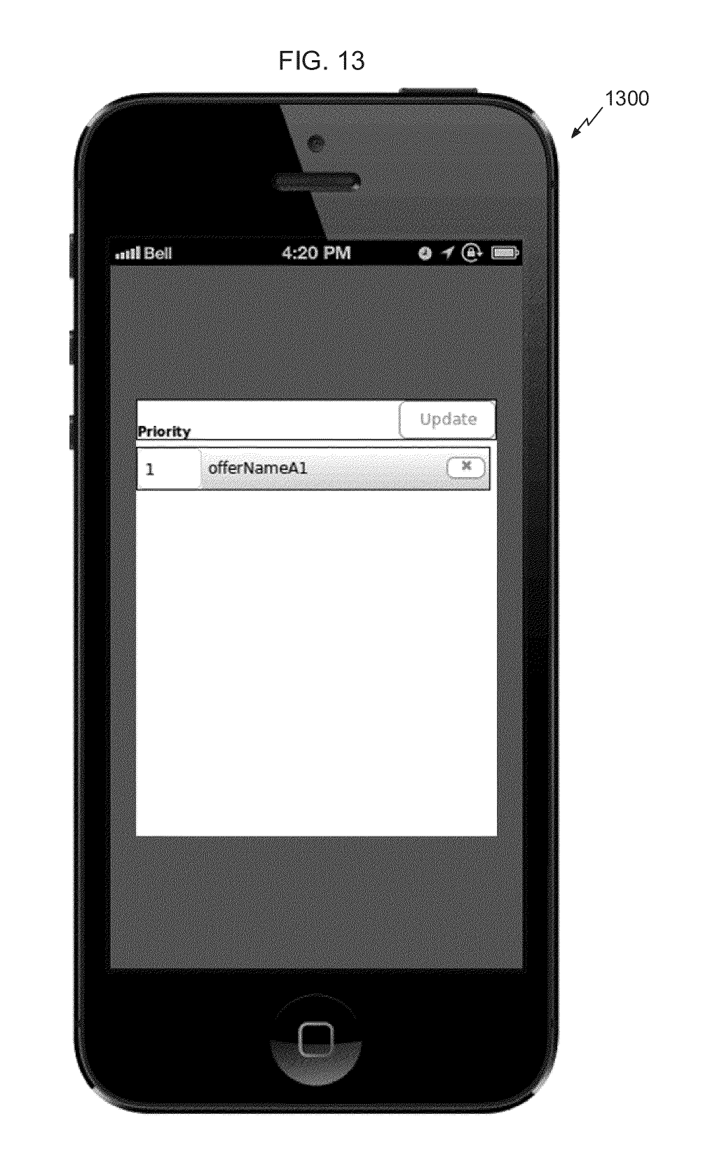

In FIG. 13 illustrates an exemplary third party offer interface 1300, according to an embodiment. The third party priority interface 1300 can be implemented in, for example, the application running on the mobile device 105 (FIG. 1). In various embodiments, the mobile device 105 can display the third party priority offer interface 1300, for example, after a third party once authorizes a live offer to be presented to consumers. The third-party can prioritize the offers that are presented to consumers by at least one combination or more of parameters. For example, parameters such as prioritize seasonal food during a certain time frame or certain day time for lunch or dinner offers.

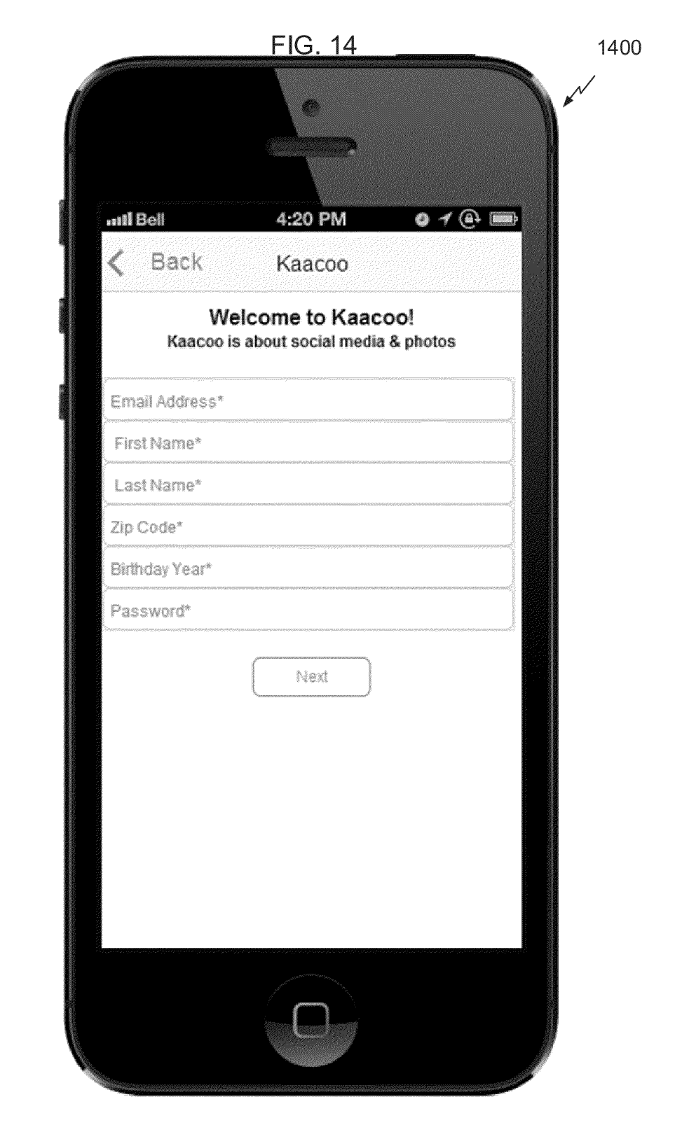

In FIG. 14 illustrates an exemplary consumer sign up interface 1400, according to an embodiment. The consumer sign up offer interface 1400 can be implemented in, for example, the application running on the mobile device 105 (FIG. 1). In various embodiments, the mobile device 105 can display the consumer sign up offer interface 1200, for example, after a third party chooses a pre-determined offer template and selects the inventory, applies to the offer and the offer is presented to the consumer.

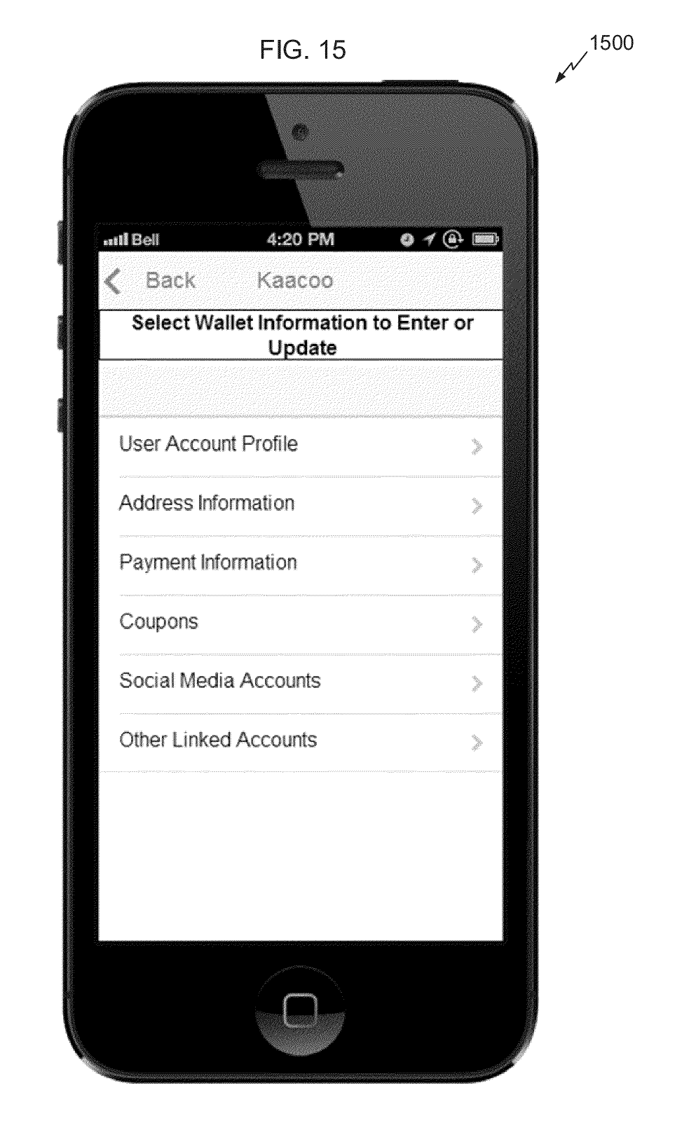

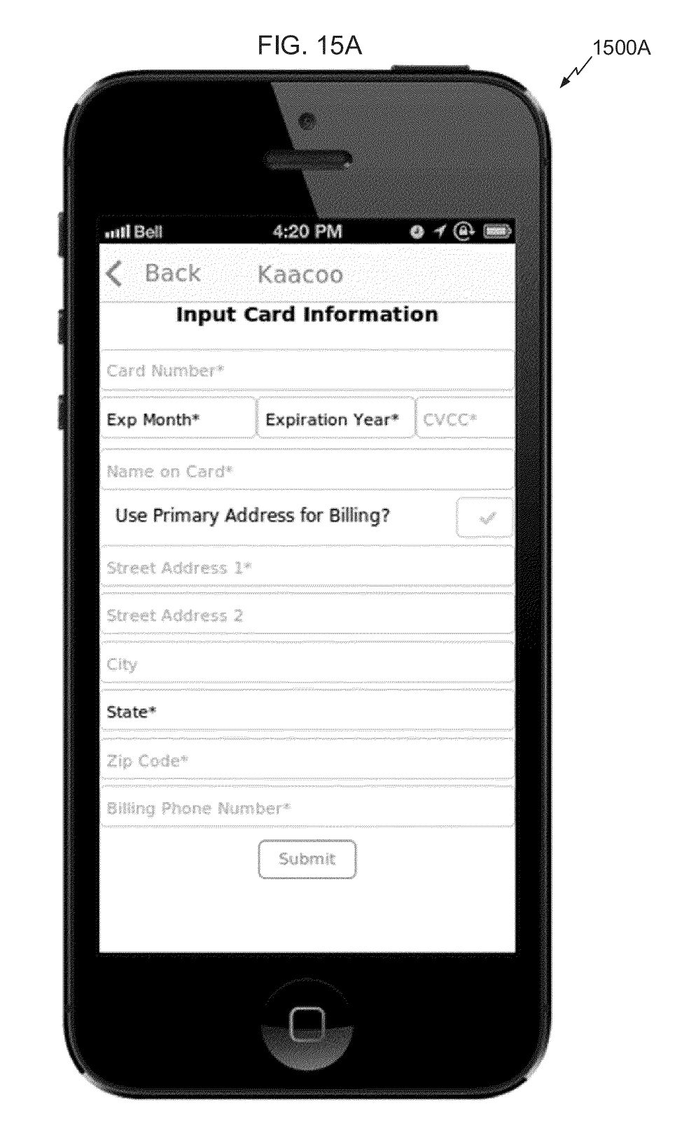

In FIG. 15 illustrates an exemplary consumer wallet interface 1500, according to an embodiment. The consumer wallet interface 1500 can be implemented in, for example, the application running on the mobile device 105 (FIG. 1). In various embodiments, the mobile device 105 can display the consumer wallet interface 1500, for example, the consumer upload the consume, address, payment information, coupons, social media accounts, food accounts, fitness account and other consumer linked accounts.

In FIG. 15A illustrates an exemplary consumer wallet interface 1500A, according to an embodiment. The consumer wallet interface 1500A can be implemented in, for example, the application running on the mobile device 105 (FIG. 1). In various embodiments, the mobile device 105 can display the consumer wallet interface 1500A, for example, the consumer wallet can upload their credit cards, bank accounts, technology, debit or any form of technology.

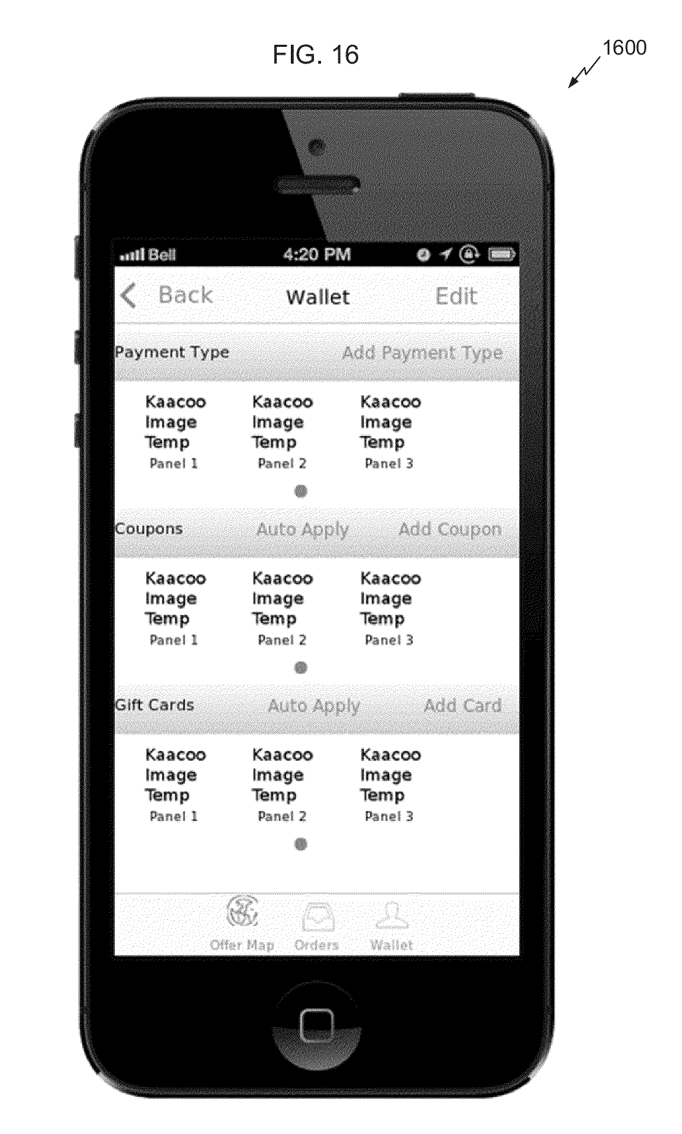

In FIG. 16 illustrates an exemplary consumer wallet interface 1600, according to an embodiment. The consumer wallet interface 1600 can be implemented in, for example, the application running on the mobile device 105 (FIG. 1). In various embodiments, the mobile device 105 can display the consumer wallet interface 1600, for example, the consumer wallet can upload their credit cards, bank accounts, technology, debit or any form of technology.

### Home Page

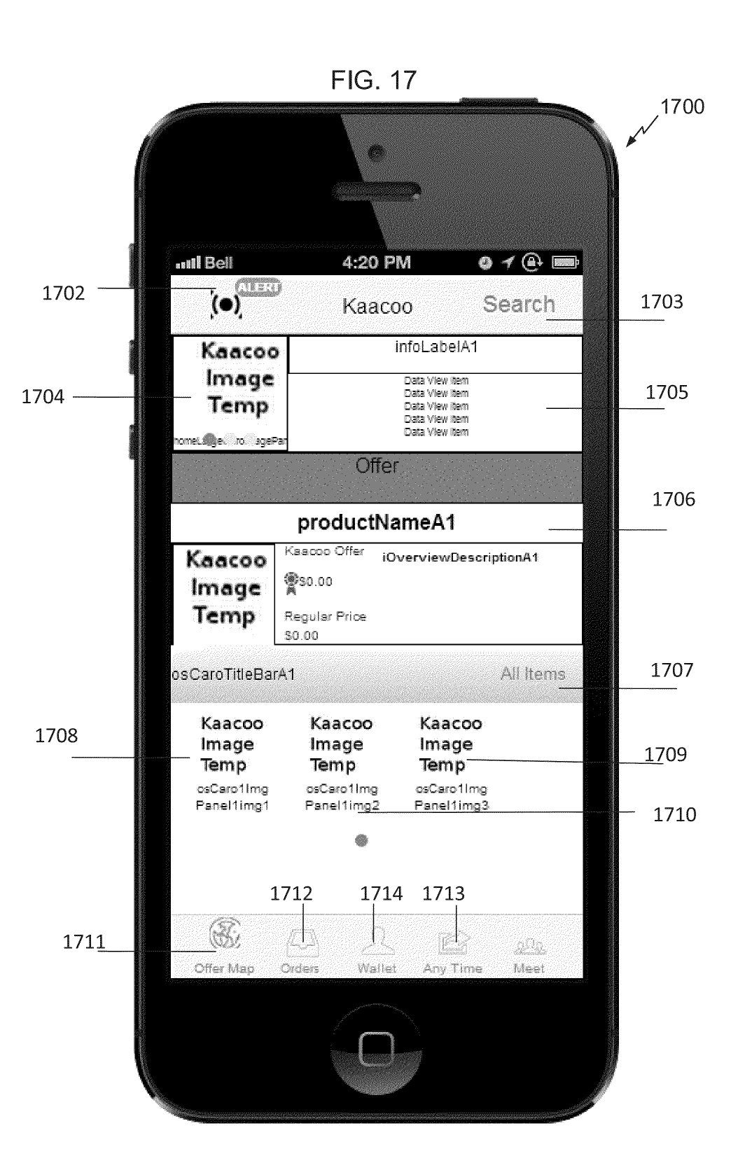

FIG. 17 illustrates an exemplary home interface 1700, according to an embodiment. The home interface 1700 can be implemented in, for example, the application running on the mobile device 105 (FIG. 1). In various embodiments, the mobile device 105 can display the home interface 1700, for example, after a consumer signs in to a consumer account via the sign-in interface 300 (FIG. 3). As shown, the home interface 1700 includes a tool bar 1701, Alert interface 1702, one or more category search interfaces 1703, mobile ordering interface 1704, social media venue interface 1705, offer search interface 1706, instant buy offer search 1707, advertisement 1708, any time feedback interface 1709, wallet interface 1710, offer map interface 1711 and order interface 1712. Although various portions of the interface A00 are shown, a person having ordinary skill in the art will appreciate that the portions can be rearranged, portions can be omitted, and/or additional portions can be added.

The tool bar 1701 serves to provide access to one or more functions of the incentive application. In various embodiments, the tool bar 1701 can be a standard tool bar repeated in one or more other interfaces of the incentive application. In some embodiments, the tool bar 1701 can be included in every interface, or substantially every interface. As shown in FIG. 17, the tool bar 1701 includes a home interface 1700, an alert interface 1702 and one or more category search interfaces 1703. The home interface 1700 can serve to navigate to the home interface 1700. For example, when the consumer selects the home interface 1700, the mobile device 105 (FIG. 1) can display the home interface 1700. In various embodiments, the home interface A10 can be added or removed from the tool bar A05 contextually. For example, the home interface 1700 can be omitted when the home interface A00 is active. Although various portions of the interface 1701 are shown, a person having ordinary skill in the art will appreciate that the portions can be rearranged, portions can be omitted, and/or additional portions can be added. Moreover, different portions of the interface 1701 can be added or removed contextually.

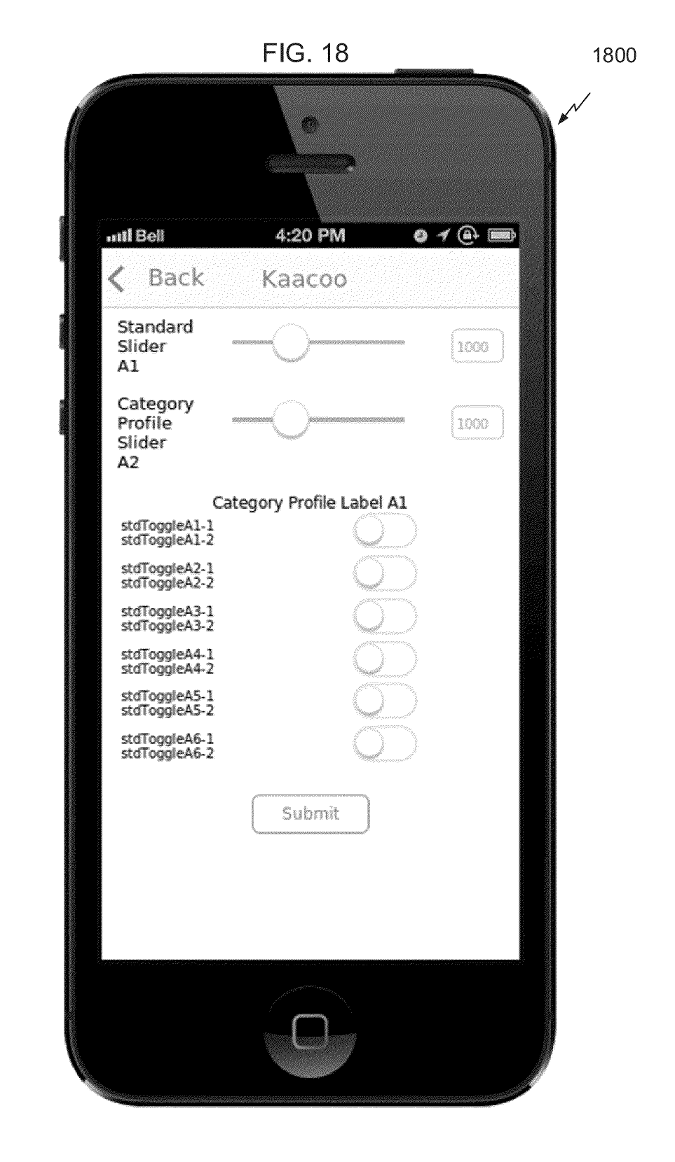

The search interface 1703 can serve to navigate to a search interface 1800 (FIG. 18). For example, when the consumer selects the search interface 1703, the mobile device 105 (FIG. 1) can display the search interface 1800 (FIG. 18). In various embodiments, the search interface can be added or removed from the tool bar 1701 contextually. For example, the search interface 1703 can be omitted when the search interface 1800 is active. In some embodiments, the category search interface 1703 can serve to navigate to a search interface 1800 having one or more pre-selected settings such as, for example, a filter by food items, a filter by health items, third-party, a filter by fitness items, etc. Although various portions of the interface 1800 are shown, a person having ordinary skill in the art will appreciate that the portions can be rearranged, portions can be omitted, and/or additional portions can be added. Moreover, different portions of the interface 1800 can be added or removed contextually.

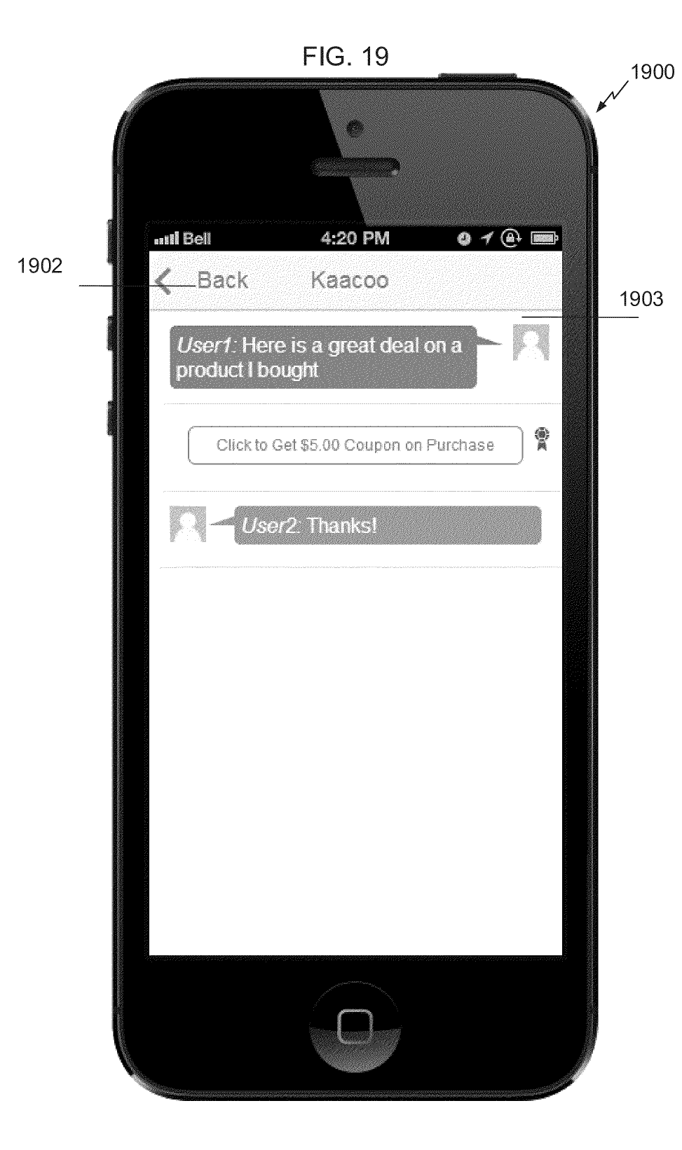

The social media venue interface 1705 can serve to navigate to a social media venue interface 100 (FIG. 19). For example, when the consumer selects the social media social media venue 1705 the mobile device 105 (FIG. 1) can display the social media venue interface 1900. In some embodiments, the social media venue interface 1900 can serve to provide an offer contingent with social media promotion requirements on at least one social media venue 1900 (FIG. 19) sent by a consumer to the consumer's contact list after the consumer has transacted the offer and completed a valid transaction. The offer displayed is contingent with social media promotion requirements (for example such as an social media promotion requirements for a specific item, an offer for a consumer photo input, an offer for a feedback, survey, third-party feedback or any other type of feedback, an offer for a specific focus group targeted for a selected consumer group segmentation, health updates, chronic care management patients, etc.) a consumer selects an offer contingent upon social media promotion requirements, the consumer authorizes by submitting the social media promotion requirements inputs, once a platform provider (for example, Kaacoo) validates the consumer social media promotion requirements inputs are met, the incentive is issued to the consumer and the platform provider (Kaacoo) posts the social media updates to at least the consumers home page social media venue and other social media venues. A “platform provider” as referred to herein may be used, for example, to generally refer to a system owned and/or operated by an entity that facilitates the transaction of providing an offer to a consumer. The offer may be for an item (e.g., a good, service, event, product, discount on good or service, that is monetary or non-monetary). Providing the item to the consumer is contingent on the consumer meeting certain requirements, which may also referred to herein as “transaction requirements or social media promotion requirements” that is contingent with the offer. The platform provider system can include hardware including computer server systems, storage systems, communication systems and can communicate with one or more client computer systems including wireless portable devices having displays, including for example, laptops, tablet computers, and cell phones and smartphones that are used by consumers. The platform provider system may include a transaction component residing on the client computer systems (for example the portable computing devices), the transaction component configured to communicate with a server computer system to provide the offer from the (platform provider) server computer system to a consumer, in other words, to receive the offer and display the offer to a consumer on a display of a computing device (e.g., a client wireless computing device, a smart phone). The transaction component can also be configured to receive input provided by a consumer to the computing device and provide the input to the (platform provider) computer server system for further processing. Subsequently, the transaction component may receive information indicating the incentive is available, and display such information on a display for the consumer to view.

After the Kaacoo post social media updates, for the consumer's contact lists, every consumer contact once signed into the incentive application consumer home page, the consumer's contact lists each respective consumer contact social media venue will display the incentive received from the consumer. The transacted offer sent to the consumer contact lists can include in the original offer (transacted offer) contingent with social media promotion requirements and an additional incentive attached to the original offer, if the consumer contact list selects the offer referred from the original consumer.

The offer presented via social media venue can be an instant Kaacoo monetary offer for the specific offer presented or the offer presented can prompt the consumer to continue to mobile order from the third-party offer inventory for additional offers and regular price items. Although various portions of the interface 1900 are shown, a person having ordinary skill in the art will appreciate that the portions can be rearranged, portions can be omitted, and/or additional portions can be added. Moreover, different portions of the interface 1900 can be added or removed contextually.

### Advertising & Searches

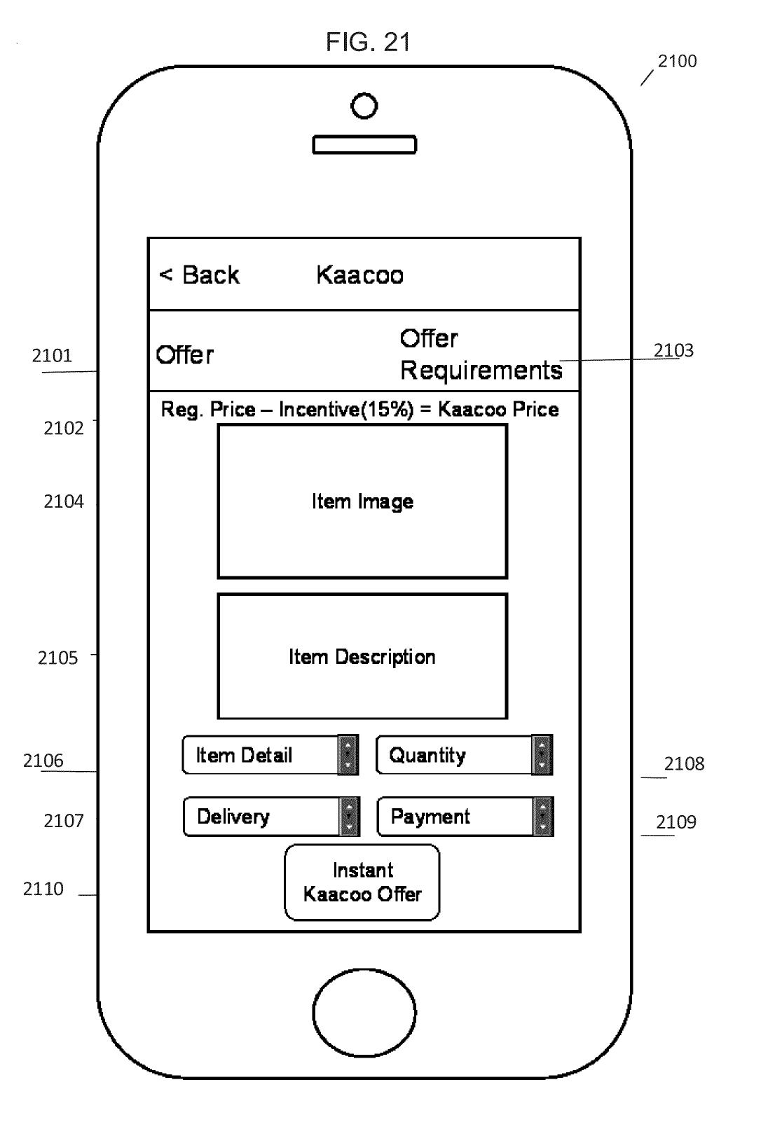

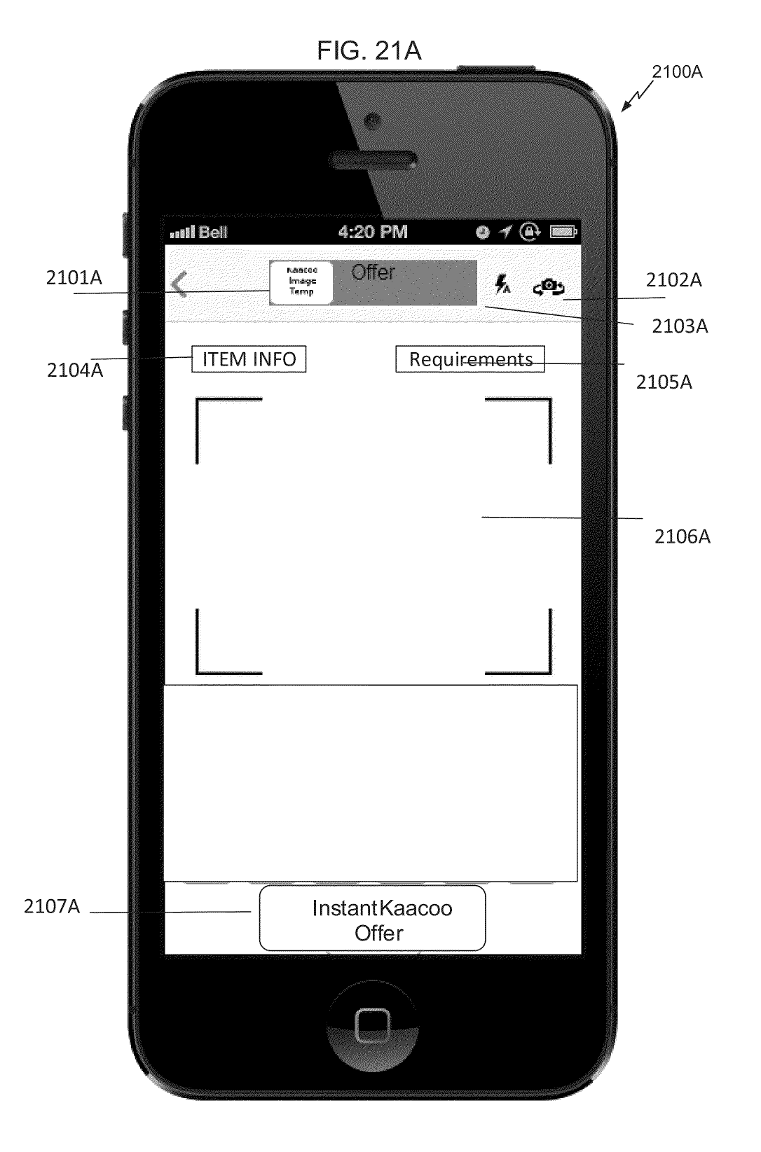

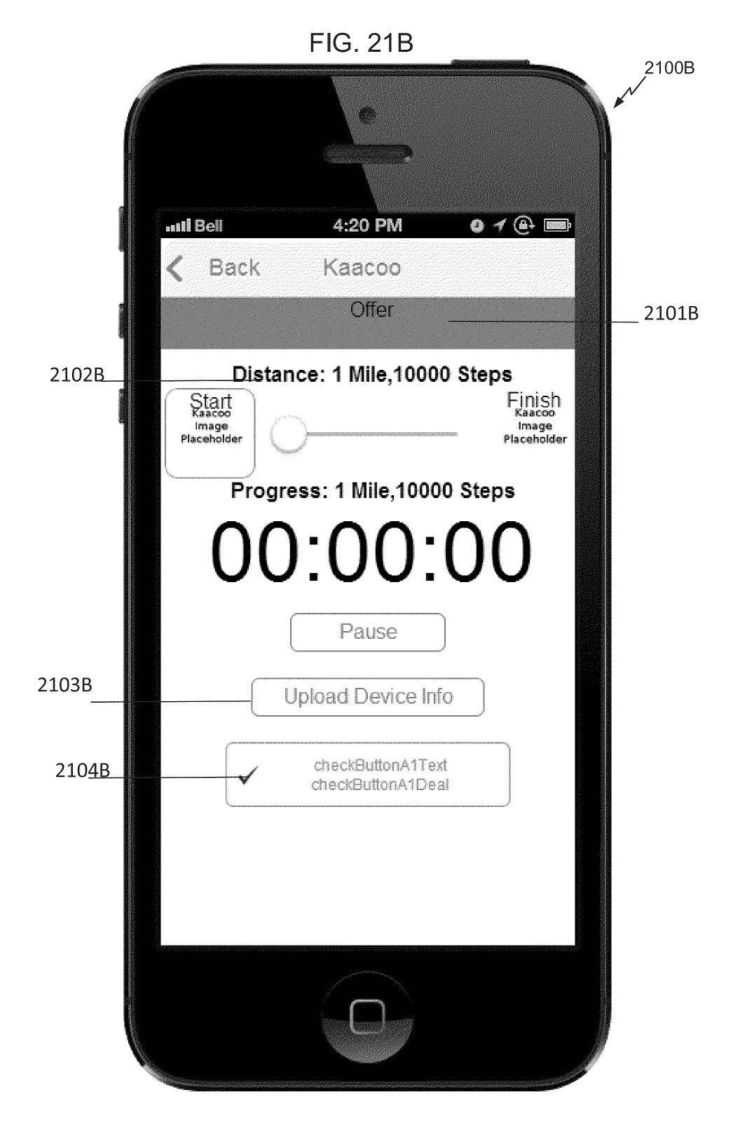

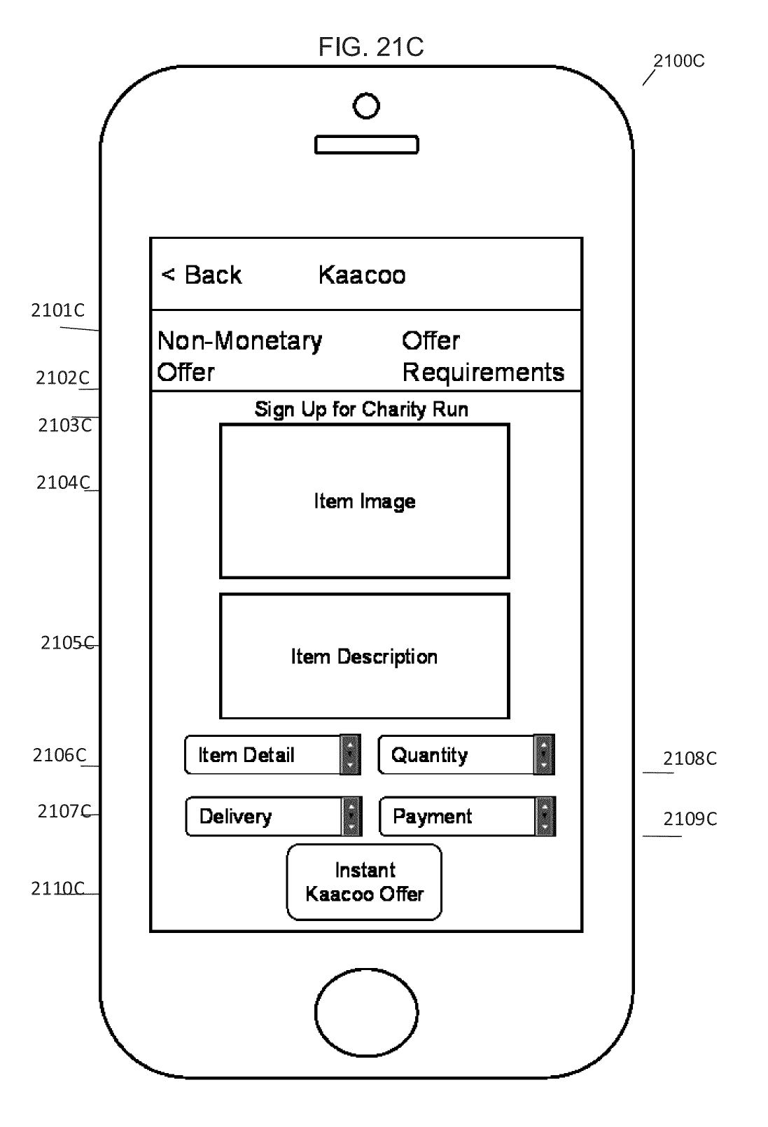

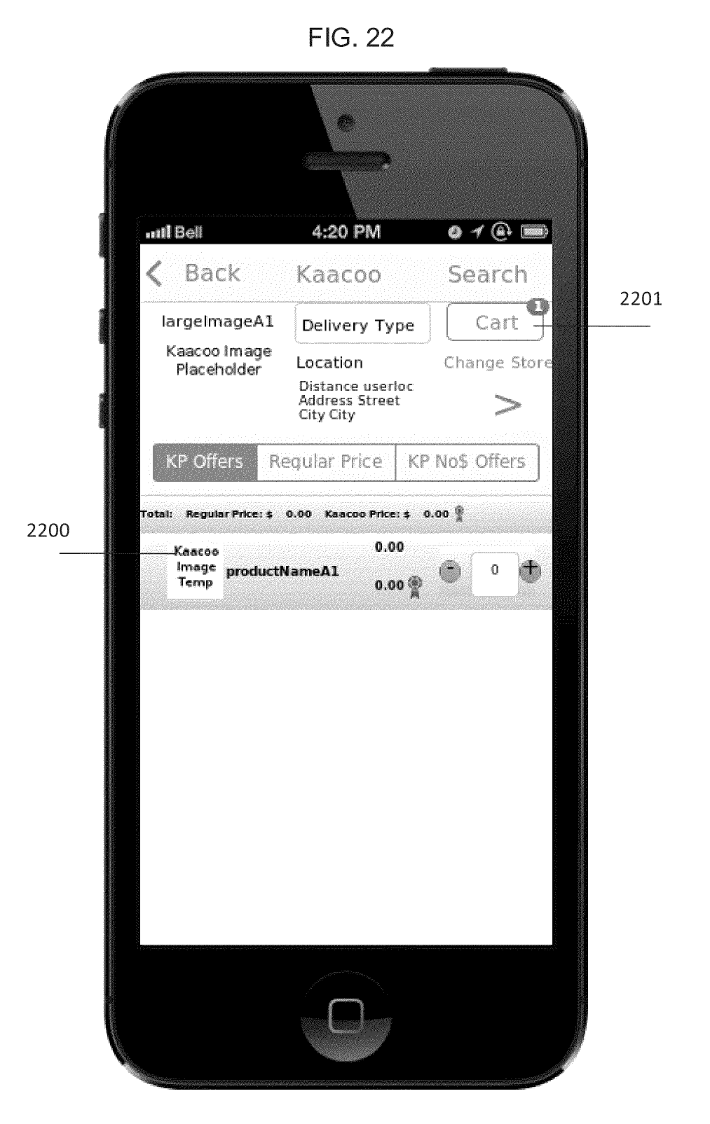

The one or more third-party search interfaces 1704, 1708, 1709 and 1710 can serve to navigate to the mobile ordering search interface 2200 (FIG. 22) or an instant Kaacoo offer 1704, 1707, 1708, 1709 and 1710. For example, when the consumer selects the third-party search interface 1704, 1707, 1708, 1709 and 1710, the mobile device 105 (FIG. 1) can display either the mobile ordering search interface 2200 (FIG. 22), or instant offers types 2110C (FIG. 21C), for example, instant offer type alert, photo offer, health update offer, anytime offer. For an instant offer, a consumer has to buy within a certain short period of time (for example, less than 30 seconds, 1 minute, 5 minutes, 10 minutes, 30 minutes, 1 hour, and it may or may not be conveyed to the consumer how long this offer will exist before it expires. The “instant” offers also have transaction requirements that include the consumer (user) authorizing a social media update to occur, on the consumer's behalf, on a social media venue that the consumer is registered to use, that is, has an account with. In various implementations, the transaction requirements may include different types of social media updates.

Mobile ordering search is either can choose to post to social media input requirements to receive incentive or option to refrain for full price.

In some embodiments, the third-party search interfaces 1704 can serve to navigate to a mobile ordering search interface 2200 (FIG. 22). For example, the third-party search interface 1704 can include a first third-party logo or a third-party offer. Accordingly, when a consumer selects the third-party search interface 1704, the mobile device 105 can display the mobile order search interface 2200 (FIG. 22) including only items offered by the specific third-party.

In other embodiments, one or more of the third-party search interfaces 1704, 1707, 1708, 1709 and 1710 (for example, third-party to mobile ordering search interfaces) can serve to navigate to an instant Kaacoo offer 1704, 1708, 1709 and 1710. For example, the instant Kaacoo offer interface 1704, 1707, 1708, 1709, and 1710 can include an advertisement for a particular item or service associated with a specific third-party offer. Accordingly, when a consumer selects the third-party search interface 1704, 1707, 1709, 1710, the mobile device 105 can display the instant Kaacoo offer 1704, 1708, 1709 and 1710 (FIG. 17) including only the particular inventory item, item, good or service, contingent with the particular instant Kaacoo offer 1704, 1708, 1709 and 1710 (FIG. 17).

### Offer Transaction Types: Instant Kaacoo Offer or Mobile Ordering Search

The offer interface can be implemented in, for example, many different types of embodiments. In various embodiments, the mobile device 105 can display the offer interface depending on the third-party offer selected for display to the consumer. The offer interface can be implemented in, for example, the incentive application running on the mobile device 105 (FIG. 1). In some embodiments, the mobile device 105 may display the offer interface for a specific third-party, for example, after a consumer selects an offer in the consumer home interface 1704, 1708, 1709 and 1710 (FIG. 17)

FIG. 21 illustrates an exemplary Instant Kaacoo offer interface 2100, according to an embodiment. The instant Kaacoo offer interface 2100 can be implemented in, for example, the incentive application running on the mobile device 105 (FIG. 1). In various embodiments, the mobile device 105 can display the instant Kaacoo offer interface 2100, for example, after a consumer selects an offer in the instant Kaacoo offer list interface 1704, 1708, 1709 and 1710 (FIG. 17). As shown, the instant Kaacoo offer interface 1704, 1708, 1709 and 1710 (FIG. 17) embodiments can include an offer for: (1) an instant Kaacoo item offer interface (2100) includes an item photo D05, a price 2102, an offer 2101. (2) instant Photo offer includes an order option interface 2200, a transaction interface D25, and an item detail interface D30. Other offer transaction types are offered in the Kaacoo offer list interface 1704, 1708, 1709 and 1710 (FIG. 17) such as instant Kaacoo monetary offer, instant Kaacoo non-monetary offer, photo offer, health update offer, anytime feedback offer, alert offer, focus offer, feedback post purchase offer and other offer combinations. Although various portions of the interface 2100 are shown, a person having ordinary skill in the art will appreciate that the portions can be rearranged, portions can be omitted, and/or additional portions can be added.

### Instant Kaacoo Monetary Offer

FIG. 21 illustrates an exemplary Instant Kaacoo offer interface 2100, according to an embodiment. The instant Kaacoo monetary offer interface 2100 can be implemented in, for example, the incentive application running on the mobile device 105 (FIG. 1). In various embodiments, the mobile device 105 can display the instant Kaacoo monetary offer interface 2100, for example, after a consumer selects an offer in the instant Kaacoo offer list interface 2100 (FIG. 2100). As shown, the instant Kaacoo offer monetary offer interface 2100 various embodiments can includes an offer, social media promotion social media promotion requirements, item photo, item description, quantity, delivery, payment, and other supporting offer information. The Instant Kaacoo offer interface 2100 can be tied specifically to a third-party, third-party inventory (product, good, service, free item, event, sign up for an activity, entry to a certain location, etc.) and after the validation of social media promotion requirements are authorized, a monetary (financial) transaction through a payment processing is executed or a nonmonetary (no financial) transaction is processed.

In an embodiment, the mobile device 105 can display the instant Kaacoo monetary offer interface 2100, once the consumer selects an offer in the instant Kaacoo offer list interface 2100 (FIG. 2100), then the consumer authorizes 2110 (FIG. 21) and provides consumer social media promotion requirements inputs contingent upon the offer 2101 through the mobile device 105, the Offer Validation Server (KTM) 150 validates the consumer social media promotion requirements inputs and additional supporting information, if validation is met 100% against from the consumer inputs against the offer social media promotion requirements, the Offer Validation Server (KTM) 150 authorizes and performs at least one social media updates to at least social media venue (Social media server 125), once social media updates are completed, the social media venue server 125 confirms the updates are completed to the Offer Validation Server 150, Offer Validation Server (KTM) 150 executes a mobile payment processing request to the payment processing server 130, once payment processing server 130 is authorized to the Offer Validation server 150, Offer Validation server 150 a confirmation is issued and displayed to the mobile device 105. Although various portions of the interface 2100 are shown, a person having ordinary skill in the art will appreciate that the portions can be rearranged, portions can be omitted, and/or additional portions can be added.

The item photo 2104 serves to identify an item (product, good, or service) for which an offer contingent upon a consumer meeting social media promotion requirements to receive an offer. In the illustrated embodiment, the item photo 2104 can include a static image. In various embodiments, the item photo 2104 can include other identifying information such as, for example, a moving image, text, etc.

The price 2102 serves to identify a Kaacoo price associated with the offer. In various embodiments, the price 2102 can identify a regular price such as, for example, a manufacturer's retail suggested price (MSRP) and/or a discounted price associated with the offer. For example, where the offer 2100 includes a “$1.00 off” incentive, the price 2102 can reflect a regular price of “$5.00,” and an offer price of “$4.00.” In various embodiments, the offer price is offered as on the condition that the consumer posts (or authorizes to be posted) a social media promotion updates to one or more social media venues.

The offer 2101 serves to convey an offer conditioned on a consumer's agreement to post (or to authorize for posting) a social media promotion requirements and updates to one or more social media venues. For example, the offer 2101 can convey an offer to sell an item for $1.00 off, in exchange for a social media promotion update.

In an embodiment, the offer 2101 can be conditioned on the subsequent initiation of, or authorization to initiate, a social media promotion update. In an embodiment, the offer 2101 can be conditioned on the prior initiation of, or authorization to initiate, a social media promotion update. In an embodiment, the offer 2101 can be conditioned on the substantially concurrent initiation of, or authorization to initiate, a social media promotion update. In various embodiments, the consumer cannot transaction the item associated with the offer 2101 without agreeing to the offer 2101 and meeting the social media promotion requirements.

In an embodiment, the offer 2101 can be conditioned on the subsequent in-person and/or electronic transaction of the associated item. In an embodiment, the offer 2101 can be conditioned on the prior in-person and/or electronic transaction of the associated item. In an embodiment, the offer 2101 can be conditioned on the substantially concurrent in-person and/or electronic transaction of the associated item. In some embodiments, the offer 2101 may not be contingent on a social media promotion. For example, in some embodiments, for example, the offer 2101 can include an incentive (for example a discount at transaction) contingent only upon offer transaction. Photo offer

FIG. 21 illustrates an exemplary Instant Kaacoo offer interface 2100, according to an embodiment. The instant Kaacoo monetary offer interface 2100 can be implemented in, for example, the incentive application running on the mobile device 105 (FIG. 1). In various embodiments, the mobile device 105 can display the instant Kaacoo monetary offer interface 2100, for example, after a consumer selects an offer in the instant Kaacoo offer list interface 1704, 1708, 1709 and 1710 (FIG. 17). As shown, the instant Kaacoo offer monetary offer interface 2100 various embodiments can includes an image 2104 (third party logo, or item image, image relating to the offer, etc.) offer 2101, social media promotion requirements 2103, item info 2104A, live camera functionality 2106A and other supporting offer information. The Instant Kaacoo offer interface 2100A can be tied specifically to a third-party, third-party inventory (product, good, service, free item, event, sign up for an activity, entry to a certain location, etc.) for the offer contingent upon the social media promotion requirements to receive the incentive. The consumer selects the instant offer through the mobile device 105 display, after the consumer authorizes 2107A and submits the validation of the social media promotion requirement inputs are submitted (for example, an image 2106A, at least one image is submitted as part of the social media promotion requirements), validation against the offer social media promotions requirements 2105A are evaluated, the validation executes object recognition detection and recognition against the image and other additional social media promotion requirements submitted and if validation is authorized, a monetary (financial) transaction through a payment processing is executed and a confirmation is received. If the offer is non-monetary transaction, then no financial transaction or mobile payment processing is executed and a confirmation is automatically sent to the consumer and third party.

### Monetary Photo Offer

In an embodiment, the mobile device 105 can display the instant Kaacoo monetary photo offer interface 2100A, once the consumer selects an offer in the instant Kaacoo offer list interface 1704, 1708, 1709 and 1710 (FIG. 17). 2100A (FIG. 2100A), then the consumer authorizes 2110A (FIG. 21A) and provides consumer social media promotion requirements inputs contingent upon the offer 2101A through the mobile device 105, the Offer Validation Server (KTM) 150 validates the consumer social media promotion requirements inputs and additional supporting information, the Offer Validation Server (KTM) 150 Validates at least one image via object recognition and detection 155, if validation is met 100% against from the consumer inputs against the offer social media promotion requirements at least one image validated the Object recognition and detection server 155 authorizes to the Offer Validation Server (KTM) 150 validation is met, the Offer Validation server (KTM) 150 then authorizes Social media server 125 to execute at least one social media updates to at least social media venue (Social media server 125), once social media updates are completed, the social media venue server 125 authorizes the updates are completed to the Offer Validation Server 150, Offer Validation Server (KTM) 150 executes a mobile payment processing request to the payment processing server 130, once payment processing server 130 is authorized to the Offer Validation server 150, Offer Validation server 150 a confirmation is issued and displayed to the mobile device 105. Although various portions of the interface 2100A are shown, a person having ordinary skill in the art will appreciate that the portions can be rearranged, portions can be omitted, and/or additional portions can be added.

### Non-Monetary Photo Offer

In another embodiment, a mobile device 105 can display the instant Kaacoo monetary offer interface 2100A, once the consumer selects an offer in the instant Kaacoo offer list interface 2100A (FIG. 21A), then the consumer authorizes 2110A (FIG. 21A) and provides consumer social media promotion requirements inputs contingent upon the offer 2101 through the mobile device 105, the Offer Validation Server (KTM) 150 validates the consumer social media promotion requirements inputs and additional supporting information, the Offer Validation Server (KTM) 150 Validates at least one image via object recognition and detection server 155, if validation is met 100% against from the consumer inputs against the offer social media promotion requirements at least one image validated the Object recognition and detection server 155 authorizes to the Offer Validation Server (KTM) 150 validation is met, the Offer Validation server (KTM) 150 then authorizes Social media server 125 to execute at least one social media updates to at least social media venue (Social media server 125), once social media updates are completed, the social media venue server 125 authorizes the updates are completed to the Offer Validation Server 150, Offer Validation Server (KTM) 150 executes a confirmation and displayed to the mobile device 105. Although various portions of the interface 2100A are shown, a person having ordinary skill in the art will appreciate that the portions can be rearranged, portions can be omitted, and/or additional portions can be added.

### Instant Kaacoo Offer Health Update

FIG. 21B illustrates an exemplary Instant Kaacoo offer health update offer interface 2100B, according to an embodiment. The instant Kaacoo offer health monetary offer interface 2100B can be implemented in, for example, the incentive application running on the mobile device 105 (FIG. 1). In various embodiments, the mobile device 105 can display the instant Kaacoo offer health update monetary offer interface 2100B, for example, after a consumer selects an offer in the instant Kaacoo offer list interface 1704, 1708, 1709 and 1710 (FIG. 17).

The Instant Kaacoo offer health update offer interface 2100B can be tied specifically to a health update, a combination of health update and photo offer, or a combination of other social media promotion requirements (for example, multiple health updates, different types of health updates (For example, Fitness and food offer or Fitness, Food and photo). In various embodiments, the Instant Kaacoo health update offer interface 2100B can also be a combination of a health update, photo offer (detection and recognition 150 server), third-party, third-party inventory (product, good, service, free item, event, sign up for an activity, entry to a certain location, etc.) for the offer contingent upon the social media promotion requirements to receive the incentive. This can be a monetary or non-monetary transaction. The health update offer can also be customized to a unique identifier to customize a health update offer specific for the unique ID. For example, a consumer who has diabetes has a specific diet plan to achieve and the offer is customized based on the consumer (unique ID) diabetes diet plan and displayed only to the specific consumer (unique ID). A customized health update offer can include various combinations of health updates

The consumer selects the instant offer through the mobile device 105 display, after the consumer authorizes 2104B and submits the validation of the social media promotion requirement inputs are submitted (for example, a health update 2106B, at least one health update is submitted as part of the social media promotion requirements), validation against the offer social media promotions requirements 2105B are evaluated, the validation executes health updates validation against the health update inputs and other additional social media promotion requirements submitted and if validation is authorized, a monetary (financial) transaction through a payment processing is executed and a confirmation is received. If the offer is non-monetary transaction, then no financial transaction or mobile payment processing is executed and a confirmation is automatically sent to the consumer and third party.

In FIG. 21B a method of processing an electronic transaction includes providing an offer for a health update (social media promotion requirements), the offer contingent upon a social media promotion requirements, receiving an authorization for the health update (social media promotion requirements) and the social media promotion based on the health update, performing the social media promotion update based on the consumer social media promotion requirement input health update, and processing the electronic transaction after verifying the social media promotion based on the health update.

In FIG. 21B, for a health update offer in some implementations, the method is at least partially performed on one or more of a smart device, laptop, desktop, smart tablet, smart phone, glasses or other wearable computing device, or any other device. In some implementations, the offer for health update can include a discount or other incentive based on the social media promotion. The social media promotion requirements may include one or more of a health update from an upload from a health device, text message, a photograph, a video, a drawing or other image, a voicemail, a tweet, a re-tweet, a Facebook page or status, a blog, or any other social communication channel. The health update may include an update provided to a health care related company from a medical device monitoring an aspect of a consumer's health. The medical device may include one or more of a scale, a pedometer, a glucose meter, a body fat meter, a health-tracking device, or a health organization server. The incentive may include allowing a consumer to select an immediate appointment time. In some implementations, the incentive includes allowing a consumer to move up in priority to be seen for medical services. In some implementations, the medical services include examination, clinic work, testing, or lab work. In some implementations, the incentive includes providing a consumer to receive immediate or prioritized processing of lab results. In some implementations, apparatus, systems, processors and computer readable medium may incorporate such methods and processes.

In FIG. 21B, a health update can represented an offer contingent social media promotion requirements or transaction requirements.

In FIG. 21B, includes a method of processing an electronic transaction, including providing an offer for a health update, the offer contingent upon a social media promotion, receiving an authorization for the health update and the social media promotion based on the health update, performing the social media promotion based on the health update, and processing the electronic transaction after verifying the social media promotion based on the health update. The method may further include one or more of, or be characterized by, the following features, and may include additional features. The method may further include providing data for the health update, wherein the method is at least partially performed on one or more of a smart device, laptop, desktop, smart tablet, smart phone, glasses or other wearable computing device, or any other device. A technology device may provide the data for the health update by a server data transfer update or a manual input data. The data may include includes food data, wherein a technology device includes a food update device configured to track food intake comprising a type of food intake, the method further comprising uploading the food data from a server or receiving a food data input from a user interface. The data may include fitness data, wherein the technology device comprises a fitness device, and wherein the method further comprises uploading fitness data from the fitness device to another device, and wherein the health update is based on the fitness device. The fitness data may include at least one of walking, running, biking, or swimming data. The data may include medical data, wherein the technology device is a medical device, and wherein the medical data includes data from tracking a medical condition, medical test results, or health data, and wherein the method further comprises uploading the medical data from the medical device to another device. The medical device may include one or more of a scale, a pedometer, a glucose meter, a body fat meter, a health tracking device, or a health organization server. A medical device update may include a technology device tracking a medical condition, test results, or any health data, metric and a data upload for a server to another device or a manual input.

In FIG. 21B, a health update offer can refer to the following:

The health update may include data from a technology device, and the method further comprises collecting data, uploading the collected data to a server, and using the uploaded data by an application processing the electronic transaction. The social media promotion can may include one or more of a text message, an email, voice to text, a photograph, a video, a drawing or other image, a voicemail, a tweet, a re-tweet, a Facebook page or status, a blog, a sentimental representation or any other social communication channel.

In some implementations, offer may be set by a third party, merchant, vendor or specific type of vendor (for profit and non-profit)—(e.g., Sports Authority), health care provider (e.g., hospital), health care payer (e.g., Blue cross insurance company), third-party (e.g., Nike), individual (e.g., individual entity), entity (e.g., any type of noted formed formal or non-formal entity), non-profit (e.g., American Red Cross) and charity (e.g., any formal or non-formal organization and any other type of entity). The offer may be for a product, good, image recognition, health update (fitness, food, medical, health), activity, action, charity, charity participation, data update, program, service, feedback, prior to transaction, post transaction feedback, feedback, survey, customer service processing and management, care management, clinical service, alert, or monitoring, and the offer includes a discount or other incentive based on the social media promotion.

The offer for a health update can relate to meeting a food goods, food service, any food related actions, food type selections, food consumptions, future food intake or consumption, achieving a certain food or nutritional requirement, a nutritional requirement, food intake requirement, total amount of food requirement, combination of food requirements (e.g., calorie and nutrition), individual menu items, fix-priced menu items, food groupings, specific stores, items from specific stores, nutritional menu groupings, menu items for a certain nutritional value, nutritional meals, total amount or combination of a nutritional food from a specific food group (basic food groups), nutrition or food or calorie tracking requirement, defined average food, nutritional, fitness and overall tracking requirement, a diet, or diet plan nutritional goals.

Fitness as used herein is a broad term, and may be defined for each sport (example, running is distance and time. Biking may include distance, time, slope gain, walking distance, number of steps walked, distance, time, etc., achieving a certain fitness distant requirement (example, for running, cycling, swimming), achieving a certain fitness time requirement (example, running up to ten minutes—a set time), achieving a certain fitness distance and time requirement (example running one mile under ten minutes), achieving an average fitness requirement, achieving an average fitness requirement or a set period of time, achieving a best fitness requirement over more than one fitness requirement, medical is defined by the type of medical service, test, tracking, monitoring or intake.

An offer may be a monetary offer for purchase (e.g., a monetary offer in exchange via payment transaction) can include a discount or other incentive based on the social media promotion. The offer may be a non-monetary offer selected and can include a discount or other incentive based on the social media promotion. An offer may relate to meeting one or more metric or requirement and can include a discount or other incentive based on the social media promotion. The metric (or requirement) may be based on to meeting one or more metric, number requirement, physical activity metric (e.g., fitness requirement equals biking equals time, distance, speed), food requirement (e.g., calories, nutrition, food groups, etc.), medical requirements, charity requirements and any other defined metric. The offer may be based on meeting an organized grouping (e.g., programs, services, line sequence, milestone(s), goal(s), average, team total, # of participants, # of participants referred, individual, group, etc.) can include a discount or other incentive based on the social media promotion.

In some implementations, the offer includes a health improvement goal, the goal is achieved includes a discount or other incentive based on social media promotion and additional discount and or incentive is granted. The offer can include a future discount or other incentive based on social media promotion. An offer for the ability to select a primary physician can include a discount or other incentive based on social media promotion. The offer to select any physician or health care specialists can include a discount or incentive based on social media promotion.

An offer for the health risk assessment (HRA) can include a discount or other incentive based on the social media promotion. An offer for the Health Savings Account (HAS) can include a discount or other incentive based on the social media promotion. An offer for a health coach call, remote health service or related medical service in exchange for diagnoses can include a discount or other incentive based on social media promotion. An offer for chronic management can include a discount or other incentive based on social media promotion. An offer for a disease management can include a discount or other incentive based on social media promotion. An offer for a wellness and/or prevention can include a discount or incentive based on social media promotion.

An offer to participate in one or more clinical trial or focus groups can include a discount or incentive based on social media promotion. An offer for pharmacy (e.g., over the counter, prescription based, pharma, etc.) can include a discount or incentive based on social media promotion. An offer can provide monitoring for a health condition, monitoring provides an alert and includes a discount or incentive based on a social media promotion. In some implementations, the offer provides in-home care health monitoring (e.g., video monitoring, pharmacy monitoring, laser monitoring—doorway or sensor etc.). The offer may also provide an alert to an emergency response organization and individuals linked to the specific individual. The offer may include a discount or incentive based on a social media promotion or communication channel. In some implementations, the offer provides a service, alert and communication channel for customer service or emergency response alerts based on a social media promotion and or channel. An offer for a wellness and/or prevention can include a discount or incentive based on social media promotion. The offer may enable physician to physician collaboration can include a discount or incentive based on social media promotion. The offer may provide a learning management environment can include a discount or incentive based on social media promotion.

The offer may be related to health data management exchange. For example, for example, an offer for a health care EMR exchange between an individual and or payer or provider can include a discount or incentive based on social media promotion. The offer may also relate to electronic wireless monitoring, for example, for health care and social media. For example, an offer for a wireless connected electronic hardware can include a discount or incentive based on a social media promotion. The offer for a wireless connected electronic hardware service via issuing a discount or incentive based on social media promotion may be used for health care tracking, monitoring and/or issuing an alert if the monitoring requirement is not met. In one example of an offer for a monitoring for a health condition, monitoring provides an alert and includes a discount or incentive based on a social media promotion for the service, and may use an alerts for any health care management condition. In some implementations, the offer provides in home care health monitoring (e.g., video monitoring, pharmacy monitoring, laser monitoring—doorway or sensor etc.), provides an alert to an emergency response organization and individuals linked to the specific individual, includes a discount or incentive based on a social media promotion or communication channel used. In some implementations, an offer provides a service, alert and communication channel for customer service or emergency response alerts based on a social media promotion and or channel.

The transaction may also relate to health care data management, using an offer to facilitate collecting, managing and/or identifying information or data. For example, data may be collected via issuing a discount or incentive offer based on social media promotion is used for health care patient management. In some implementations, the patient to physician data collected via issuing a discount or incentive offer based on social media promotion may be used for health care patient management. In some implementations, the data collected via issuing a discount or incentive offer based on social media promotion may be used for public health care management. In some implementations, the data collected via issuing a discount or incentive offer based on social media promotion may be used for health care management and issued to provider and payers on health care trends, outbreaks and overall public or private health care management. For example, to connect other hospitals on public health outbreaks, trends, or what health care issues they are experiencing.

In some implementations, data collected via issuing a discount or incentive offer based on social media promotion may be used for diagnostic decision support information. Data collected via issuing a discount or incentive offer based on social media promotion may be used for health care management to recommend personalized medicine, any health related services or health management to an individual and group.

Data collected via issuing a discount or incentive offer based on social media promotion may be used for chronic care management. Data collected via issuing a discount or incentive offer based on social media promotion may be used for diagnosis services management. In some implementations, data collected via issuing a discount or incentive offer based on social media promotion may be used for at least one of treatment services management, health care patient management, chronic management, health care disease management, wellness and prevention management, clinical management, pharmacy management, monitoring patient management, or health care alert management. Data collected via issuing a discount or incentive offer based on social media promotion may be used for monitoring physical health related hardware (e.g., pill bottles), alert and using social media for an alert management.

In some implementations, a system can be configured for managing health care via social media and certain payment transactions. For example, in some implementations, an offer of collecting data via issuing a discount or incentive based on social media may be used for an algorithm for health care analytics (e.g., health care management, payment transaction and social media to identify patient management, care management, chronic management, disease management, wellness and prevention, clinical and focus group management, pharmacy management, health care monitoring and management, vital care monitoring and management, alert management, public health management, physician to physician collaboration, learning management and any health care related management) crossing payment transaction, social media and/or health care for predictive analytics.

In FIG. 21B, health updates offer can include the following:
data includes food data, wherein a technology device includes a food update device configured to track food intake comprising a type of food intake, the method further comprising uploading the food data from a server or receiving a food data input from a user interface.
fitness data, wherein the technology device comprises a fitness device, and wherein the method further comprises uploading fitness data from the fitness device to another device, and wherein the health update is based on the fitness device.
fitness data includes at least one of walking, running, biking, or swimming data. Data includes medical data, wherein the technology device is a medical device, and wherein the medical data includes data from tracking a medical condition, medical test results, or health data, and wherein the method further comprises uploading the medical data from the medical device to another device.
medical device includes one or more of a scale, a pedometer, a glucose meter, a body fat meter, a health tracking device, or a health organization server.
wherein the health update includes data from a technology device, and the method further comprises collecting data, uploading the collected data to a server, and using the uploaded data by an application processing the electronic transaction

### Monetary Health Update Offer

In an embodiment, the mobile device 105 can display the instant Kaacoo monetary health update offer interface 2100B, once the consumer selects an offer in the instant Kaacoo offer list interface 1704, 1708, 1709 and 1710 (FIG. 17) then the consumer authorizes 2104B (FIG. 21B) and provides consumer social media promotion requirements inputs contingent upon the offer 2100B through the mobile device 105, the Offer Validation Server (KTM) 150 validates the consumer social media promotion requirements inputs and additional supporting information, the Offer Validation Server (KTM) 150 validates at least one health update via health update server 160, if validation is met 100% against from the consumer inputs against the offer social media promotion requirements at least one image validated the health update server 160 authorizes to the Offer Validation Server (KTM) 150 validation is met, the Offer Validation server (KTM) 150 then authorizes Social media server 125 to execute at least one social media updates to at least social media venue (Social media server 125), once social media updates are completed, the social media venue server 125 authorizes the updates are completed to the Offer Validation Server 150, Offer Validation Server (KTM) 150 executes a mobile payment processing request to the payment processing server 130, once payment processing server 130 is authorized to the Offer Validation server 150, Offer Validation server 150 a confirmation is issued and displayed to the mobile device 105. Although various portions of the interface 2100B are shown, a person having ordinary skill in the art will appreciate that the portions can be rearranged, portions can be omitted, and/or additional portions can be added.

### Non-Monetary Health Offer

In an embodiment, the mobile device 105 can display the instant Kaacoo non-monetary offer interface 2100B, once the consumer selects an offer in the instant Kaacoo non-monetary offer list interface 1704, 1708, 1709 and 1710 (FIG. 17) then the consumer authorizes 2104B (FIG. 21B) and provides consumer social media promotion requirements inputs contingent upon the offer 2101B through the mobile device 105, the Offer Validation Server (KTM) 150 validates the consumer social media promotion requirements inputs and additional supporting information, the Offer Validation Server (KTM) 150 Validates at least one image via health update server 160, if validation is met 100% against from the consumer inputs against the offer social media promotion requirements at least one health update validated the health update server 160 authorizes to the Offer Validation Server (KTM) 150 validation is met, the Offer Validation server (KTM) 150 then authorizes Social media server 125 to execute at least one social media updates to at least social media venue (Social media server 125), once social media updates are completed, the social media venue server 125 authorizes the updates are completed to the Offer Validation Server 150, Offer Validation Server (KTM) 150 executes a confirmation and displayed to the mobile device 105. Although various portions of the interface 2100B are shown, a person having ordinary skill in the art will appreciate that the portions can be rearranged, portions can be omitted, and/or additional portions can be added.

For example, the Technical step-by-step execution (see FIGURE HEALTH UPDATES FIG. 2B) for health updates can include and a person having ordinary skill in the art will appreciate that the portions can be rearranged, portions can be omitted, and/or additional portions can be added.

### Non-Monetary Offer

In an embodiment, the mobile device 105 can display the instant Kaacoo non-monetary offer interface 2100C, once the consumer selects an offer in the instant Kaacoo offer list interface 2100C (FIG. 2100), then the consumer authorizes 2110C (FIG. 21) and provides consumer social media promotion requirements inputs contingent upon the offer 2101C through the mobile device 105, the Offer Validation Server (KTM) 150 validates the consumer social media promotion requirements inputs and additional supporting information, the Offer Validation Server (KTM) 150 Validates, if validation is met 100% against from the consumer inputs against the offer social media promotion requirements at least one authorizes to the Offer Validation Server (KTM) 150 validation is met, the Offer Validation server (KTM) 150 then authorizes Social media server 125 to execute at least one social media updates to at least social media venue (Social media server 125), once social media updates are completed, the social media venue server 125 authorizes the updates are completed to the Offer Validation Server 150, Offer Validation Server (KTM) 150 executes a confirmation and displayed to the mobile device 105. Although various portions of the interface 2100C are shown, a person having ordinary skill in the art will appreciate that the portions can be rearranged, portions can be omitted, and/or additional portions can be added.

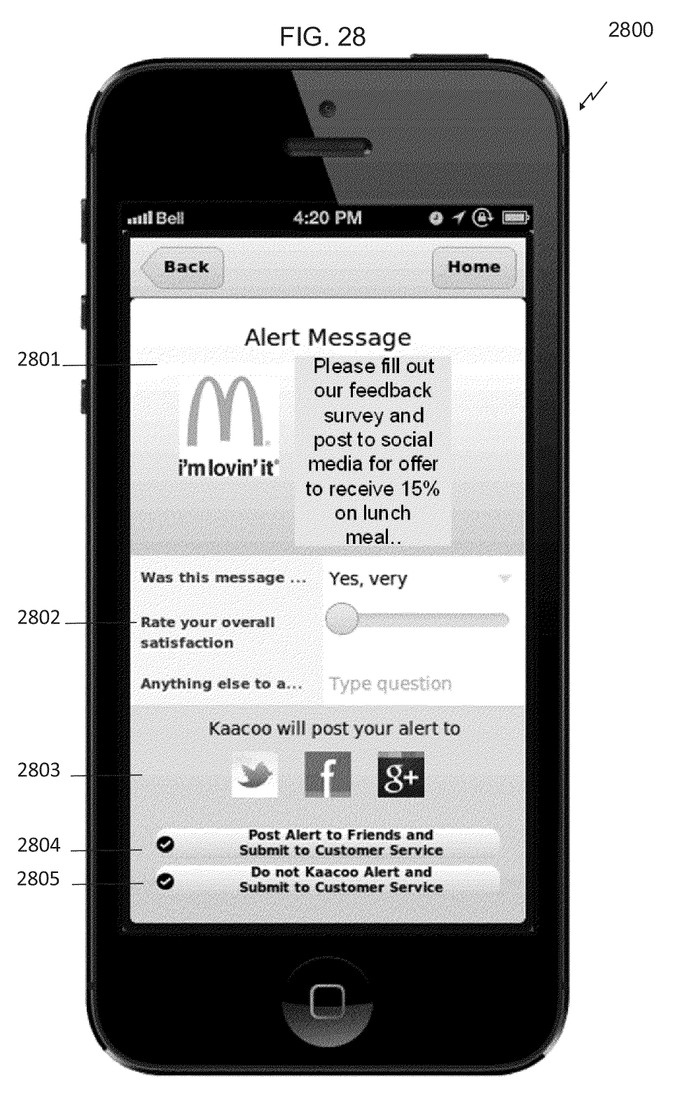

FIG. 28 illustrates an exemplary alert interface FIG. 28, according to an embodiment. The alert interface FIG. 28 can be implemented in, for example, the incentive application running on the mobile device 105 (FIG. 1). In various embodiments, the mobile device 105 can display the alert interface FIG. 28, for example, after a user selects the alert interface FIG. 2 (FIG. A) from the home interface A00 (FIG. A). As shown, the alert interface FIG. 28 2801 Alert offer, Social media promotion requirements 2802, one or more social media logos 2803, submit interface button 2804. Although various portions of the interface FIG. 28 are shown, a person having ordinary skill in the art will appreciate that the portions can be rearranged, portions can be omitted, and/or additional portions can be added.

The notification interface K2806 serves to display key information and customer service features for the alert interface 2800. The notification interface 2800 can include, for example, an urgent text message.

The social media promotion requirements serves to display one or more requirements.

The social media promotion requirements 2802 serves to receive user feedback and can include, for example, one or more input text fields.

The social media submission interface button 2804 serves to receive authorization to initiate a feedback submission to customer service and a social media alert identified in the alert interface 2800. For example, when the consumer selects the social media submission interface 2800, the mobile device 105 (FIG. 1) can initiate the social media alert (for example directly, using locally stored social media credentials, or indirectly by authorizing another device to use remotely stored social media credentials), or a non-social media alert (for example, via e-mail, SMS, etc.). In an embodiment, the mobile device 105 can initiate the feedback submission to the analytics server 135 (FIG. 1). In various embodiments, a consumer can submit their answers to the Alert issuer to create a customer service ticket for the third party to take action upon.

The non-social media submission interface 2805 serves to receive authorization to initiate the feedback submission without the social media promotion incentive. For example, when the user selects the non-social media submission interface 2805, the mobile device 105 (FIG. 1) can initiate the feedback submission to the analytics server 135 (FIG. 1).

### Anytime Feedback

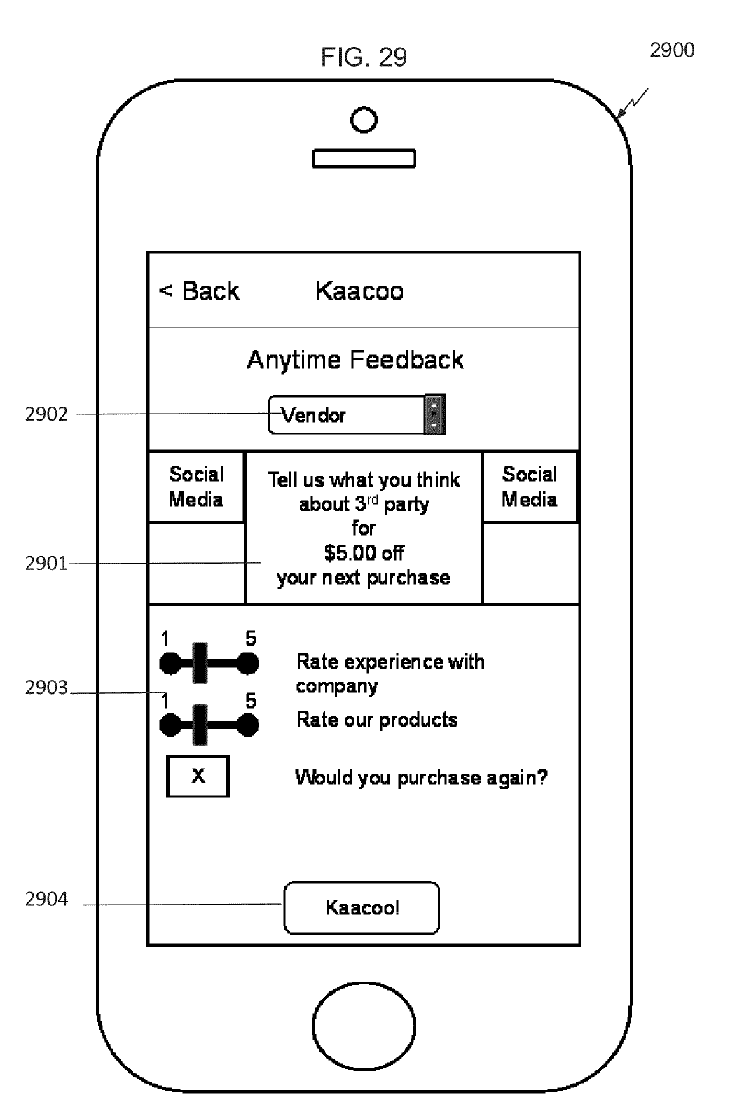

FIG. 29 illustrates an exemplary anytime feedback interface 2900, according to an embodiment. The anytime feedback interface 2900 can be implemented in, for example, the incentive application running on the mobile device 105 (FIG. 1). In various embodiments, the mobile device 105 can display the anytime feedback interface 2900, for example, after a consumer selects the anytime feedback interface 2900 (FIG. 29) or after a transaction or from the confirmation or the consumer home interface.

As shown, the anytime feedback interface 2900 includes one or more advertisements 2901, a third party interface 2902, one or more feedback inputs (social media promotion requirements 2903, and a submission interface 2904. Although various portions of the interface 2900 are shown, a person having ordinary skill in the art will appreciate that the portions can be rearranged, portions can be omitted, and/or additional portions can be added.

The third party selection interface 2903 serves to receive a third party selection from a consumer. In the illustrated embodiment, the third party selection interface 2903 includes a drop-down list of third party from which a consumer has made a transaction or can be another third party. In some embodiments, all third party associated with the incentive application can be listed. In other embodiments, products and/or services can be listed alternatively or additionally.

The anytime social media promotion requirement inputs L15 serve to receive feedback input from a consumer. The social media promotion requirements 2903 can further include one or more user-defined, third-parry-defined, or dynamically determined inputs such as, for example, text, pictures, video, drawings, audio recordings, hash tags, universal resource locators (URLs), etc. In the illustrated embodiment, for example, a consumer can choose between three check-boxes.

The submission interface 2904 serves to initiate submission of the social media promotion requirements contingent with the offer, entered in the social media promotion inputs 2903. In some embodiments, when the consumer selects the submission interface 2904, the mobile device 105 (FIG. 1) can initiate a social media promotion based on the feedback inputs 2903. For example, the mobile device 105 can transmit the social media promotion or an authorization for the social media promotion, to the social media server 125 (FIG. 1). In various embodiments, a consumer can submit their answers to the third-party to create a customer service ticket for the third party to take action upon.

In an embodiment, the mobile device 105 (FIG. 1) and/or the social media server 125 (FIG. 1) can analyze the social media promotion to identify negative feedback. For example, in the illustrated embodiment of FIG. 29, the mobile device 105 (FIG. 1) and/or the social media server 125 (FIG. 1) can detect that the “Terrible” box has been checked. The mobile device 105 (FIG. 1) and/or the social media server 125 (FIG. 1) can intercept the social media promotion and/or refrain from initiating the social media promotion. The mobile device 105 can display a further incentive to provide additional feedback, to ameliorate a negative experience, and/or to modify the social media promotion inputs 2904.

### Mobile Ordering Search

FIG. 22 illustrates a mobile ordering search interface 2200 that can include one or more third-party- and/or consumer-adjustable options associated with the offer 2101. For example, the illustrated embodiment includes a quantity selection drop-box, a payment method drop-box, and a delivery method drop-box. Although various portions of the order option interface 2200 are shown, a person having ordinary skill in the art will appreciate that the portions can be rearranged, portions can be omitted, and/or additional portions can be added.

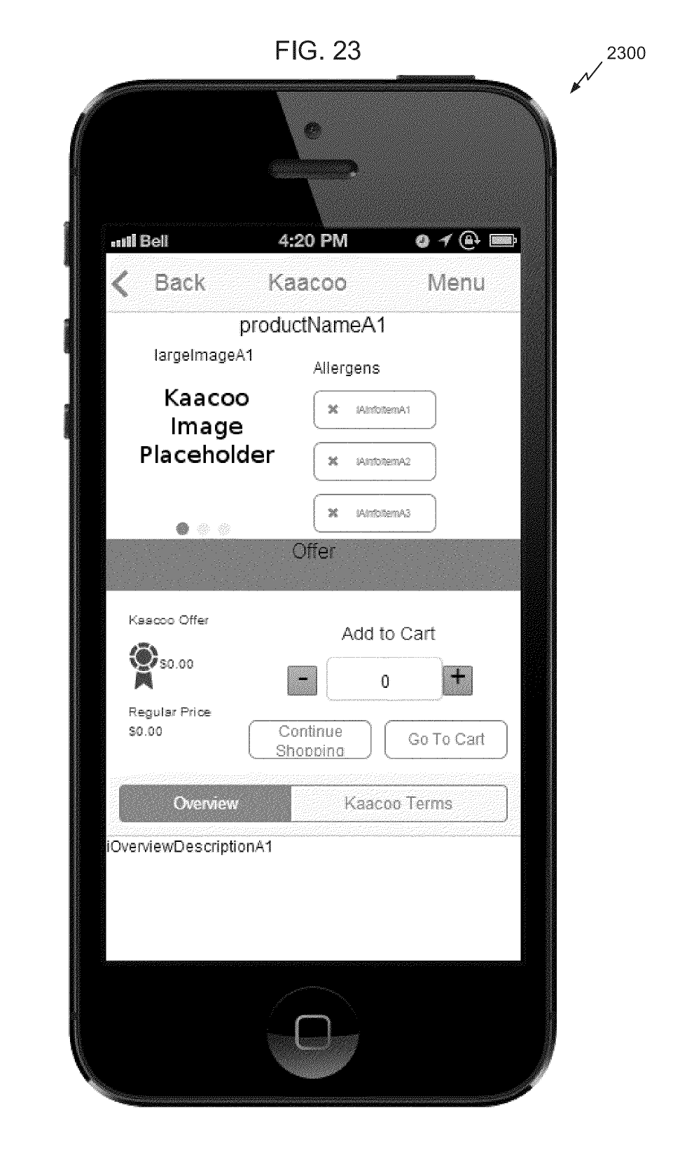

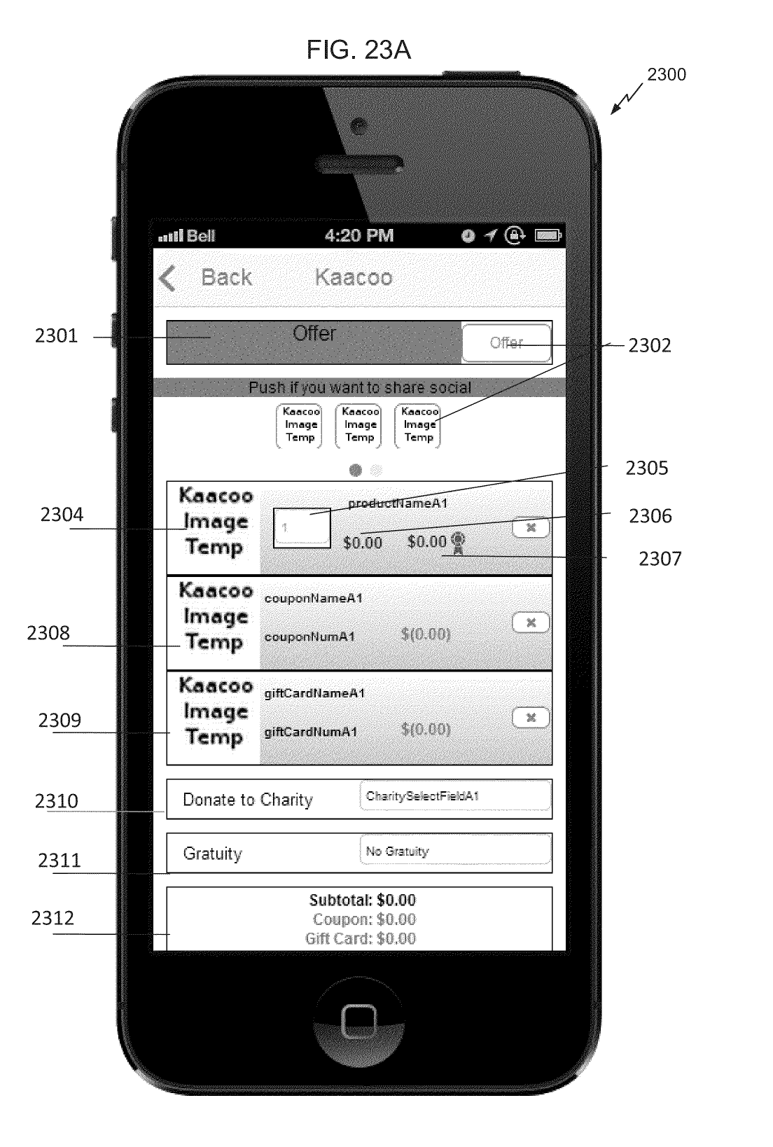

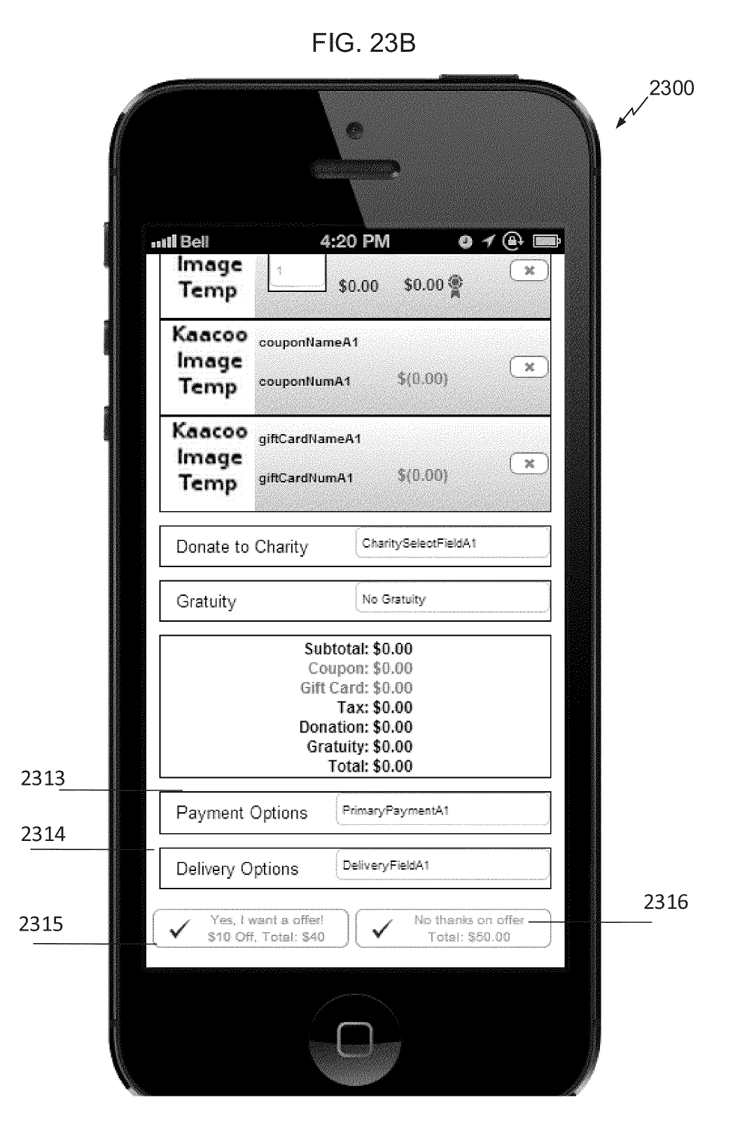

The item detail interface 2300 (FIG. 23) serves to communicate one or more characteristics of an item associated with the offer 2101. For example, the item detail interface 2300 can include one or more of an item and/or product, good, service name, description, photos, social media promotion requirements, regular price, Kaacoo price, terms and conditions associated with the offer transaction, and other supporting information.

### Checkout

FIG. 23 illustrates an exemplary checkout interface 2300, according to an embodiment. The checkout interface 2300 can be implemented in, for example, the incentive application running on the mobile device 105 (FIG. 1). In various embodiments, the mobile device 105 can display the checkout interface 2300, for example, after a consumer selects a mobile ordering search result in the search result mobile ordering interface cart button 2201 (FIG. 22). As shown, the checkout interface 2300 includes offer 2301, social media requirements 2304, item image 2304, quantity 2305, regular price 2306, offer price 2307, delete functionality 2307a, 2308 applied coupon information, 2309 applied coupon information, 2310 donate to charity functionality, 2311 gratuity 2311, 2312 check out summary matrix, 2313 payment options, 2314 Delivery options, 2315 consumer authorization 2315, Although various portions of the interface 2300 are shown, a person having ordinary skill in the art will appreciate that the portions can be rearranged, portions can be omitted, and/or additional portions can be added.

The social media promotion requirements information 2302 serves to identify one or more selected items or services, for example, items or services for which an incentive is offered. The offer can be a monetary or non-monetary offer to receive the incentive contingent upon meeting the social media requirements. In the illustrated embodiment, the social media promotion requirements information 2304 can include at least one offer requirement. In various embodiments, the social media offer requirements information 2304 can include other social media requirements for example, photograph, feedback, tagging, identifying information such as, for example, a moving image, text, etc. In various embodiments, the item information 2304 can identify a item, Third-party or vendor, etc.

In various embodiments, the checkout interface 2300 can further include one or more social media promotion requirements 2302. For example, any portion of the checkout interface 2300 described above, including the item information 2304, the order information E10, the offer 2101, the transaction interface E20, and the non-monetary transaction interface E25, or another portion not described, can include social media promotion requirements contingent to the offer. Social media promotion details can include, for example, particular social media content upon which the offer 2101 is contingent. Such social media content can include, for example, consumer and/or Third-party defined text, photographs, order details, social media types (e.g., text, photograph, etc.), one or more required or optional social media venues, etc.

The order information 2304 serves to identify and/or receive one or more order details associated with a transaction. In various embodiments, the order information 2304 can include one or more Third-party- and/or consumer-adjustable options associated with the transaction or offer 2302. Although various portions of the order information 2304 are shown, a person having ordinary skill in the art will appreciate that the portions can be rearranged, portions can be omitted, and/or additional portions can be added.

### Instant Kaacoo Offer Transaction—Monetary

The Offer Validation Server (KTM) 150 executes a mobile payment processing request to the payment processing server 130, once payment processing server 130 is authorized to the Offer Validation server 150, Offer Validation server 150 a confirmation is issued and displayed to the mobile device 105. Although various portions of the interface 2100 are shown, a person having ordinary skill in the art will appreciate that the portions can be rearranged, portions can be omitted, and/or additional portions can be added.

### Instant Kaacoo Offer—Non-Monetary

The Offer Validation server (KTM) 150 then authorizes Social media server 125 to execute at least one social media updates to at least social media venue (Social media server 125), once social media updates are completed, the social media venue server 125 authorizes the updates are completed to the Offer Validation Server 150, Offer Validation Server (KTM) 150 executes a confirmation and displayed to the mobile device 105. Although various portions of the interface 2100 are shown, a person having ordinary skill in the art will appreciate that the portions can be rearranged, portions can be omitted, and/or additional portions can be added.

### Mobile Ordering Transaction

The transaction interface 2315 (FIG. 23) serves to receive authorization to initiate the transaction and social media promotion requirements validation identified in the checkout interface 2300 for the platform provider Kaacoo to issue the incentive contingent with the offer and social media promotion requirements.

For example, when the consumer selects the transaction interface 2315 “Yes, Kaacoo offer”, the mobile device 105 (FIG. 1) can initiate the validation of the offer's contingent social media promotion requirements contingent with the offer for the consumers specific check out cart. The platform provider Kaacoo validates the consumer's social media promotion requirements inputs and additional information matches 100% of the offer's social media promotion requirements, then the social media updates are executed to the respective social media venues contingent with the offer. The consumer for example directly, using locally stored social media credentials, or indirectly by authorizing another device to use remotely stored social media credentials is signed in to the incentive application. In an embodiment, the mobile device 105 can confirm that the social media promotion updates has been posted, for example via the social media server 125 (FIG. 1). In an embodiment, the mobile device 105 can initiate the transaction (for example directly, using locally stored payment information, or indirectly by authorizing another device to use remotely stored payment information) at the offer price if a monetary or if a non-monetary execute the action. In some embodiments, the mobile device 105 initiates the transaction only after confirming completion of the social media promotion requirements contingent with the offer presented is met. In some embodiments, when the social media promotion requirements is not confirmed or authorized, the mobile device 105 can complete the transaction based on a regular item price and no offer's incentives are issued towards the transaction. For example, “No, offer” selected authorizes the regular price checkout total when submitted for processing.

### Transaction Confirmation

FIG. F illustrates an exemplary transaction confirmation interface F00, according to an embodiment. The transaction confirmation interface F00 can be implemented in, for example, the incentive application running on the mobile device 105 (FIG. 1). In various embodiments, the mobile device 105 can display the transaction confirmation interface F00, for example, after a consumer selects a search result in the search result interface B15 (FIG. B). As shown, the transaction confirmation interface F00 includes one or more social media logos F05, a confirmation identifier F10, an order detail confirmation F15, the home interface A25, and one or more advertisements F25. Although various portions of the interface F00 are shown, a person having ordinary skill in the art will appreciate that the portions can be rearranged, portions can be omitted, and/or additional portions can be added. For example, in some embodiments, the transaction confirmation interface F00 can include a feedback incentive or social media incentive, discussed below with respect to FIGS. G-I, or a link thereto.

### Social Media Promotion Interface

FIG. 17 illustrates an exemplary social media promotion interface 1900, according to an embodiment. The social media promotion interface 1900 can be implemented in, for example, the incentive application running on the mobile device 105 (FIG. 1). In various embodiments, the mobile device 105 can display the social media promotion interface G00, for example, after a user selects the social media promotion interface 1900 (FIG. 19). As shown, the social media promotion interface G00 includes an anytime feedback interface F25, a post-payment feedback interface G10, a focus feedback interface G15, and one or more advertisements G20. Although various portions of the interface 2500 are shown, a person having ordinary skill in the art will appreciate that the portions can be rearranged, portions can be omitted, and/or additional portions can be added.

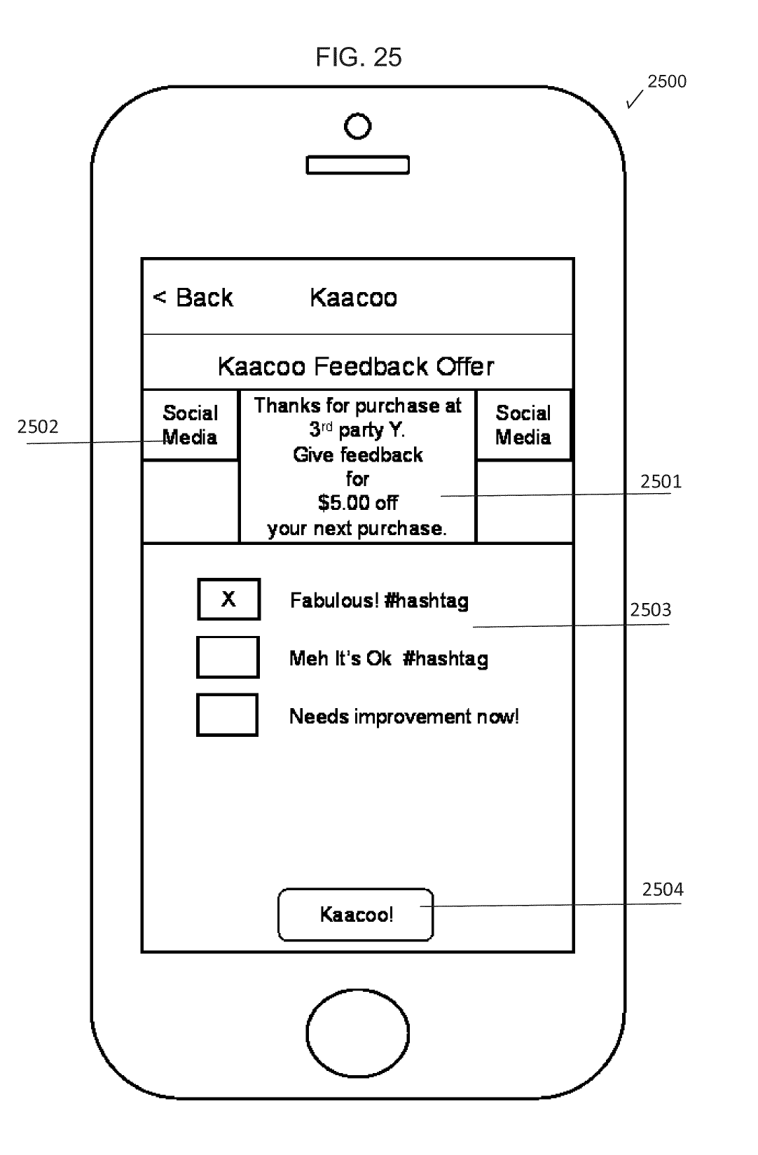

The anytime feedback interface FIG. 25 serves to navigate to an anytime feedback interface L00 (FIG. L). For example, when the user selects the anytime feedback interface FIG. 25, the mobile device 105 (FIG. 1) can display the feedback interface 2500. The anytime feedback interface 2500 can allow a user to provide a social media promotion regarding any third-party or vendor.

The post transaction, feedback or post-purchase feedback is the interface FIG. 25 serves to navigate to a post offer feedback interface 2500 (FIG. 25) after an offer transaction. For example, when the user selects the feedback interface offer 25, the mobile device 105 (FIG. 151) can display the post feedback offer interface 25. The feedback offer interface 2500 can allow an incentive user to provide an offer requirements regarding a third-party/vendor and/or product/service associated with a previous offer transaction. For example, the post feedback offer interface 2500 can include a list of products and/or services previously purchased, or third-parties/vendors associated therewith. The post feedback offer interface 2500 can further list incentives for providing offer feedback.

The focus feedback interface FIG. 15 serves to navigate to a focus feedback interface 100 (FIG. 1). For example, when the user selects the focus interface G15, the mobile device 105 (FIG. 1) can display the focus feedback interface 100. The focus feedback interface 100 can allow a user to provide non-social media feedback and/or opinions.

### Feedback Offer or Known as Feedback Offer

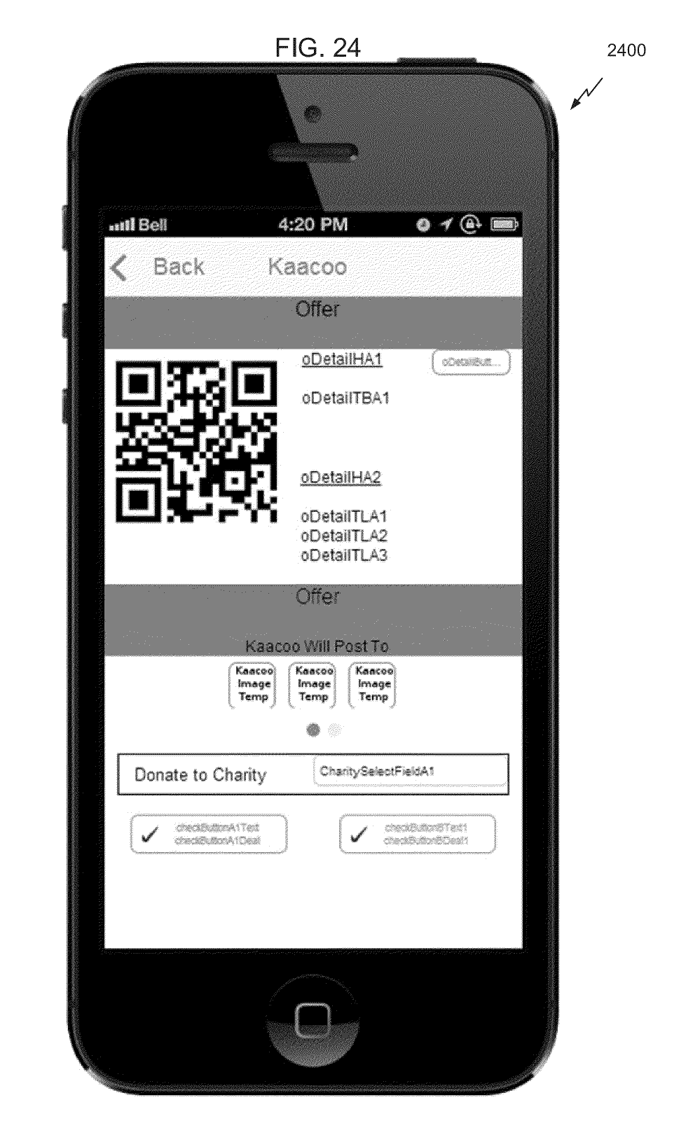

FIG. 25 illustrates an exemplary post-purchase feedback interface 2500, according to an embodiment. The post-purchase feedback interface 2500 can be implemented in, for example, the incentive application running on the mobile device 105 (FIG. 1). In various embodiments, the mobile device 105 can display the post-purchase feedback interface 2500, for example, after a consumer selects the post-purchase feedback interface 2500 (FIG. 25) or after offer transaction is confirmed from the confirmation in interface 2400 (FIG. 24). As shown, the post-purchase feedback interface 2500 includes one or more social media icons 2502, an offer 2501, one or more feedback inputs 2503, and a submission interface 2504. Although various portions of the interface 2500 are shown, a person having ordinary skill in the art will appreciate that the portions can be rearranged, portions can be omitted, and/or additional portions can be added.

The social media icons 2502 can include icons for social media networks associated with the offer 2501. In some embodiments, the social media icons 2502 are selectable when the third party creates the offer contingent social media promotion requirements. In other words, a third party can enable or disable one or more social media icons 2502. In an embodiment, only social media networks associated with enabled social media icons 2502 are included in the offer 2501. In some embodiments, a selectability for each icon 2502 can be pre-set, for example, by a third-party. In some embodiments, the value of the offer 2501 can be based on a number of selected social media networks and/or specific networks selected.

The offer 2501 serves to convey an offer that is linked to a completed transaction. The transaction can be processed as any type of an offer such as an instant Kaacoo offer, mobile ordering search offer, monetary offer, non-monetary offer, etc.

Once the transaction is processed and confirmed, if the third party selects a feedback offer for the transaction the consumer will receive a feedback offer for the consumer whose unique ID is link to the transaction. The feedback offer is an offer that is contingent on social media promotion requirements. For the feedback offer social medial promotion requirements are contingent on a consumer unique ID, one or more completed transaction. The completed transaction can be at least one item, product, good, service, event, or any other exchange between a third party and a consumer. Feedback offer can be a single item transacted or can be a group of items, multiple transaction, social group transactions or a combination of transaction combinations such as feedback for multiple transactions at one vendor and one particular item. For example, every time a consumer eats at a steak house restaurant the feedback offer is for the particular third party, a food item and over a period of three visits when the consumer transacted at the third party over time, the consumer is to provide consumer social media inputs and authorizes, if passes validation the social media updates are posted to at least one social media venue and the consumer receives the incentive (i.e. coupon for next meal).

In some embodiments, transaction, offer, and/or confirmation interfaces described herein can automatically apply the offer 2501 upon completion of the offer 2501. In other embodiments, a code can be provided after completion of the offer 2501, which can be applied during a later purchase. In the illustrated embodiment, for example, a third-party is offering $5.00 off a user's next transaction in exchange for authorization to post feedback entered in the feedback offer social media promotion input interface 2503.

The social media promotion requirements consumer inputs 2503 serve to receive feedback from a consumer. The consumer social media promotion input 2503 can further include one or more user-defined, third-parry-defined, or dynamically determined social media promotions such as, for example, text, pictures, video, drawings, audio recordings, hash tags, universal resource locators (URLs), etc. In the illustrated embodiment, for example, a user can choose one of three text boxes including pre-defined responses. Additionally, the user can include additional text or pictures.

The submission interface 2504 serves to initiate submission of the feedback offer, the entered in consumer social media promotion feedback offer inputs 2503. In some embodiments, when the consumer selects the submission interface 2504, the mobile device 105 (FIG. 1), if consumer social media promotion feedback inputs pass validation server (KTM) 150, then the social media updates are executed on at least one social media server 125, and if a monetary transacted then payment processing server 130 is executed then returned to the consumer for confirmation on the mobile device 105 (FIG. 1) Feedback offer validation can be a combination of consumer credentials social media server 125, object detection and recognition server 155, health update server 160, payment processing 130, analytics server 135 and other server for validation that are contingent with the offer social media promotion requirements.

In an embodiment, the mobile device 105 (FIG. 1) and/or the social media server 125 (FIG. 1) can analyze the social media promotion to identify negative feedback. For example, in the illustrated embodiment of FIG. 25, the mobile device 105 (FIG. 1) and/or the social media server 125 (FIG. 1) can detect that the “Naa Improvements Now!” box has been checked. The mobile device 105 (FIG. 1) and/or the social media server 125 (FIG. 1) can intercept the social media promotion and/or refrain from initiating the social media promotion. The mobile device 105 can display a further incentive to provide additional feedback, to ameliorate a negative experience, and/or to modify the feedback inputs 2504.

### Dashboard

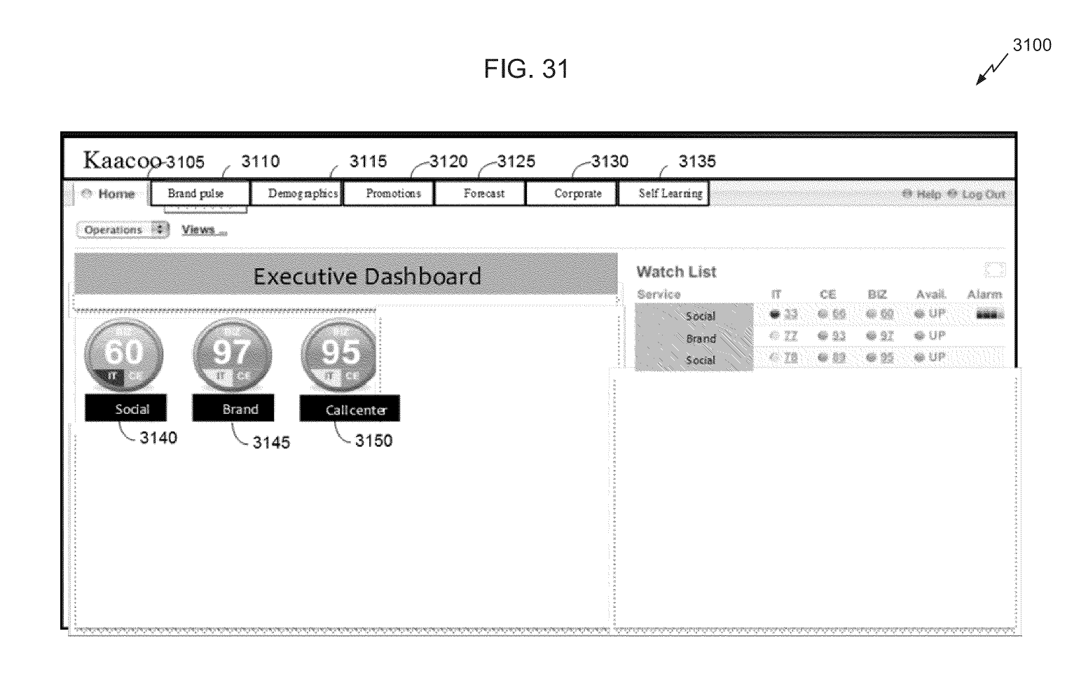

FIG. 31 illustrates an exemplary dashboard interface 3100, according to an embodiment. The dashboard interface 3100 can be implemented as, for example, a web page displayed by the mobile device 110 (FIG. 1) and served by the analytics server 135 (FIG. 1). As shown, the dashboard interface 3100 includes a variety of analytic tools including an executive dashboard 3105 including a social media score 3140, a brand score 3145, and a call center score 3150, a brand pulse monitor 3110, a demographics monitor 3115, a promotions monitor 3120, a forecast monitor 3125, a corporate monitor 3130, and a self-learning monitor 3135. Although various interface components are shown, a person having ordinary skill in the art will appreciate that the interface components can be rearranged, components can be omitted, and/or additional components can be added.

In various embodiments, the analytics server 135 (FIG. 1) can be configured to determine a real time brand pulse, what consumers are saying regarding competitors, what consumers are buying from competitors, consumer behavior, trending transaction power, forecasting, consumer demographics including profiles, consumer transaction power and location, and regional purchasing power and business operations.

In various embodiments, the analytics server 135 (FIG. 1) can be configured to determine a real time brand pulse, what consumers are purchasing, what consumers are saying about the vendor, what consumers are saying regarding competitors, what consumers are buying from competitors, consumer behavior, trending transaction power, forecasting, consumer demographics including profiles, consumer transaction power and location, and regional purchasing power and business operations.

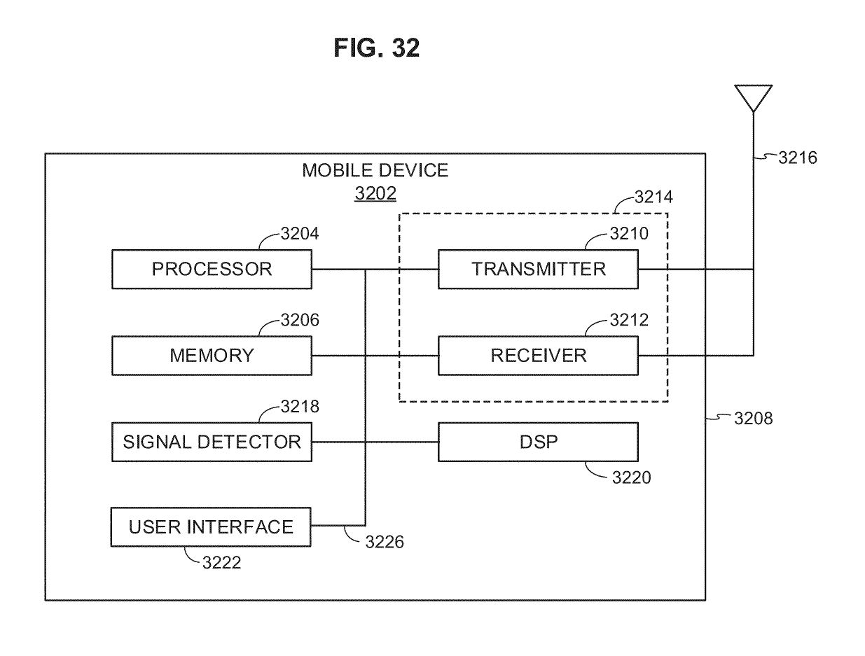

FIG. 32 illustrates an example of various components that can be included in a mobile device 3202 that can be employed within the e-commerce incentive system 100 of FIG. 1. The mobile device 3202 is an example of a device that can be configured to implement the various methods described herein. For example, in some embodiments, those of a client computing device that may communicate with a computer server system to communicate information of an offer to a consumer (user), receive input from the consumer, validate (wholly or in part) consumer input to determine if it meets transaction requirements of an offer, transmit consumer input to the computer server system, and receive and display information relating to an incentive for viewing by a consumer. In various embodiments, the mobile device 3202 can be an example of the mobile device 105, the device 110, the Point-of-Sale (POS) device 115, and/or the access controlled entry device 145.

The mobile device 3202 can include a processor 3204 which controls operation of the mobile device 3202. The processor 3204 can also be referred to as a central processing unit (CPU). Memory 3206, which can include both read-only memory (ROM) and random access memory (RAM), can provide instructions and data to the processor 3204. A portion of the memory 3206 can also include non-volatile random access memory (NVRAM). The processor 3204 typically performs logical and arithmetic operations based on program instructions stored within the memory 3206. The instructions in the memory 3206 can be executable to implement the methods described herein.

The processor 3204 can include or be a component of a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the one or more processors, cause the processing system to perform the various functions described herein.

The mobile device 3202 can also include a housing 3208 that can include a transmitter 3210 and/or a receiver 3212 to allow transmission and reception of data between the mobile device 3202 and a remote location. The transmitter 3210 and receiver 3212 can be combined into a transceiver 3214. An antenna 3216 can be attached to the housing 3208 and electrically coupled to the transceiver 3214. The mobile device 3202 can also include (not shown) multiple transmitters, multiple receivers, multiple transceivers, and/or multiple antennas. The transmitter 3210 and receiver 3212 can be configured to communicate via wired and/or wireless communications, including via protocols such as WIFI, Bluetooth, cellular data, etc.

The mobile device 3202 can also include a signal detector 3218 that can be used in an effort to detect and quantify the level of signals received by the transceiver 3214. The signal detector 3218 can detect such signals as total energy, energy per subcarrier per symbol, power spectral density and other signals. The mobile device 3202 can also include a digital signal processor (DSP) 3220 for use in processing signals. The DSP 3220 can be configured to generate a packet for transmission. In some aspects, the packet can include a physical layer data unit (PPDU).

The mobile device 3202 can further include a user interface 3222 in some aspects. The user interface 3222 can include a keypad, a microphone, a speaker, and/or a display. The user interface 3222 can include any element or component that conveys information to a user of the mobile device 3202 and/or receives input from the user.

The various components of the mobile device 3202 can be coupled together by a bus system 3226. The bus system 3226 can include a data bus, for example, as well as a power bus, a control signal bus, and a status signal bus in addition to the data bus. The components of the mobile device 3202 can be coupled together or accept or provide inputs to each other using some other mechanism.

Although a number of separate components are illustrated in FIG. 32, one or more of the components can be combined or commonly implemented. For example, the processor 3204 can be used to implement not only the functionality described above with respect to the processor 3204, but also to implement the functionality described above with respect to the signal detector 3218 and/or the DSP 3220. Further, each of the components illustrated in FIG. 32 can be implemented using a plurality of separate elements.

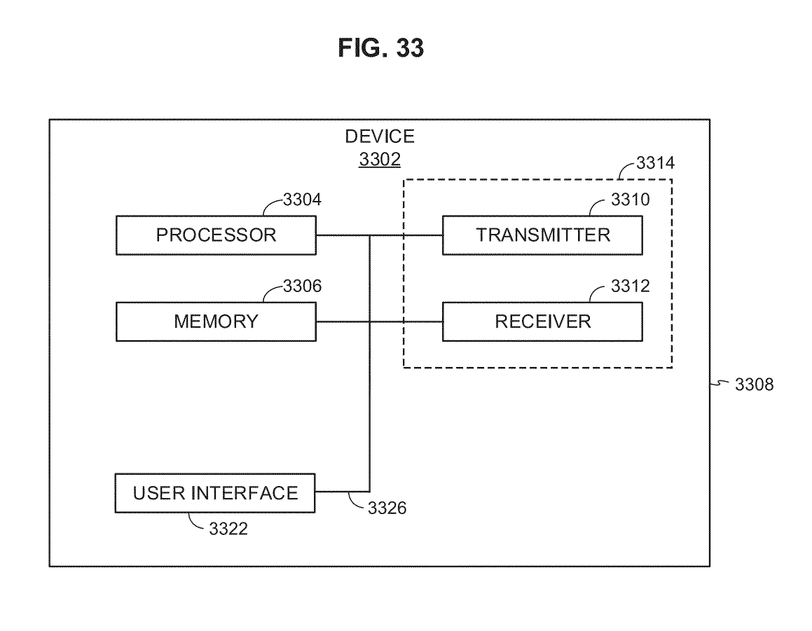

FIG. 33 illustrates various components that can be utilized in a device 3302 that can be employed within the e-commerce offer/incentive system 100 illustrated in FIG. 1. The device 3302 is an example of a device that can be configured to implement the various methods described herein. For example, the device 3302 can be an example of, and perform the functionality of device 110, any of the servers 125, 130, 135, and 140, 150 and 1640 the POS 115, and/or the access controlled entry 145.

The device 3302 can include a processor 3304 which controls operation of the device 3302. The processor 3304 can also be referred to as a central processing unit (CPU). Memory 3306, which can include both read-only memory (ROM) and random access memory (RAM), can provide instructions and data to the processor 3304. A portion of the memory 3306 can also include non-volatile random access memory (NVRAM). The processor 3304 typically performs logical and arithmetic operations based on program instructions stored within the memory 3306. The instructions in the memory 3306 can be executable to implement the methods described herein.

The processor 3304 can include or be a component of a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the one or more processors, cause the processing system to perform the various functions described herein.

The device 3302 can also include a housing 3308 that can include a transmitter 3310 and/or a receiver 3312 to allow transmission and reception of data between the device 3302 and a remote location. The transmitter 3310 and receiver 3312 can be combined into a transceiver 3314. The transmitter 3310 and receiver 3312 can be configured to communicate via wired and/or wireless communications, including via protocols such as WIFI, Bluetooth, cellular data, etc.

The device 3302 can further include a user interface 3322 in some aspects. The user interface 3322 can include a keypad, a microphone, a speaker, and/or a display. The user interface 3322 can include any element or component that conveys information to a user of the device 3302 and/or receives input from the user.

The various components of the device 3302 can be coupled together by a bus system 3326. The bus system 3326 can include a data bus, for example, as well as a power bus, a control signal bus, and a status signal bus in addition to the data bus. The components of the device 3302 can be coupled together or accept or provide inputs to each other using some other mechanism.

Although a number of separate components are illustrated in FIG. 33, one or more of the components can be combined or commonly implemented. For example, the processor 3304 can be used to implement not only the functionality described above with respect to the processor 3304, but also to implement the functionality of a signal detector 3318 and/or a DSP. Further, each of the components illustrated in FIG. 33 can be implemented using a plurality of separate elements.

### Backend Flows

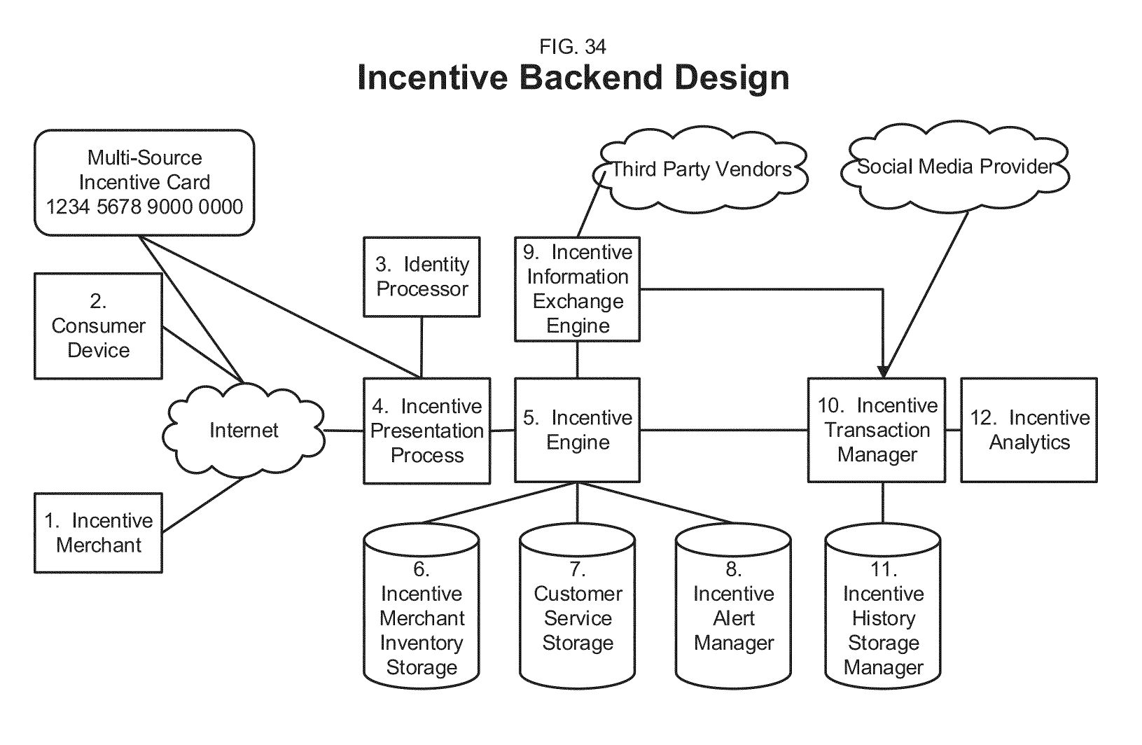

FIGS. 34-45B illustrate exemplary systems and processes for managing social media incentives, according to various embodiments. FIG. 34 illustrates an e-commerce system, which can include the e-commerce system 100 of FIG. 1. The e-commerce system of FIG. 34 includes an incentive third-party, a consumer device, and identity processor, an incentive presentation process, an incentive engine, an incentive third-party inventory storage, a customer service storage, an incentive alert manager, an incentive information exchange engine, an incentive transaction manager, an incentive history storage manager, incentive analytics, the Internet, one or more third-party vendors, one or more social media providers, and an incentive card. In various embodiments, any portion shown in FIG. 34 can include one or more portions shown and discussed herein. For example, the consumer device of FIG. 34 can include the mobile device 105 (FIG. 1), the various managers, engines, and processes can be implemented on the analytics server 135 (FIG. 1), etc. Table 1, below, shows exemplary functionality and exemplary backend assignments for back-end units shown in FIGS. 34-45. References to “Kaacoo” in this disclosure merely indicate an example of a company that my operate and/or control systems that perform certain functionality described herein (for example, by the platform provider that operates and/or controls such systems), and do not intend to limit implementations of the invention in any way.

TABLE 1

| Back end | | Backend assignments (not |
|---|---|---|
| unit name | Functionality | limited) |
| Kaacoo | Third-party access to create, | Third-party submitting inventory |
| Third-party | modify and terminate inventory, | and identifying deals |
| | create deals and alerts | |
| Consumer | Signs into using any smart device, | Any electronic device, smart device |
| Device | laptop | or ecommerce - Google Glasses, |
| | | smart device, laptop, iPad, smart |
| | | device, etc. |
| Identity | Signup, login, social media | Single sign-on page |
| Processor | identity, single sign-on | |
| Incentive | Dynamically construct consumer | Home page |
| Presentation | application experience | |
| Process | | |
| Incentive | Contextual search for items and | All search capabilities |
| Engine | deals. Process that combines | |
| | consumer profile, appropriate | |
| | third-party inventory and relevant | |
| | deals | |
| Incentive | All third-party inventory for the | When consumers select, consumers |
| Third-party | consumer and creates promotion | pull inventory information |
| Inventory | deal. | |
| Storage | | |
| Customer | All post transaction feedback, | Any type of feedback or alerts |
| Service | focused feedback, anytime | |
| Storage | feedback and alerts | |
| Incentive | Direct push notification of | Alert at any time (see next) |
| Alert | important information | |
| Manager | | |
| Incentive | Consumer information data | Payment for exchange of |
| Information | exchange portal on demand, i.e. | information (meet me, health care |
| Exchange | power providers, health care | exchange) |
| Engine | | |
| Incentive | Transaction manager for social | Social media pre, post, any time or |
| Transaction | media message, feedback, | alert, payment, reconciliation |
| Manager | broadcast alerts/Payment process | |
| | for transaction and reconciliation | |
| Incentive | All consumer interactions, | All transaction history and |
| History | confirmations, transaction history, | confirmation |
| Storage | feedback history, alert | |
| Manager | | |
| Incentive | Analytics on consumer behavior, | Analytics, Alerts and Customer |
| Analytics | deal success, social media, | Service feedback/ticketing |
| | feedback and alert customer | |
| | service ticketing, alert API and | |
| | general reporting | |

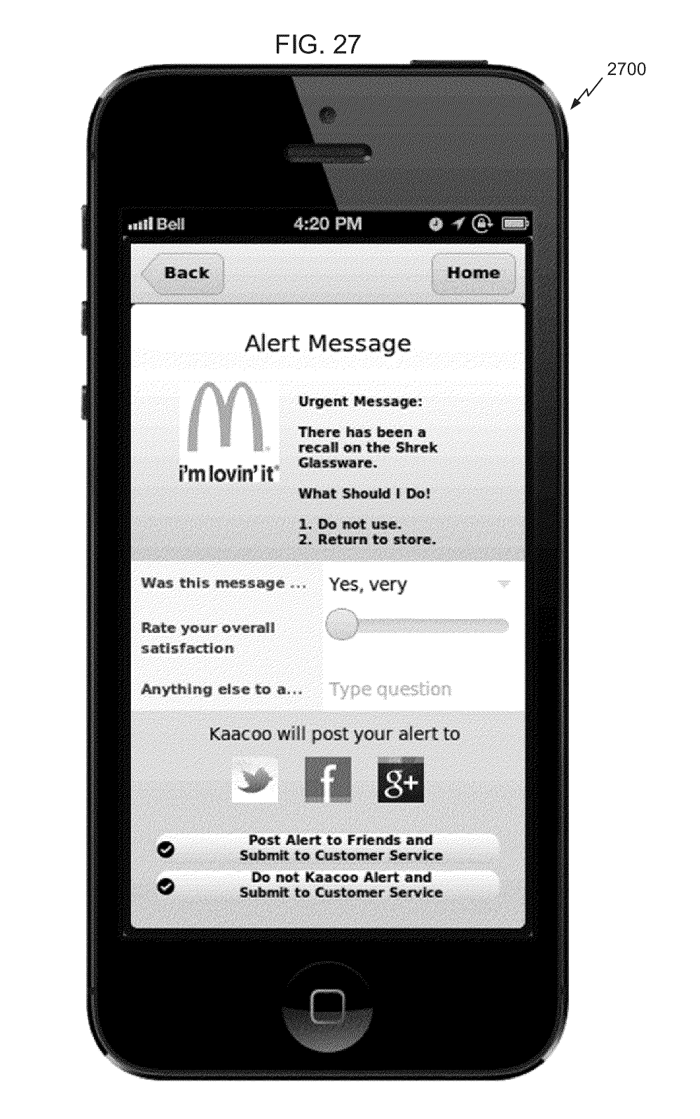

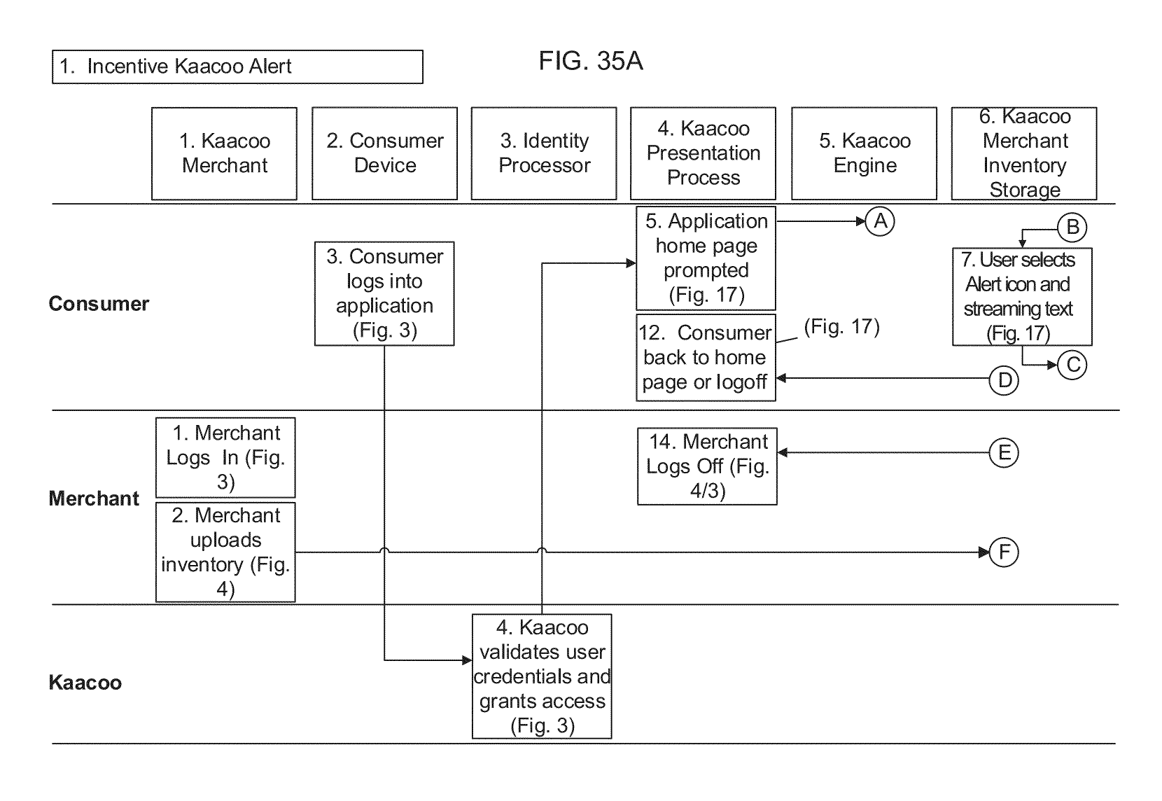

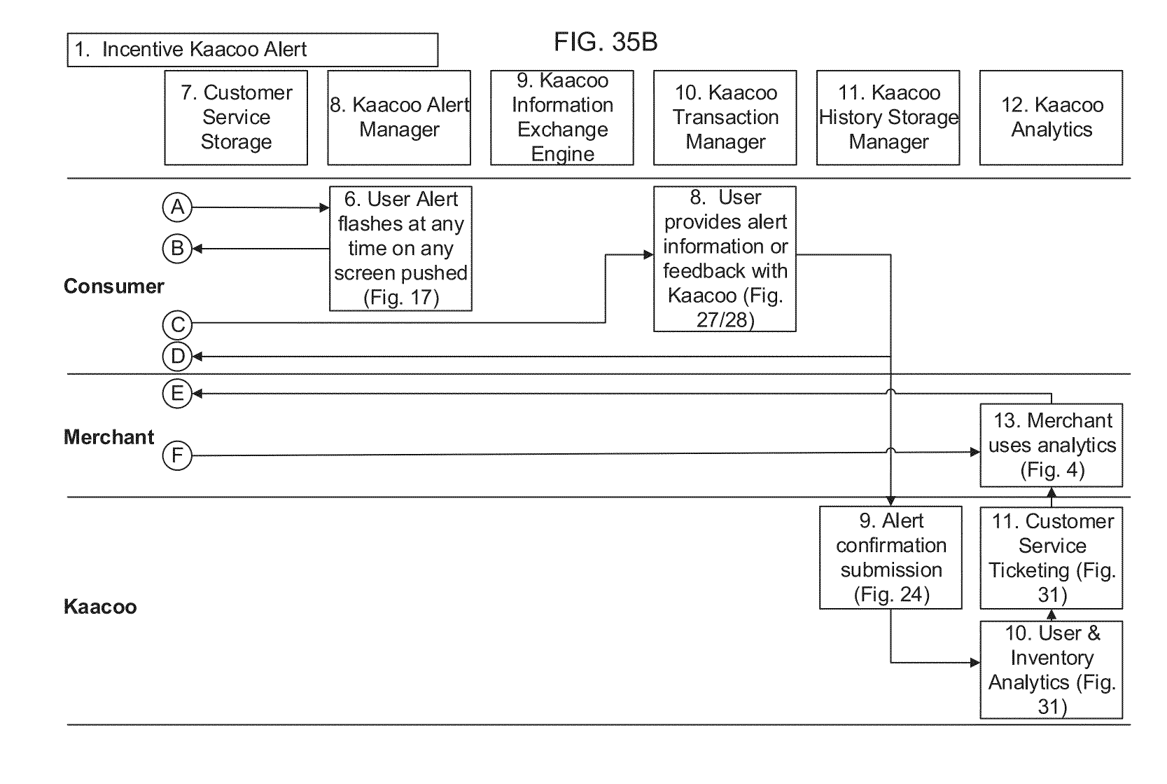

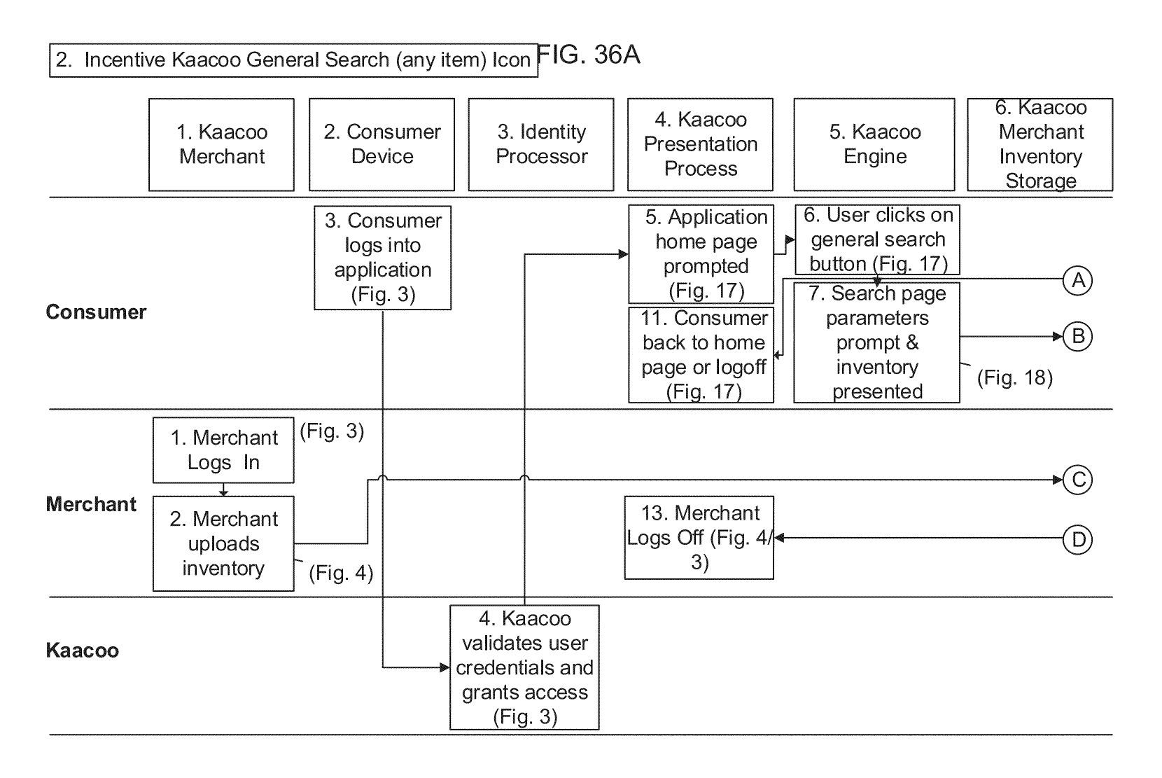

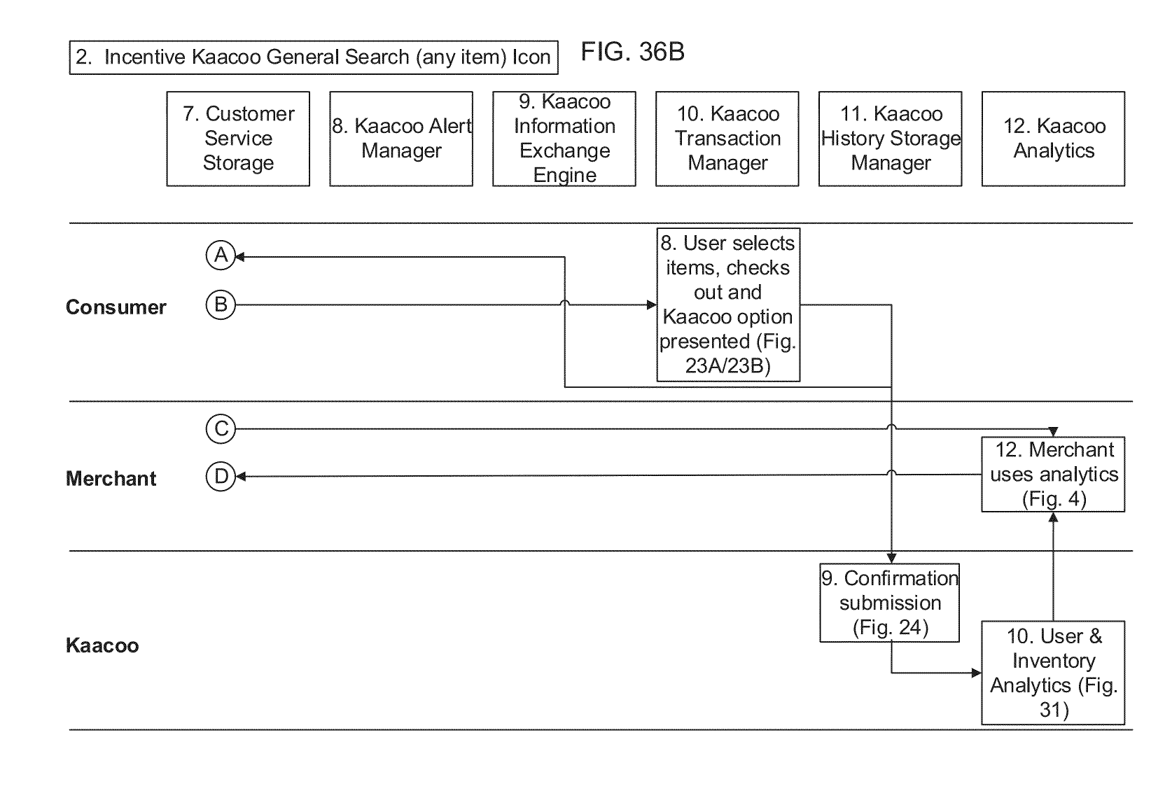

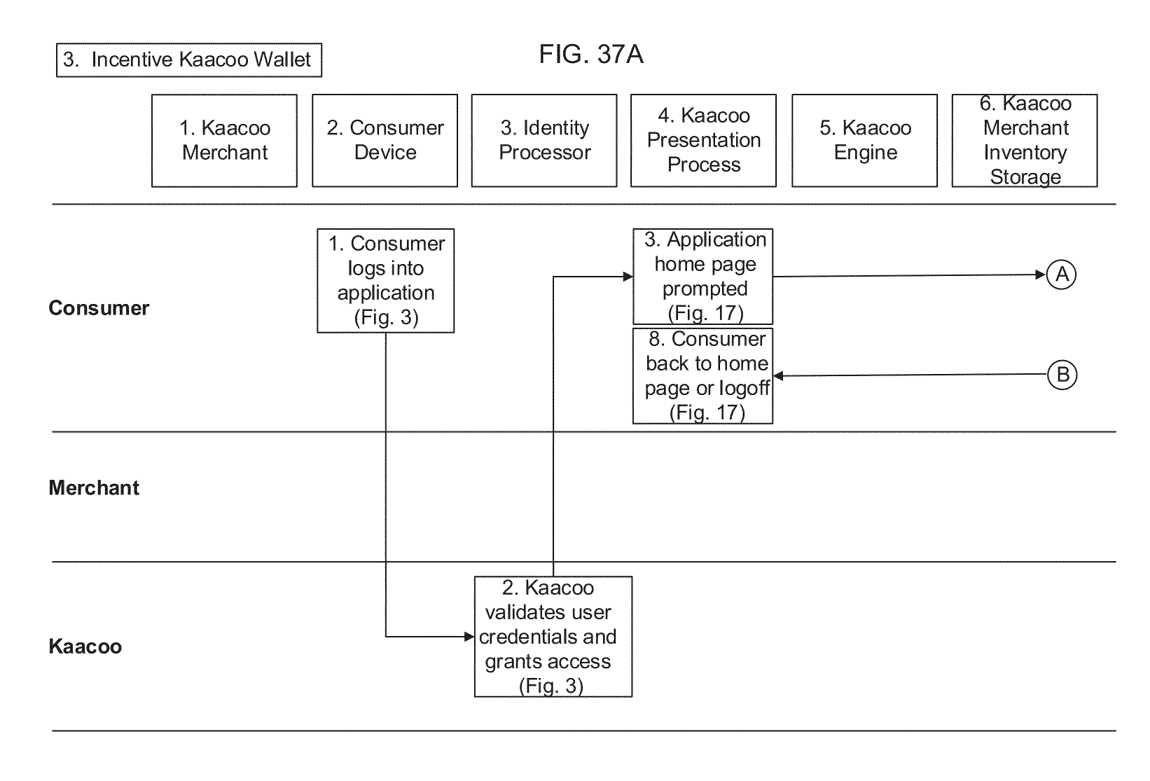

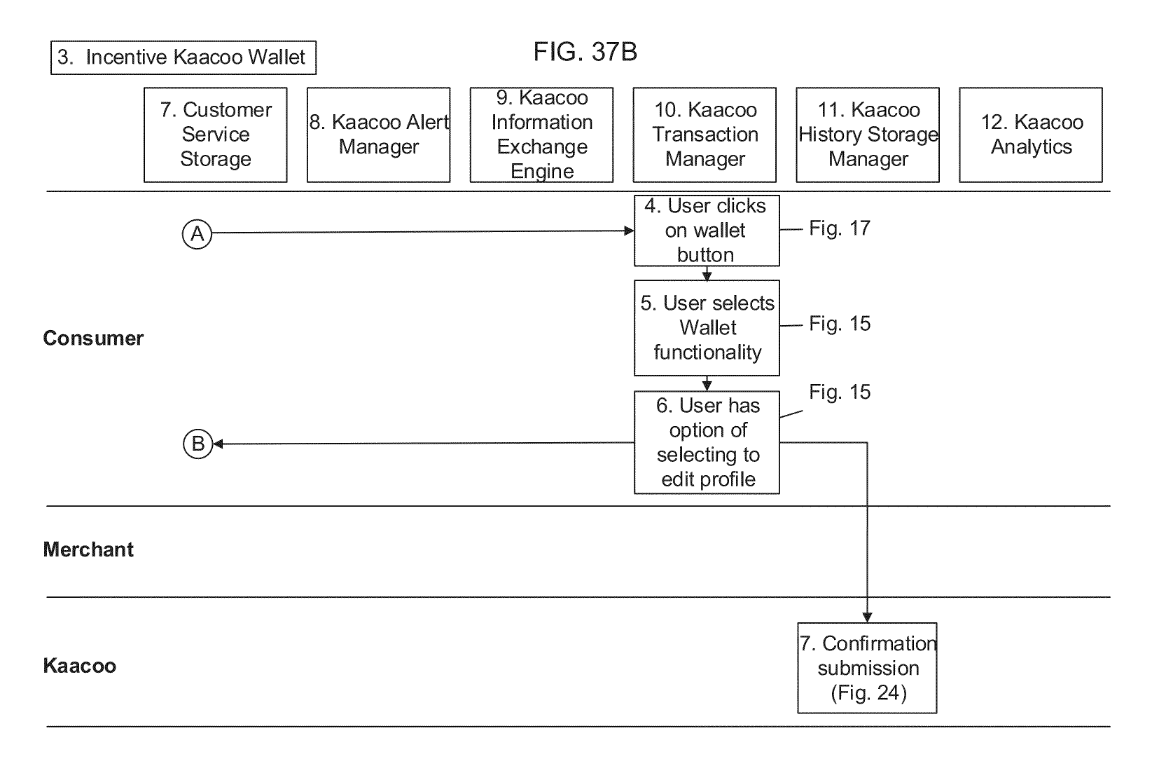

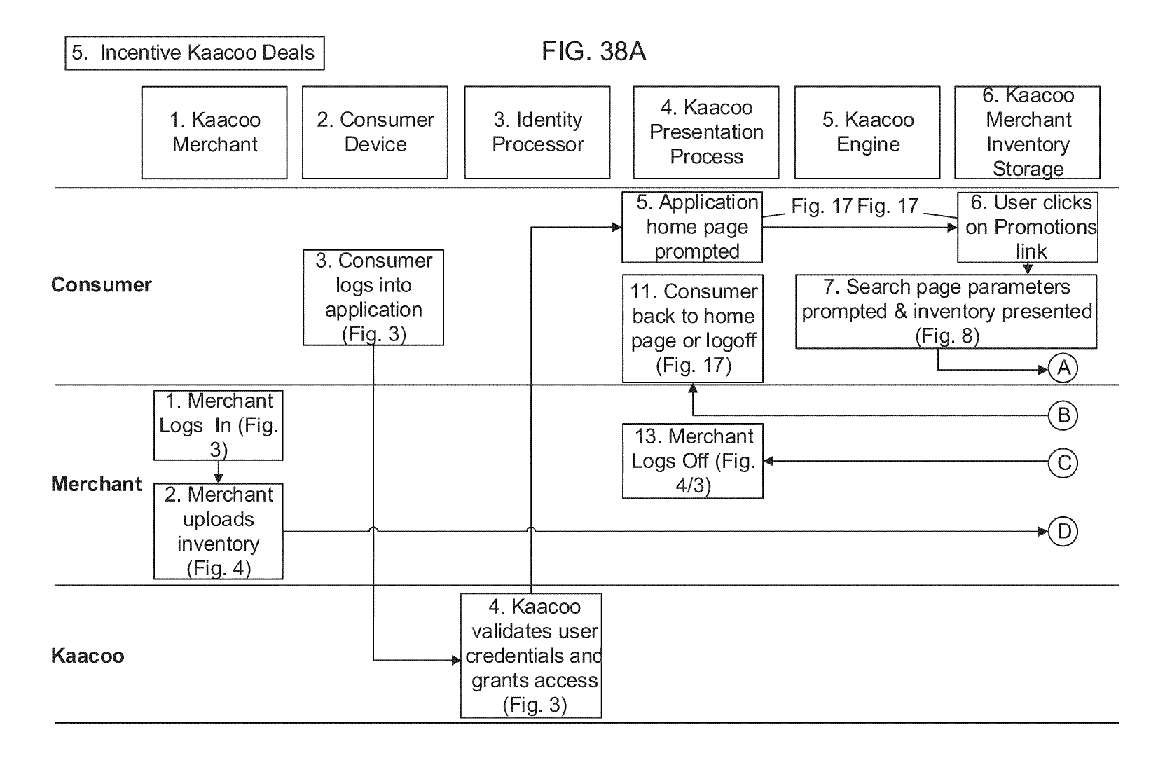

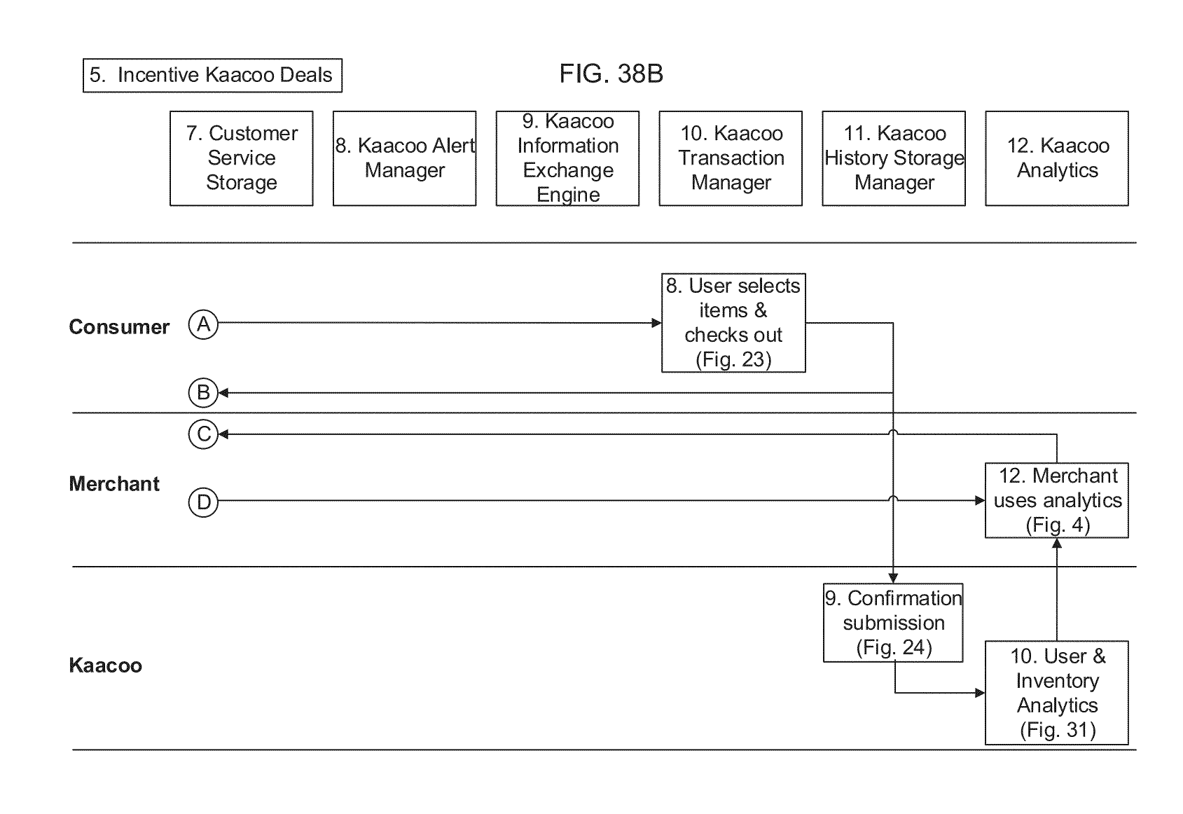

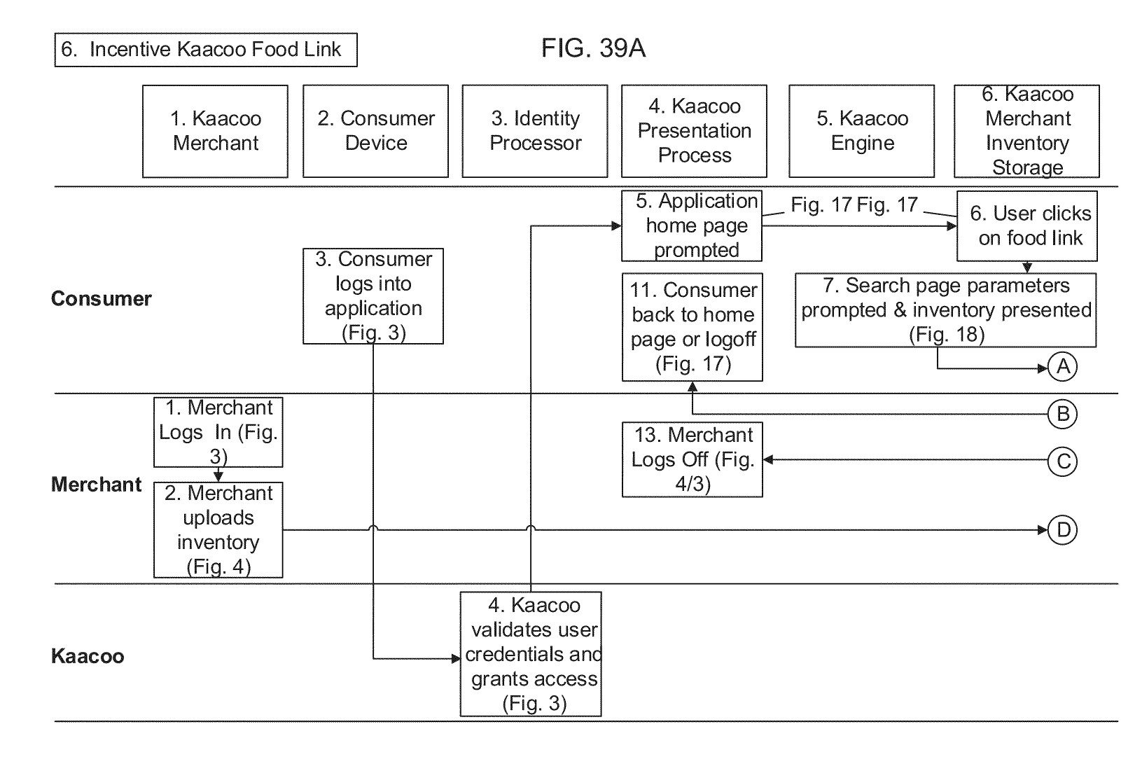

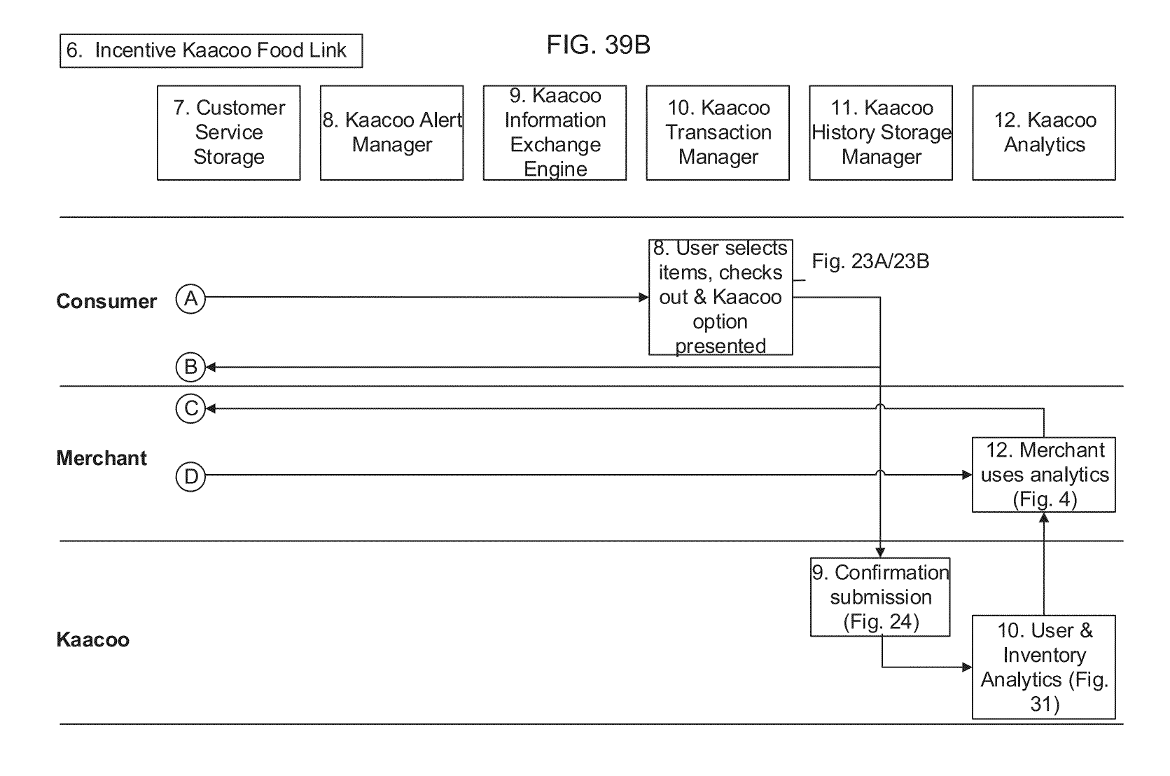

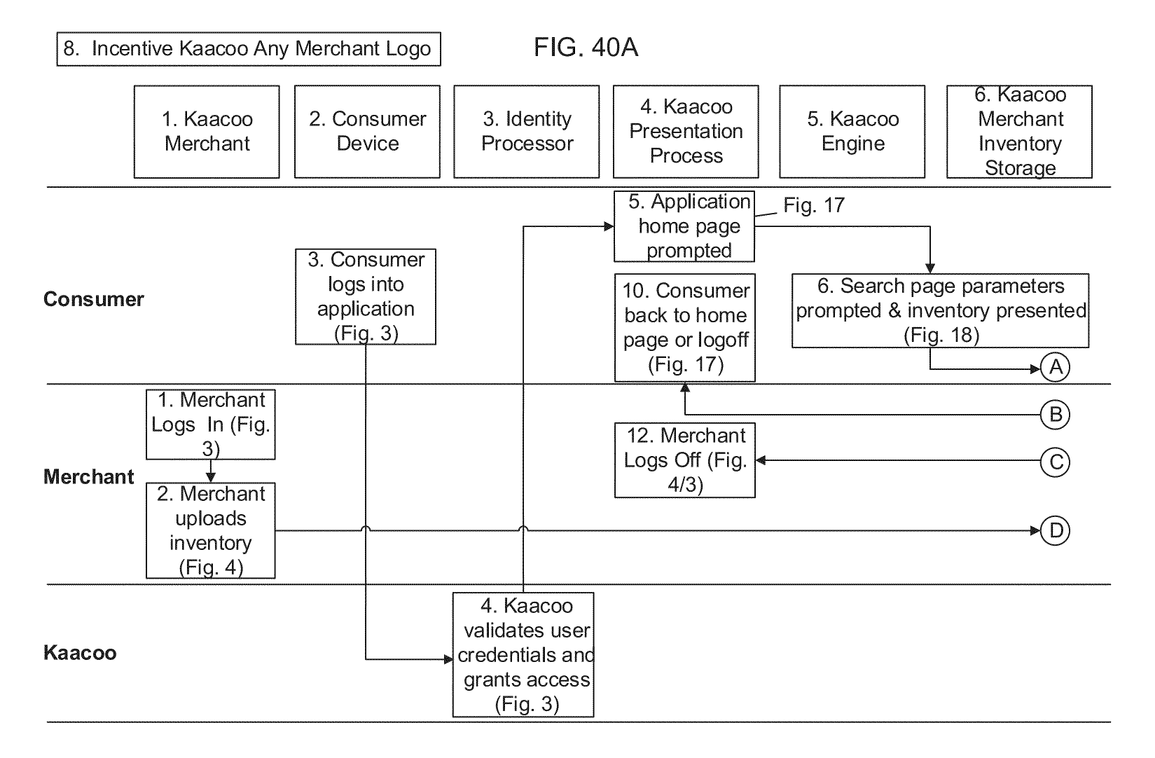

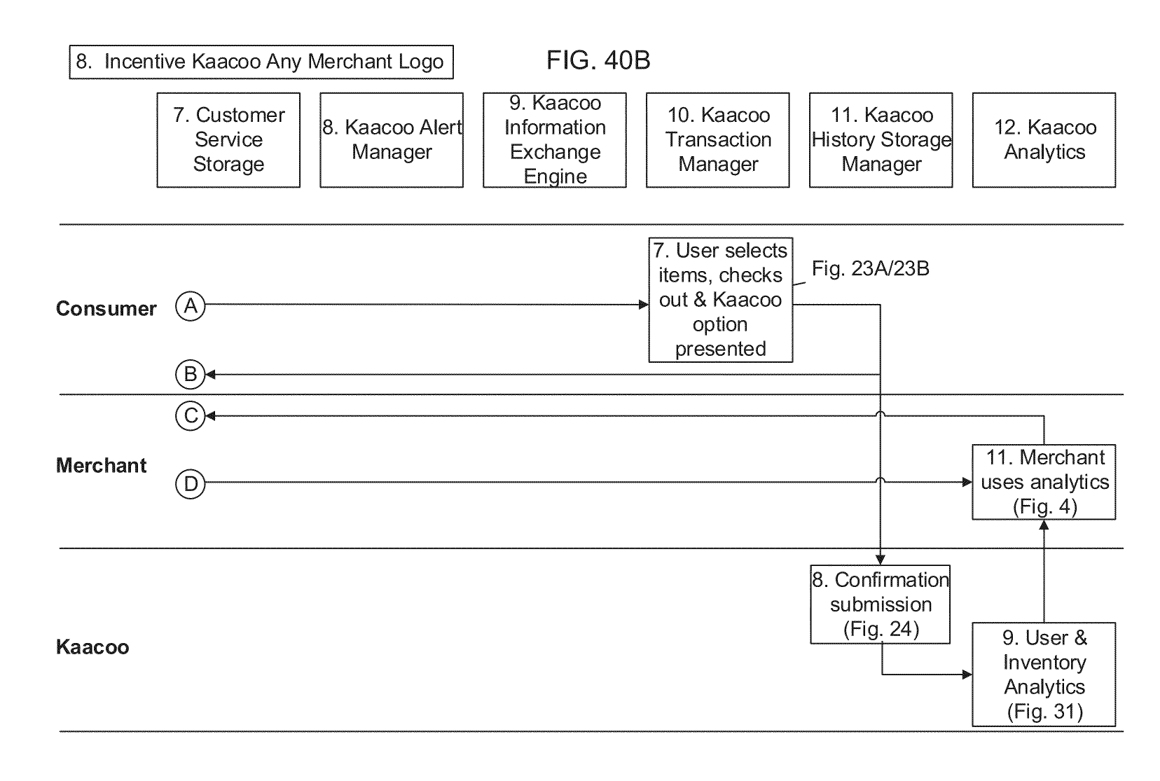

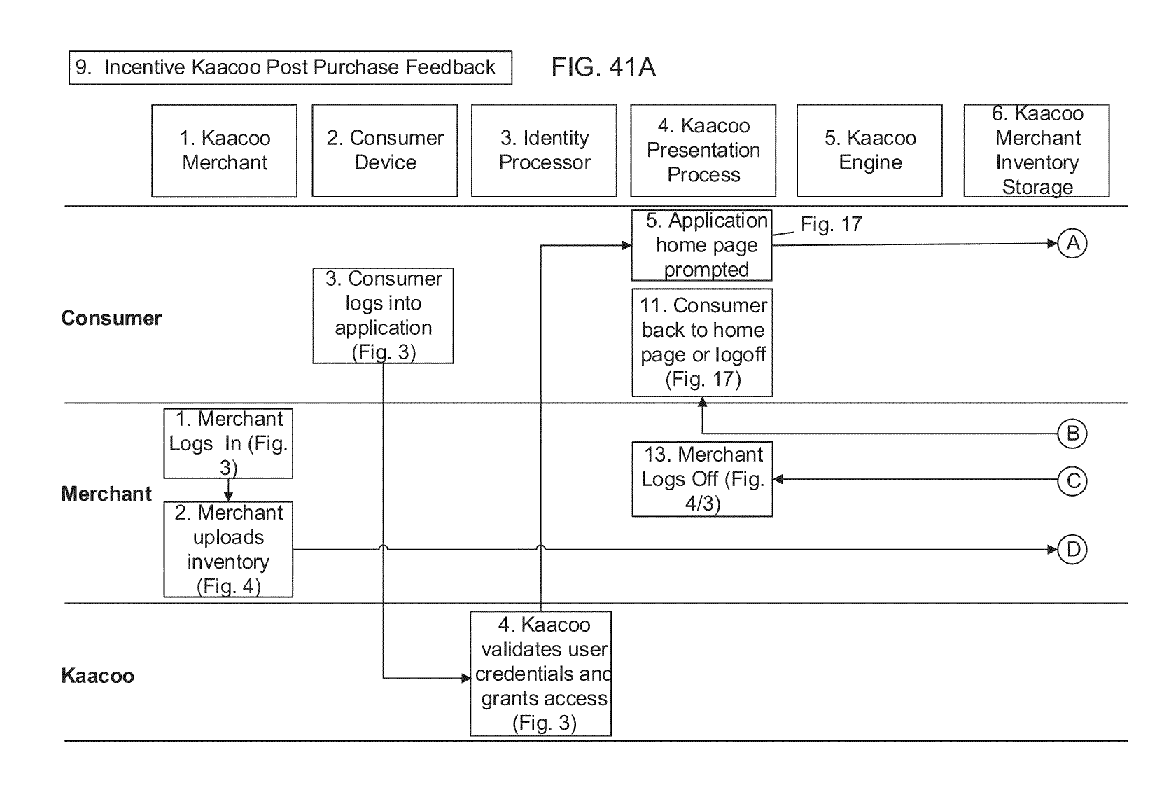

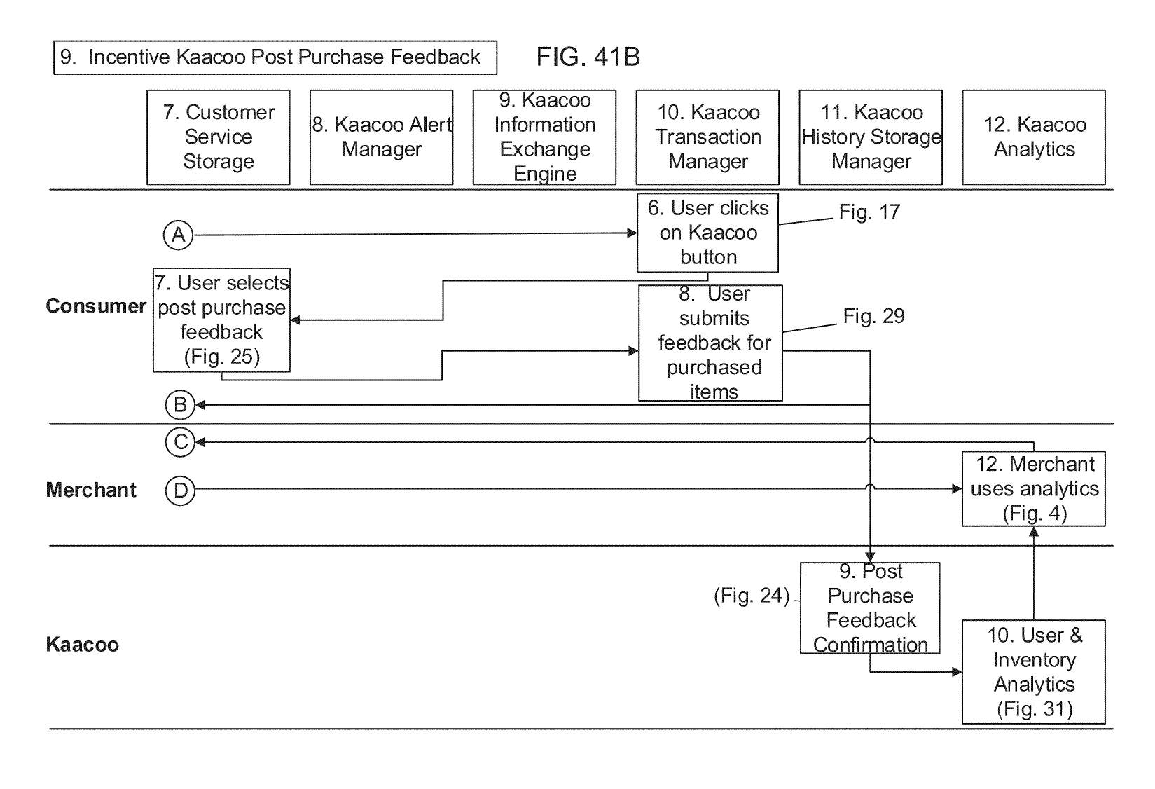

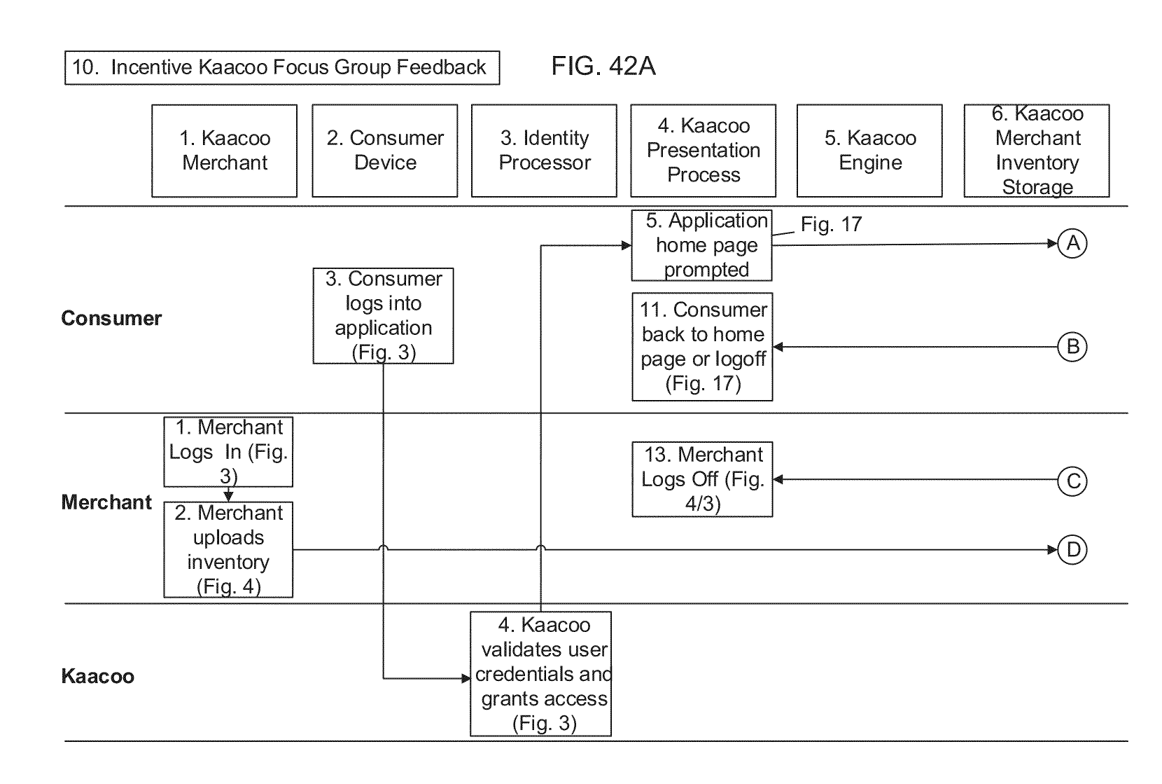

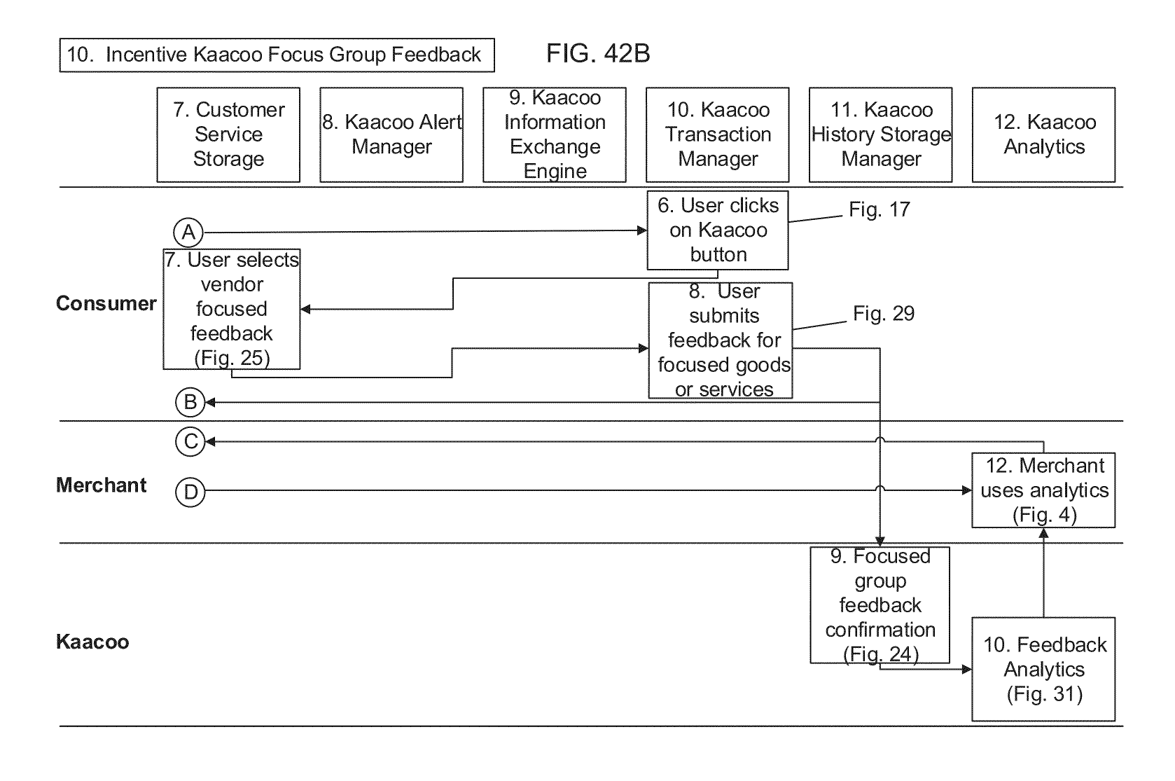

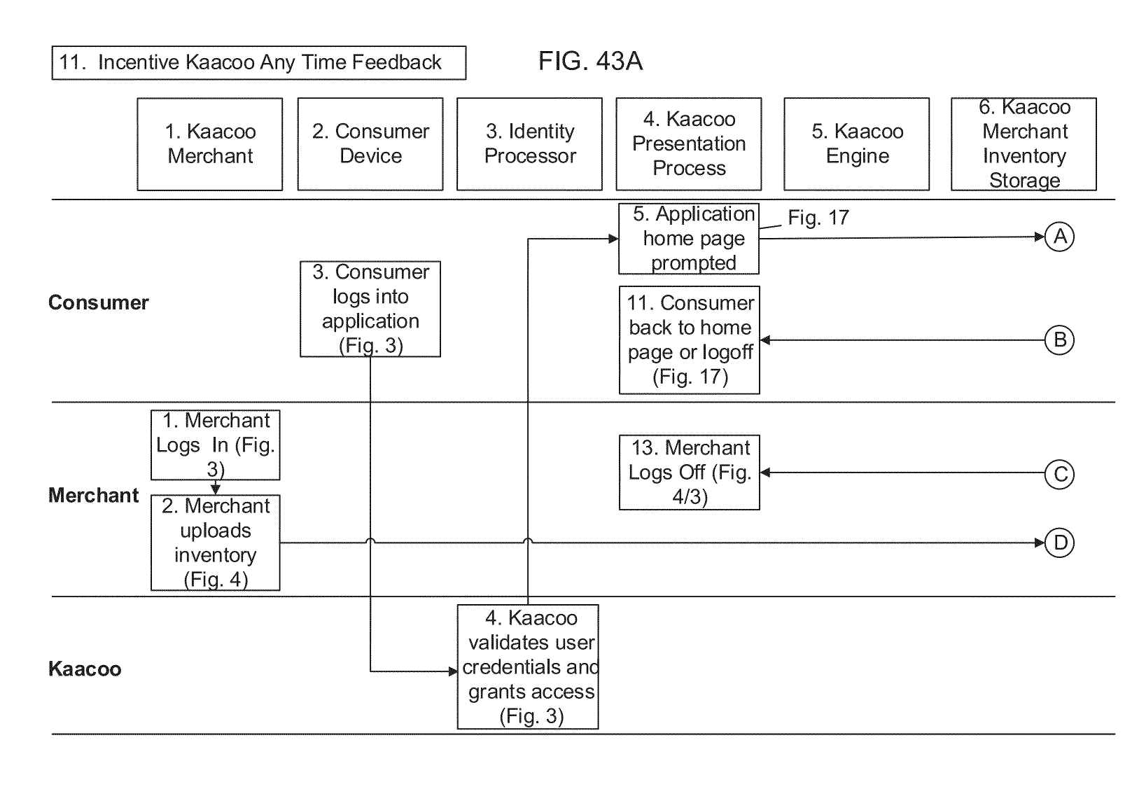

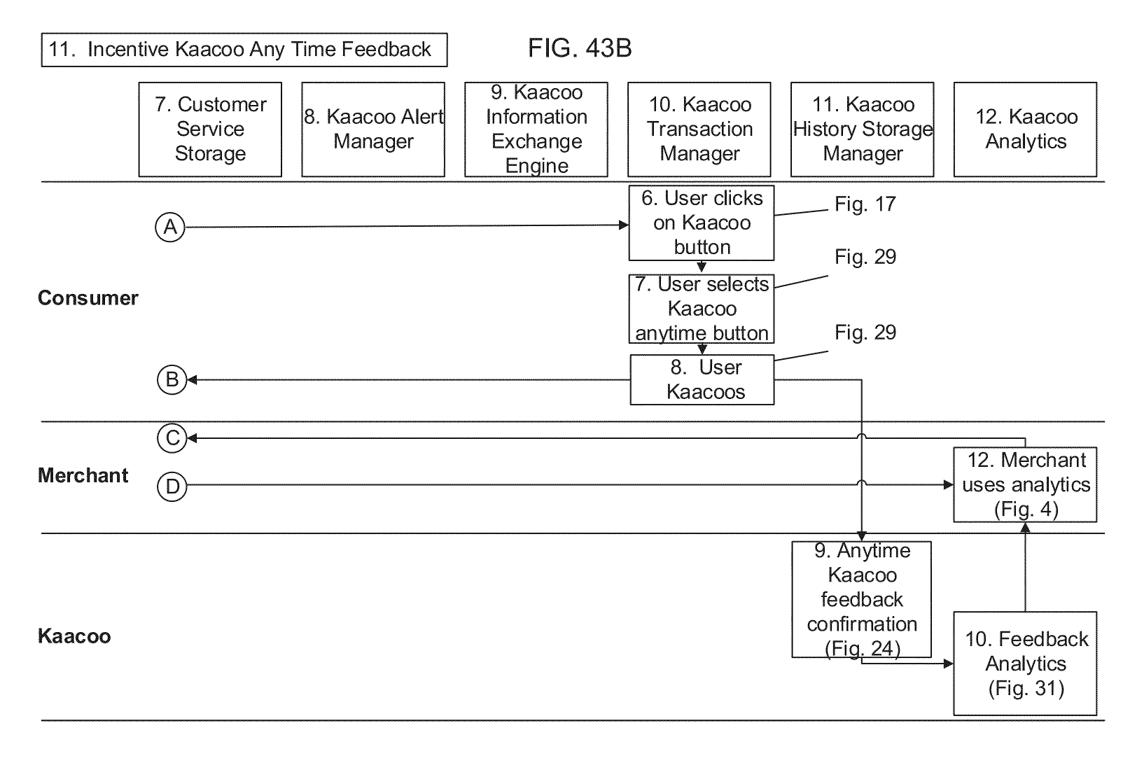

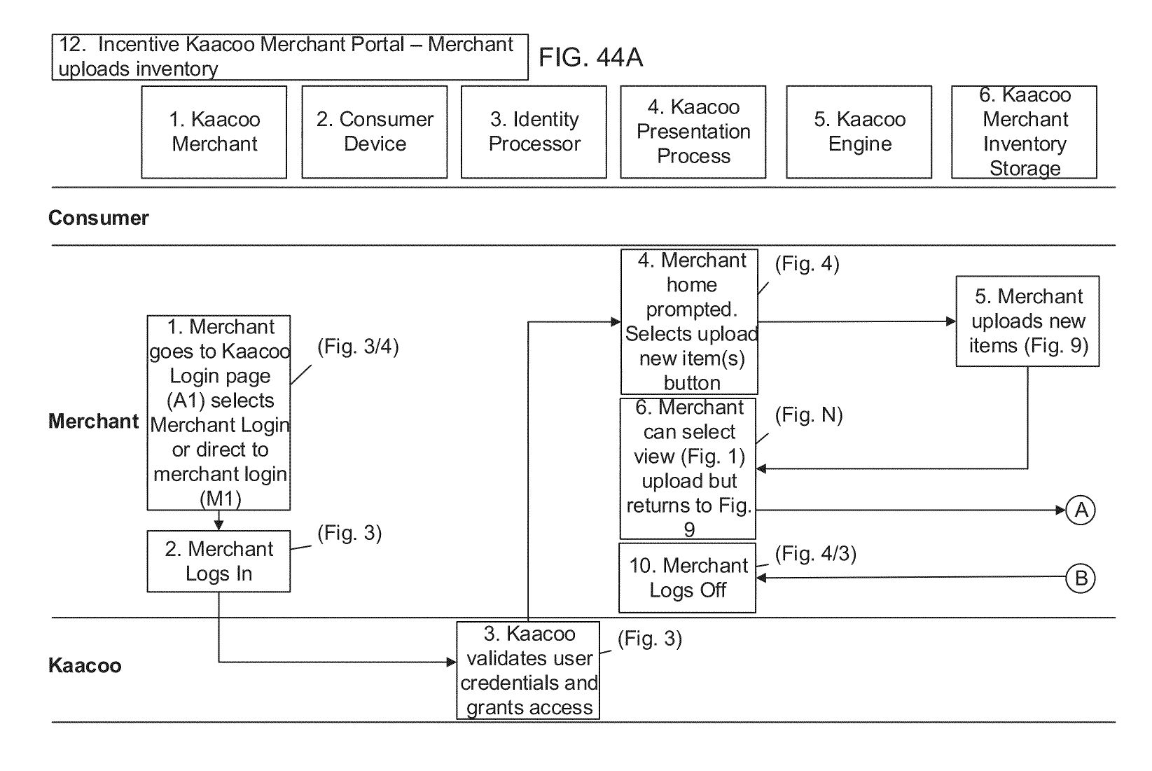

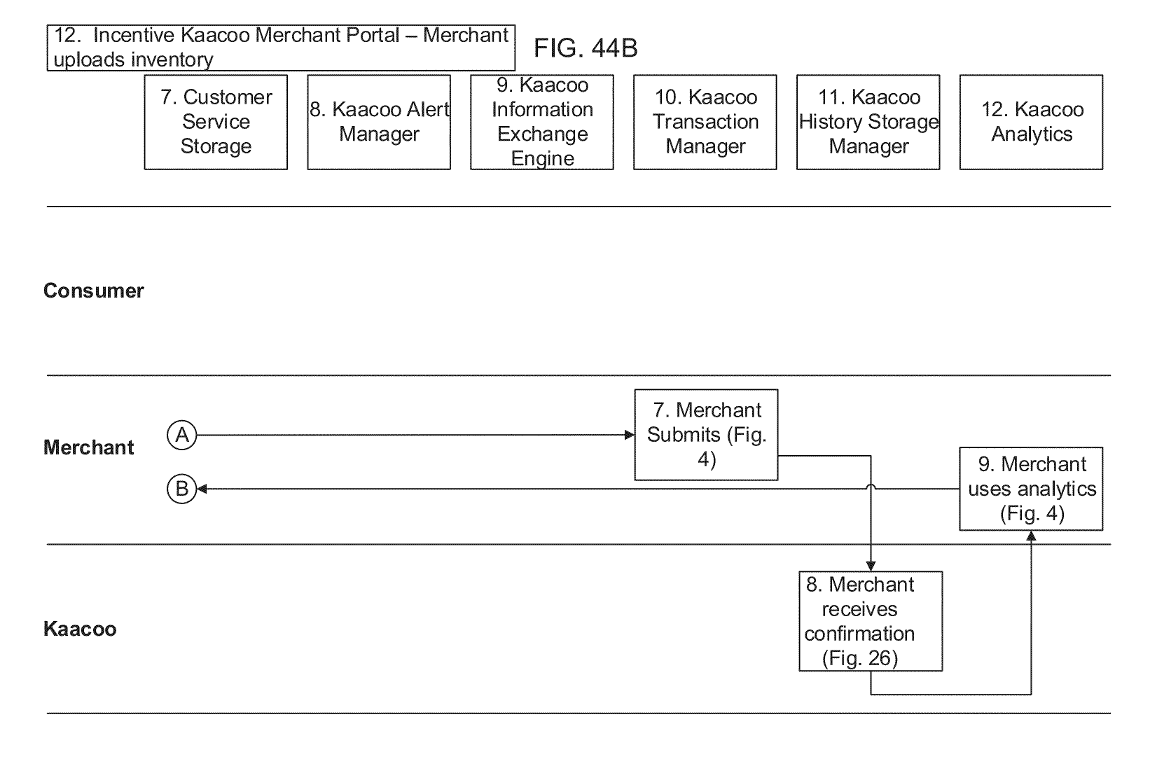

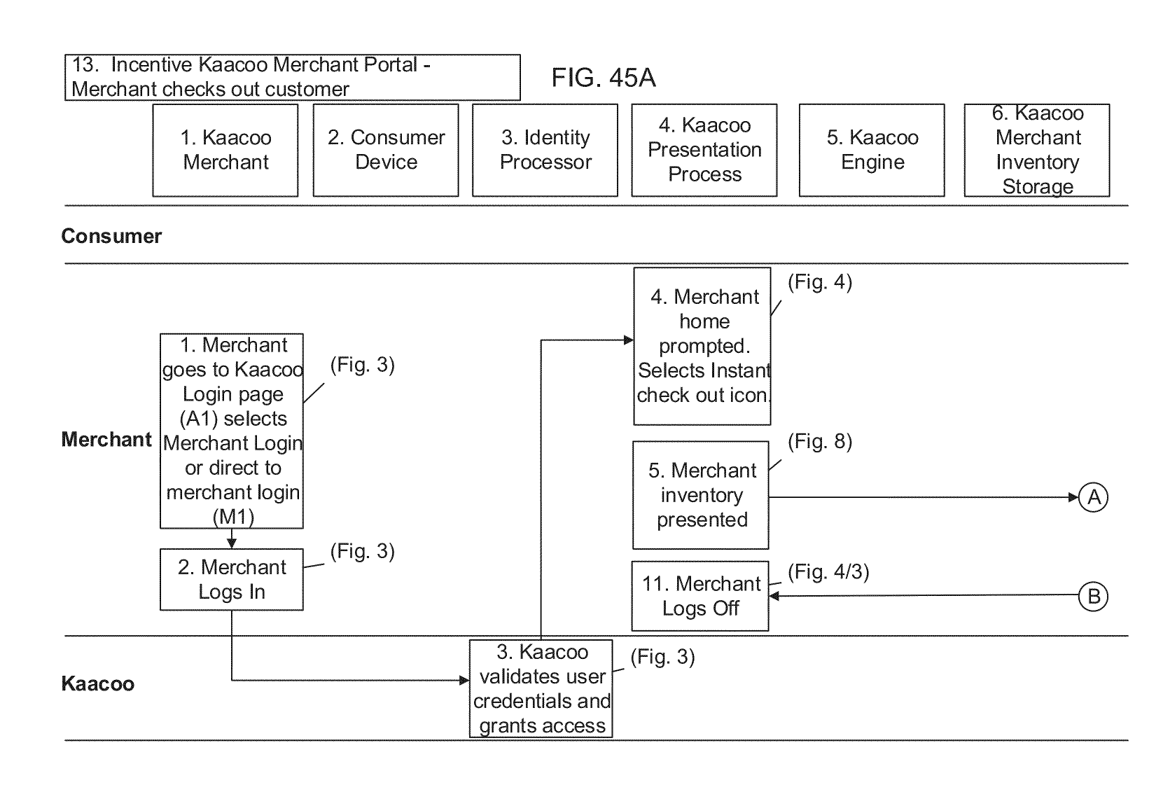

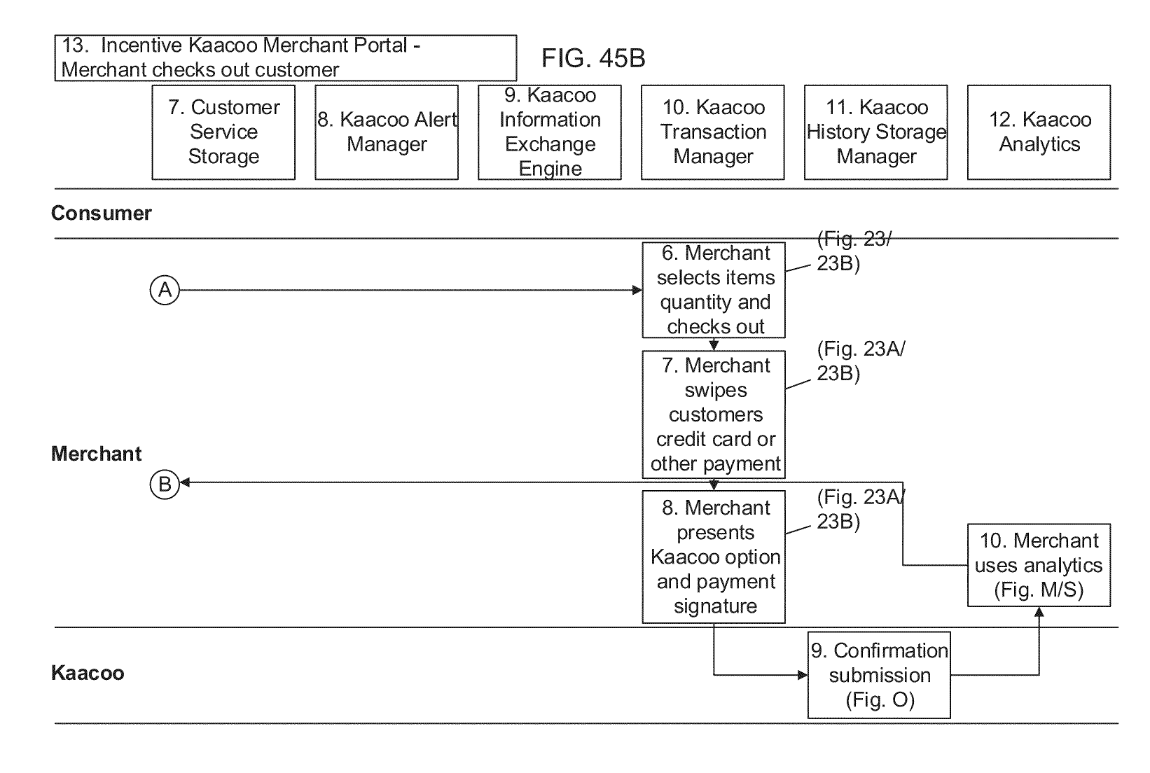

FIGS. 35A-35B illustrate a process for managing the incentive alert discussed above at least with respect to FIGS. 27-28. FIGS. 36A-36B illustrate a process for managing the incentive search discussed above at least with respect to FIG. 18. FIGS. 37A-37B illustrate a process for managing the incentive wallet discussed above at least with respect to FIGS. 15-16. FIGS. 38A-38B illustrate a process for managing the offers and deals discussed above at least with respect to FIGS. 14-25. FIGS. 39A-39B illustrate a process for managing an exemplary food item search discussed above at least with respect to FIG. 14-25. FIG. 40A-40B illustrate a process for managing the third-party search discussed above at least with respect to FIGS. 14-25. FIG. 41A-41B illustrate a process for managing the post-transaction feedback discussed above at least with respect to FIG. 25. FIGS. 42A-42B illustrate a process for managing the focus feedback discussed above at least with respect to FIG. 25. FIGS. 43A-43B illustrate a process for managing the anytime feedback discussed above at least with respect to FIG. 25. FIGS. 44A-44B illustrate a process for managing the incentive third-party upload discussed above at least with respect to FIGS. 9-13. FIGS. 45A-45B illustrate a process for managing an incentive third-party checkout.

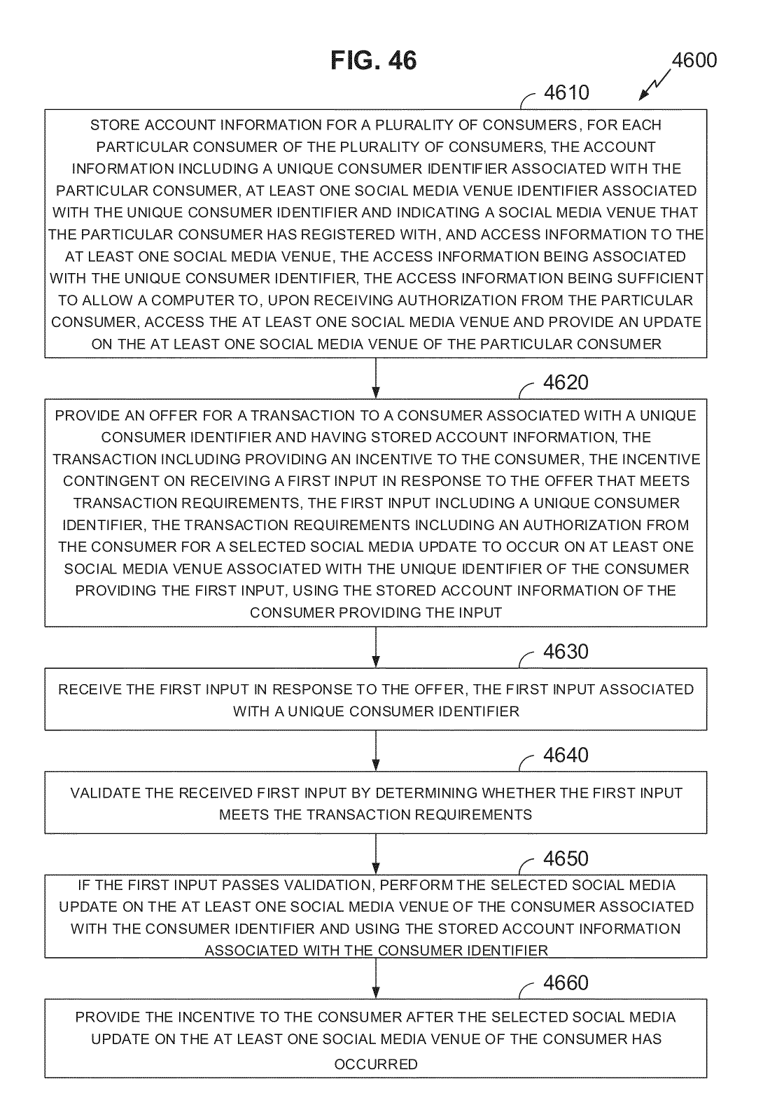

FIG. 46 shows a flowchart 4600 of a process 4600 that can be used to provide an offer for an incentive contingent on authorizing and performing an update of at least one social media venues of a consumer. The method can be implemented in whole or in part by the devices described herein, such as the devices 3204 and 3304 shown in FIGS. 32-33 of any of the devices 105-145 shown in FIG. 1. Although the illustrated method is described herein with reference to the e-commerce system 100 discussed above with respect to FIG. 1, and the interfaces described above with respect to FIGS. 3-30, a person having ordinary skill in the art will appreciate that the illustrated method can be implemented by another device described herein, or any other suitable device. Although the illustrated method is described herein with reference to a particular order, in various embodiments, blocks herein can be performed in a different order, or omitted, and additional blocks can be added.

At block 4610, the process stores account information for a plurality of consumers. For each particular consumer of the plurality of consumers, the account information includes a unique consumer identifier associated with the particular consumer, at least one social media venue identifier associated with the unique consumer identifier and indicating a social media venue that the particular consumer has registered with. The account information also includes access information that allows access to the at least one social media venue of a consumer. The access information is associated with the unique consumer identifier, and is sufficient to allow a computer to, upon receiving authorization from the particular consumer, access the at least one social media venue and provide an update on the at least one social media venue of the particular consumer.

At block 4620, the process 600 provides an offer for a transaction to a consumer associated with a unique consumer identifier and having stored account information, the transaction including providing an incentive to the consumer. The incentive is contingent on receiving a first input in response to the offer that meets transaction requirements. The first input includes a unique consumer identifier, the transaction requirements includes an authorization from the consumer for a selected social media update to occur on at least one social media venue associated with the unique identifier of the consumer providing the first input, using the stored account information of the consumer providing the input. As used herein, the term “first input” is used to indicate that is input as a response to an offer to satisfy transaction requirements related to the offer. The first input may include one or more inputs to the offer, and at the same time or nearly so by a consumer, or made over a period of time, all in response to the offer and provided by the consumer to meet the transaction requirements. For example, in one implementation, a consumer may provide a first input that agrees to the offer and in doing so meets the transaction requirements (e.g., authorizing a social media update). In another implementation, a consumer may provide a first input that includes agreeing to the offer and also provides an image, to meet transaction requirements for that offer. Accordingly, as described herein both an input agreeing to the offer and an input of an image (which may be used for the social media update) are the “first input.” In some implementations, a consumer may provide as a first input just an image (or other electronic data or information), and providing just the image is sufficient to meet authorization and image submission transaction requirements.

At block 4630, the process 600 receives a the first input in response to the offer, the first input associated with a unique consumer identifier. At block 4640, the process 600 validates (in whole or in part) the received first input by determining whether the first input meets the transaction requirements, and if the first input meets the transaction requirements it is considered to have passed validation. At block 4650, if the first input passes validation, the process 600 performs the selected social media update on the at least one social media venue of the consumer associated with the consumer identifier and using the stored account information associated with the consumer identifier. At block 4660, the process 600 provides the incentive to the consumer after the selected social media update on the at least one social media venue of the consumer has occurred.

In some embodiments, a device (or system) provides an offer for a transaction, the offer contingent upon a social media promotion requirements. For example, the mobile device 105 can display the offer 1704, 1707, 1708, 1709 and/or 1710 as discussed above with respect to FIG. 17. As another example, the analytics server 135 can provide information indicating the offer 1704, 1707, 1708, 1709 and/or 1710 to the mobile device 105.

In an embodiment, a device (or system) can provide a plurality of advertisements. The advertisements can be prioritized based on an account referral. For example, the mobile device 105 can display the third-party search interfaces 1704, 1708, 1709 and/or 1710, which can be prioritized as described above with respect to FIG. 17. In another embodiment, the analytics server 135 can transmit information indicative of the third-party search interfaces 704, 1708, 1709 and/or 1710 to the mobile device 105.

A device (or system) can receive an authorization for the transaction and the social media promotion requirements based on the transaction. For example, the mobile device 105 can receive the authorization for the transaction and the social media promotion requirements when a user select the transaction interface 2315 or 2316 (FIG. 23B), as discussed above with respect to FIG. 17. As another example, the analytics service 135 can receive the authorization for the transaction and the social media promotion requirements from the mobile device 105.

Then, a device (or system) performs the social media promotion requirements based on the transaction. For example, the mobile device 105 can transmit the social media promotion requirements, discussed above with respect to FIG. 19, based on the authorization received when the user selects the transaction interface 2315 or 2316 (FIG. 23B). As another example, the social media server 125 can transmit the social media promotion requirements 2303 (FIG. 23) (the transaction requirements)

The device (or system) may process the mobile payment after verifying the social media promotion requirements based on the transaction. For example, the mobile device 105 can transmit a payment authorization to the payment processing server 130 after verifying that the social media promotion requirements 2302 (FIG. 23) is posted, via the social media server 125. As another example, the payment processing server 130 can receive verification of the social media promotion requirements 2303 (FIG. 23) from the social media server 125, and can process the mobile payment.

In an embodiment, the device (or system) records a plurality of payment methods associated with an account. For example, the mobile device 105 can receive various forms of payment 1600, as described above with respect to FIG. 16. The device can select one payment method. For example, the mobile device 105 can select a payment method based on the payment method drop-down box in the order option interface 2200 (FIG. 22). Processing the mobile payment can include applying the one payment method to the transaction.

In an embodiment, after processing the transaction, the device (or system) can solicit soliciting feedback regarding the transaction. The device (or system) can solicit the feedback in conjunction with an incentive for completing the feedback and authorization for a social media promotion requirements based on the feedback. For example, the mobile device 105 can display the offer 2501 in the post-transaction feedback interface 1709, as discussed above. As another example, the analytics server 135 can transmit information indicative of the offer 2501 to the mobile device 105.

The device 3204 can further receive the feedback and authorization. For example, the mobile device 105 can receive selection of the submission interface 2504, as discussed above. As another example, the analytics server can receive an indication of feedback and authorization from the mobile device 105.

The device (or system) can further perform the social media promotion requirements based on the feedback prior to delivering the incentive. For example, the mobile device 105 can transmit the feedback 2503 to the social media server 125. As another example, the social media server 125 can receive the feedback 2503 and can perform the social media promotion requirements.

The device 3204 can further deliver the incentive after verifying the social media promotion requirements based on the feedback. For example, the mobile device 105 can verify the social media promotion requirements via the social media server 125 and can display the confirmation indication 2400, as discussed above with respect to FIG. 24. As another example, the analytics server 135 can verify the social media promotion requirements via the social media server 125 can transmit information indicative of the incentive to the mobile device 105.

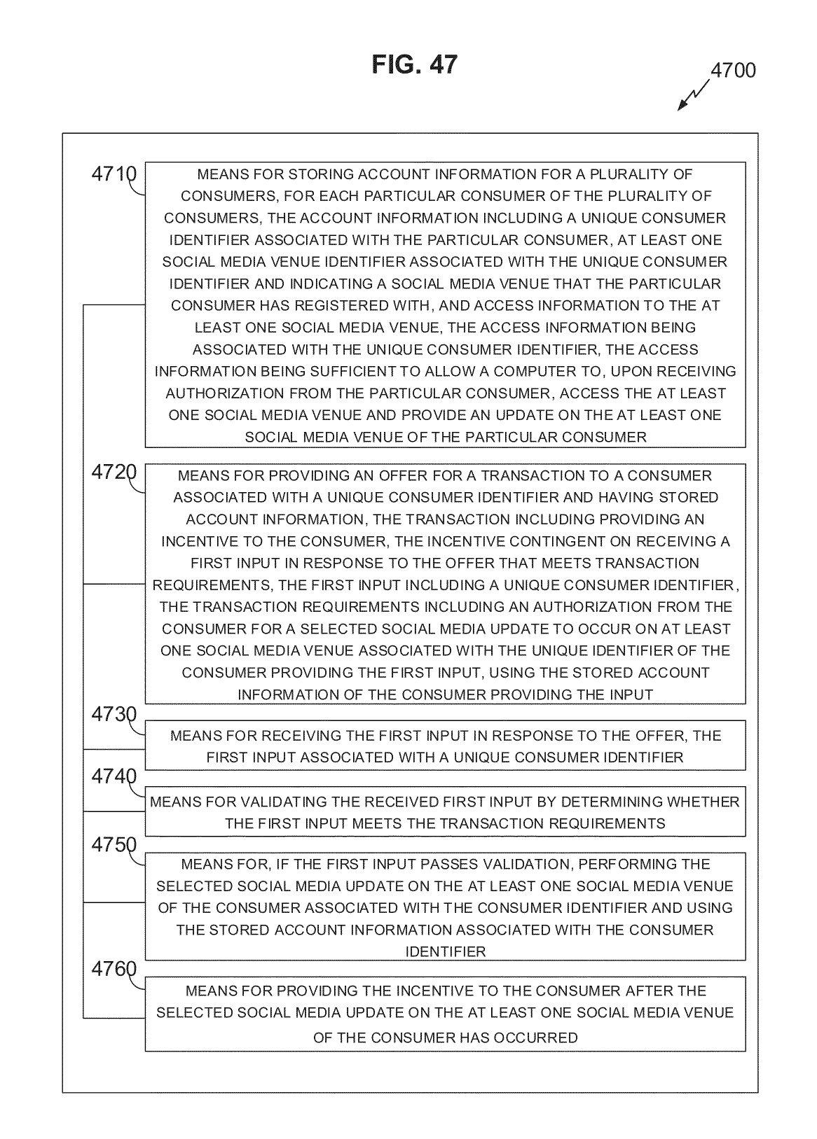

FIG. 47 is a functional block diagram of system 4700 that can be employed within the e-commerce system 100 of FIG. 1. The device 4700 comprises means 4710 for storing account information. The account information is for a plurality of consumers, for each particular consumer of the plurality of consumers. The account information may include a unique consumer identifier associated with the particular consumer, at least one social media venue identifier associated with the unique consumer identifier and indicating a social media venue that the particular consumer has registered with, and access information to the at least one social media venue, the access information being associated with the unique consumer identifier, the access information being sufficient to allow a computer to, upon receiving authorization from the particular consumer, access the at least one social media venue and provide an update on the at least one social media venue of the particular consumer;

The system 4700 may also include means 4720 for providing an offer for a transaction to a consumer associated with a unique consumer identifier and having stored account information. The transaction may include providing an incentive to the consumer, the incentive contingent on receiving a first input in response to the offer that meets transaction requirements, the first input including a unique consumer identifier, the transaction requirements including an authorization from the consumer for a selected social media update to occur on at least one social media venue associated with the unique identifier of the consumer providing the first input, using the stored account information of the consumer providing the first input. The means 4720 for providing an offer for a transaction, the offer contingent upon a social media promotion requirements can correspond to one or more of the transmitter 3210, the transceiver 3214, the processor 3204, the memory 3206, and the user interface 3222, discussed above with respect to FIG. 32. The means 4705 for providing an offer for a transaction, the offer contingent upon a social media promotion requirements can correspond to one or more of the transmitter 3310, the transceiver 3314, the processor 3304, the memory 3306, and the user interface 3322, discussed above with respect to FIG. 33.

The system 4700 may also include means 4730 for receiving the first input in response to the offer, the first input associated with a unique consumer identifier. The system 4700 may also include means 4740 for validating the received first input by determining whether the first input meets the transaction requirements. The system 4700 may also include means 4750 for if the first input passes validation, performing the selected social media update on the at least one social media venue of the consumer associated with the consumer identifier and using the stored account information associated with the consumer identifier. The system 4700 may also include means 4760 for providing the incentive to the consumer after the selected social media update on the at least one social media venue of the consumer has occurred. The means for receiving an authorization for the transaction and the social media promotion requirements based on the transaction can correspond to one or more of the receiver 3212, the transceiver 3214, the processor 3204, the memory 3206, and the user interface 3222, discussed above with respect to FIG. 32. The means for receiving an authorization for the transaction and the social media promotion requirements based on the transaction can correspond to one or more of the receiver 3312, the transceiver 3314, the processor 3304, the memory 3306, and the user interface 3322, discussed above with respect to FIG. 33. The means for performing the social media promotion requirements based on the transaction can correspond to one or more of the transmitter 3210, the transceiver 3214, the processor 3204, the memory 3206, and the user interface 3222, discussed above with respect to FIG. 32. The means for performing the social media promotion requirements based on the transaction can correspond to one or more of the transmitter 3310, the transceiver 3314, the processor 3304, the memory 3306, and the user interface 3322, discussed above with respect to FIG. 33.

Various references herein can include the word “Kaacoo.” As used herein, “Kaacoo” can include one or more portions of the e-commerce system 100 of FIG. 1, an incentive program, the incentive application, and/or any other aspect described herein. For example, a “Kaacoo analytics” can refer to incentive analytics.

It should be understood that any reference to an element herein using a designation such as “first,” “second,” and so forth does not generally limit the quantity or order of those elements. Rather, these designations can be used herein as a convenient wireless device of distinguishing between two or more elements or instances of an element. Thus, a reference to first and second elements does not mean that only two elements can be employed there or that the first element can precede the second element in some manner. Also, unless stated otherwise a set of elements can include one or more elements.

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

A person/one having ordinary skill in the art would further appreciate that any of the various illustrative logical blocks, modules, processors, means, circuits, and algorithm steps described in connection with the aspects disclosed herein can be implemented as electronic hardware (e.g., a digital implementation, an analog implementation, or a combination of the two, which can be designed using source coding or some other technique), various forms of program or design code incorporating instructions (which can be referred to herein, for convenience, as “software” or a “software module), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present disclosure.

The various illustrative logical blocks, modules, and circuits described in connection with the aspects disclosed herein and in connection with FIGS. 1-9 can be implemented within or performed by an integrated circuit (IC), an access terminal, or an access point. The IC can include a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and can execute codes or instructions that reside within the IC, outside of the IC, or both. The logical blocks, modules, and circuits can include antennas and/or transceivers to communicate with various components within the network or within the device. A general purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. The functionality of the modules can be implemented in some other manner as taught herein. The functionality described herein (e.g., with regard to one or more of the accompanying figures) can correspond in some aspects to similarly designated “means for” functionality in the appended claims.

If implemented in software, the functions can be stored on or transmitted over as one or more instructions or code on a computer-readable medium. The steps of a method or algorithm disclosed herein can be implemented in a processor-executable software module which can reside on a computer-readable medium. Computer-readable media includes both computer storage media and communication media including any medium that can be enabled to transfer a computer program from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm can reside as one or any combination or set of codes and instructions on a machine readable medium and computer-readable medium, which can be incorporated into a computer program product.

It is understood that any specific order or hierarchy of steps in any disclosed process is an example of a sample approach. Based upon design preferences, it is understood that the specific order or hierarchy of steps in the processes can be rearranged while remaining within the scope of the present disclosure. The accompanying method claims present elements of the various steps in a sample order, and are not meant to be limited to the specific order or hierarchy presented.

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A system for incentivizing a transaction, comprising:
a computer server system comprising
electronic storage configured to store account information for a plurality of consumers, the account information including, for each particular consumer of the plurality of consumers, a unique consumer identifier associated with the particular consumer, at least one social media venue identifier associated with the unique consumer identifier and indicating a social media venue that the particular consumer has registered with, and access information to the at least one social media venue, the access information being associated with the unique consumer identifier, the access information being sufficient to allow a computer to, upon receiving authorization from the particular consumer, access the at least one social media venue and provide an update on the at least one social media venue of the particular consumer;
at least one processor configured with instructions to operate the processor to
provide an offer for a transaction to a consumer associated with a unique consumer identifier and having stored account information, the transaction including providing an incentive to the consumer, the incentive contingent on receiving a first input in response to the offer that meets transaction requirements, the first input including a unique consumer identifier, the transaction requirements including an authorization from the consumer for a selected social media update to occur on at least one social media venue associated with the unique identifier of the consumer providing the first input, using the stored account information of the consumer providing the input;
receive the first input in response to the offer, the first input associated with a unique consumer identifier;
validate the received first input by determining whether the first input meets the transaction requirements;
if the first input passes validation, perform the selected social media update on the at least one social media venue of the consumer associated with the consumer identifier and using the stored account information associated with the consumer identifier; and
provide the incentive to the consumer after the selected social media update on the at least one social media venue of the consumer has occurred.

2. The system of claim 1, wherein said perform the selected social media update comprises providing at least a portion of the first input received in response to the offer and providing stored access information associated with the consumer identifier to at least one computer configured to perform the selected social media update on the at least one social media venue using the access information and at least a portion of the first input.

3. The system of claim 2, further comprising a transaction component residing on a portable computing device, wherein the transaction component is configured to be associated with the unique consumer identifier, and further configured to
receive the offer;
display indicia of the offer on a display screen of the portable computing device;
receive a first input in response to the offer at an electronic interface of the portable computing device;
send the first input in a wireless transmission from the portable computing device; and
display, on the display screen of the portable computing device, indicia indicating receipt of the incentive.

4. The system of claim 1, wherein the incentive comprises a coupon, a future coupon, a free item, entry into an event, sign-up for an event, or joining a group.

5. The system of claim 1, wherein the incentive comprises a financial incentive, a non-financial incentive, or both a financial incentive and a non-financial incentive.

6. The system of claim 1, wherein the offer is a monetary offer or a non-monetary offer.

7. The system of claim 3, wherein said electronic storage comprises a database in data communication with the at least one processor, and wherein the portable computing device comprises a wireless client device adapted to communicate with the computer server system.

8. The system of claim 3, wherein the transaction component is further configured to validate the first input on the portable computing device.

9. The system of claim 3, wherein the first input comprises at least one of an image, a video, or an electronic data file.

10. The system of claim 3, wherein the portable computing device comprises a laptop computer, a tablet computer, a smart phone, or glasses or other wearable computer device.

11. The system of claim 1, wherein the incentive comprises a discount, coupon, gift card, membership, product, good or service.

12. The system of claim 1, wherein the at least one social media venue includes a SMS, an email, Facebook, Twitter, Instagram, Yelp, or Foursquare.

13. The system of claim 1, wherein the selected social media update includes providing an update to at least one social media venue having a social media identifier associated with the unique consumer identifier, and wherein the update includes one or images.

14. The system of claim 1, wherein the offer comprises an offer to purchase an item from a third party, wherein the offer for a transaction is provided by the computer server system, and wherein and the transaction requirements include receiving authorization for the platform provider to process a payment for the item with the third party on behalf of the consumer.

15. The system of claim 14, wherein the at least one processor is further configured to receive inventory information from a third party via a communication network, the inventory information having at least one indicia of an item to include in the offer and that will be provided to the consumer if the transaction requirements are met.

16. The system of claim 15, and wherein the account information further includes, for each particular consumer, payment information associated with the unique consumer identifier, the payment information having at least one payment source and being sufficient to make payments to a third party on behalf of the consumer, and wherein the at least one processor is further configured to
receive at the computer server system, via a network and communicated from a computing device, an authorization to pay the third party for the item, the authorization being associated with a unique consumer identifier, and wherein the first input comprises the authorization;
retrieve at the computer server system, from the storage component, payment information that is associated with the unique consumer identifier, after receiving the authorization to pay the third party; and
provide payment information from the from the computer server system to the third party to transact a payment of the item for the consumer associated with the unique consumer identifier.

17. The system of claim 15, wherein the at least one processor is further configured to receive, from the third party via a network, an electronic communication that includes data representative of a displayable offer graphic for presenting on a display screen of a computing device for visually conveying information about the offer for the item.

18. The system of claim 17, wherein said provide the offer comprises providing, via a communication network, data representative of the displayable offer graphic to a computing device.

19. The system of claim 1, wherein the at least one processor is further configured to
receive a second input having the same consumer identifier as the first input, the second input including feedback related to the transaction;
validate the second input based on second transaction requirements;
if the second input passes validation, perform a second selected social media update on the at least one social media venue of the consumer associated with the consumer identifier; and
provide a second incentive to consumer after the second selected social media update has occurred.

20. A method, comprising:
storing account information for a plurality of consumers, for each particular consumer of the plurality of consumers, the account information including a unique consumer identifier associated with the particular consumer, at least one social media venue identifier associated with the unique consumer identifier and indicating a social media venue that the particular consumer has registered with, and access information to the at least one social media venue, the access information being associated with the unique consumer identifier, the access information being sufficient to allow a computer to, upon receiving authorization from the particular consumer, access the at least one social media venue and provide an update on the at least one social media venue of the particular consumer;
providing an offer for a transaction to a consumer associated with a unique consumer identifier and having stored account information, the transaction including providing an incentive to the consumer, the incentive contingent on receiving a first input in response to the offer that meets transaction requirements, the first input including a unique consumer identifier, the transaction requirements including an authorization from the consumer for a selected social media update to occur on at least one social media venue associated with the unique identifier of the consumer providing the first input, using the stored account information of the consumer providing the first input;
receiving the first input in response to the offer, the first input associated with a unique consumer identifier;
validating the received first input by determining whether the first input meets the transaction requirements;
if the first input passes validation, performing the selected social media update on the at least one social media venue of the consumer associated with the consumer identifier and using the stored account information associated with the consumer identifier; and
providing the incentive to the consumer after the selected social media update on the at least one social media venue of the consumer has occurred.
